(19) United States
(12) Patent Application Publication
(10) Pub. No.: US 2025/0358659 A1
(43) Pub. Date: Nov. 20, 2025

(54) COMMUNICATION APPARATUS AND COMMUNICATION METHOD FOR EXTENDED SENSING BY PROXY

(71) Applicant: Panasonic Intellectual Property Corporation of America, Torrance, CA (US)

(72) Inventors: Rojan CHITRAKAR, Singapore (SG); Yoshio URABE, Nara (JP); Hiroyuki MOTOZUKA, Kanagawa (JP); Rajat PUSHKARNA, Singapore (SG)

(21) Appl. No.: 18/872,709

(22) PCT Filed: Apr. 28, 2023
(86) PCT No.: PCT/SG2023/050292

§ 371 Date: Dec. 6, 2024

(30) Foreign Application Priority Data
Jun. 17, 2022 (SG) 10202250217M

(51) Int. Cl. H04W 24/10; H04B 17/20

(52) U.S. Cl. CPC H04W 24/10; H04B 17/25

(57) ABSTRACT

The present disclosure provides a communication apparatus and a communication method for extended sensing by proxy, the communication apparatus comprising: a receiver, which, in operation, receives a first request frame from a second communication apparatus, the first request frame indicating a condition to select one or more links, each of the one or more links attached to one or more third communication apparatuses; circuitry, which, in operation, is configured to select a fourth communication apparatus and generate a second request to a fourth communication apparatus to perform a measurement on the one or more links; and a transmitter, which, in operation, transmits a first report frame to the second communication apparatus carrying one or more reports of the measurement corresponding to the one or more links.

### TECHNICAL FIELD

The present disclosure relates to communication apparatuses and methods for sensing, and more particularly for extended sensing by proxy.

### BACKGROUND

A wireless local area network (WLAN) sensing is under development by Institute of Electrical and Electronics Engineers (IEEE) 802.11bf Task Group. In the task group, Sensing by Proxy (SBP), which enables a client to obtain sensing measurement using multiple radio links, is proposed, but the details of the protocol/procedure to select best links/STAs for the SBP procedure has not been discussed in the Task Group. Meanwhile, Multi-Link Operation (MLO)/Multi-Link Device (MLD) specification, where multiple stations can be affiliated with an MLD, allowing seamless communication between two MLDs over multiple wireless link, is still under development by IEEE 802.11be Task Group.

With the current SBP procedure, a STA can only request sensing measurements for the links that are directly accessible via the AP receiving the SBP request (i.e., the Sensing Responder).

There is thus a need for communication apparatuses and methods for extended sensing by proxy that provide feasible technical solutions to address the issues, more particularly, to extend the SBP procedure to an AP (other than the AP receiving the SBP request) that is not directly accessible by the STA (SBP initiator) for sensing measurements.

Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for extended sensing by proxy in context of WLAN.

In a first aspect, the present disclosure provides a first communication apparatus comprising: a receiver, which, in operation, receives a first request frame from a second communication apparatus, the first request frame indicating a condition to select one or more links, each of the one or more links attached to one or more third communication apparatuses; and circuitry, which, in operation, is configured to select a fourth communication apparatus and generate a second request to the fourth communication apparatus to perform a measurement on the one or more links; and a transmitter, which, in operation, transmits a first report frame to the second communication apparatus carrying one or more reports of the measurement corresponding to the one or more links.

In a second aspect, the present disclosure provides a second communication apparatus: circuitry, which, in operation, generates a first request frame indicating a condition to select one or more links and requesting for a measurement on the one or more links; a transmitter, which, in operation, transmits the first request frame to a first communication apparatus, each of the one or more links attached to one or more third communication apparatuses; and a receiver, which, in operation, receives a first report frame from the first communication apparatus carrying one or more reports of the measurement corresponding to the one or more links performed by a fourth communication apparatus.

In a third aspect, the present disclosure provides a communication method implemented by a first communication apparatus comprising: receiving a first request frame from a second communication apparatus, the first request frame indicating a condition to select one or more links, each of the one or more links attached to one or more third communication apparatuses; selecting a fourth communication apparatus, generating a second request to a fourth communication apparatus to perform a measurement on the one or more links; and transmitting a first report frame to the second communication apparatus carrying one or more reports of the measurement corresponding to the one or more links.

In a fourth aspect, the present disclosure provides a communication method implemented by a second communication apparatus comprising: generating a first request frame indicating a condition to select one or more links and requesting for a measurement on the one or more links; transmitting the first request frame to a first communication apparatus, each of the one or more links attached to one or more third communication apparatuses; and receiving a first report frame from the first communication apparatus carrying one or more reports of the measurement corresponding to the one or more links performed by a fourth communication apparatus.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 depicts a schematic diagram illustrating a single-user (SU) communication between an access point (AP) and a station (STA) in a MIMO (multiple-input multiple-output) wireless network.

FIG. 2 depicts a schematic diagram illustrating downlink multi-user (MU) communication between an AP and multiple STAs in a MIMO wireless network.

FIG. 3 depicts a schematic diagram illustrating a trigger-based (TB) uplink MU communication between an AP and multiple STAs in a MIMO wireless network.

FIG. 4 depicts a schematic diagram illustrating communications between a STA (client 0) and an AP for a basic SBP procedure.

FIG. 5 depicts a schematic diagram illustrating three wireless links between an AP MLD and a non-AP MLD.

FIG. 6 shows a schematic diagram showing a floor plan and devices located therein.

FIG. 7 depicts a schematic diagram illustrating a conventional communication method for an SBP initiator to set up SBP procedures with multiple APs for sensing measurements on multiple links.

FIG. 8 shows a schematic view of a communication apparatus according to the present disclosure.

FIG. 9 shows a flowchart illustrating a communication method implemented by a first communication apparatus such as an AP acting as a SBP responder according to various embodiments of the present disclosure.

FIG. 10 shows a flowchart illustrating a communication method implemented by a second communication apparatus such as a STA acting as an SBP initiator according to various embodiments of the present disclosure.

FIG. 11 shows a schematic diagram illustrating communications in an exemplary extended SBP procedure according to various embodiments of the present disclosure.

FIG. 12 shows a schematic diagram illustrating communications in an extended SBP procedure according to an example of the first embodiment of the present disclosure.

FIG. 13 shows an exemplary flowchart illustrating an overview of an extended SBP procedure between two APs and three non-AP STAs.

FIG. 14 shows an exemplary flowchart illustrating a detailed procedural flow of an exemplary extended SBP procedure.

FIG. 15 shows an example format of an Extended Capabilities element used for basic discovery according to various embodiments of the present disclosure.

FIG. 16A shows an example format of an SBP Request frame according to various embodiments of the present disclosure.

FIG. 16B shows an example format of a Protected SBP Request frame according to various embodiments of the present disclosure.

FIG. 17A shows an example format of an SBP Response frame according to the first embodiment of the present disclosure.

FIG. 17B shows an example format of a Protected Response frame according to the first embodiment of the present disclosure.

FIG. 18 shows an example format of an SBP Parameter Element field in SBP Request/Response frames according to the first embodiment of the present disclosure.

FIG. 19 shows an example format of an SBP Link Info Element field in SBP Response frames according to the first embodiment of the present disclosure.

FIG. 20 shows a flowchart illustrating communications between an SBP Initiator (non-AP STA) and an SBP Responder (AP) for sensing by proxy according to the first embodiment of the present disclosure.

FIG. 21 shows an example format of a Protected SBP Report frame according to the first embodiment of the present disclosure.

FIG. 22 shows a schematic diagram illustrating communications in an extended SBP procedure according to the first example of the second embodiment of the present disclosure.

FIG. 23 shows a flowchart illustrating an overview of an extended SBP procedure among two APs, a non-AP MLD and three STAs.

FIG. 24 shows a flowchart illustrating a detailed procedural flow of an exemplary extended SBP procedure.

FIG. 25 shows a schematic diagram illustrating communications in an extended SBP procedure according to the second example of the second embodiment of the present disclosure.

FIG. 26 shows a flowchart illustrating an overview of an exemplary extended SBP procedure among two APs, a non-AP MLD and three STAs.

FIG. 27 shows a flowchart illustrating a detailed procedural flow of an exemplary extended SBP procedure.

FIG. 28 shows an example format of an SBP Parameter Element field in SBP Request/Response frames according to the second embodiment of the present disclosure.

FIG. 29A shows an example format of an SBP Response frame according to the second embodiment of the present disclosure.

FIG. 29B shows an example format of a Protected Response frame according to the second embodiment of the present disclosure.

FIG. 30 shows an example format of an SBP Link Info Element field in SBP Response frames according to the second embodiment.

FIG. 31 shows a schematic diagram illustrating communications in an extended SBP procedure according to an example of the third embodiment of the present disclosure.

FIG. 32 shows a flowchart illustrating an overview of an exemplary extended SBP procedure among three APs and the six STAs.

FIG. 33 shows a flowchart illustrating a detailed procedural flow of an exemplary extended sensing by proxy procedure.

FIG. 34 shows an example format of an SBP Parameter Element field in SBP Request/Response frames according to the third embodiment.

FIG. 35 shows an example format of an SBP Link Info Element field in SBP Response frames according to the third embodiment.

FIG. 36 shows an example format of a 1905.1 Message used for extended SBP procedure according to the third embodiment of the present disclosure.

FIG. 37 shows a schematic diagram illustrating communications in an extended SBP procedure according to an example of the fourth embodiment of the present disclosure.

FIG. 38 shows a flowchart illustrating a detailed procedural flow of an exemplary extended SBP procedure.

FIG. 39 shows an example format of an Extended Capabilities element used for basic discovery according to the fourth embodiment of the present disclosure.

FIG. 40 depicts example formats of a SBP Request frame, a SBP Response frame, a Protected SBP Report frame and a SBP Termination frame according to the fourth embodiment of the present disclosure.

FIG. 41 shows an example configuration of a communication apparatus.

FIG. 42 shows another example configuration of a communication apparatus.

FIG. 43 shows yet another example configuration of a communication apparatus.

FIG. 44 shows another example configuration of a communication apparatus.

Skilled artisans will appreciate that elements in the figures are illustrated for simplicity and clarity and have not necessarily been depicted to scale. For example, the dimensions of some of the elements in the illustrations, block diagrams or flow charts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for sensing by proxy, especially in a multiple-input multiple-output (MIMO) wireless network.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

In a MIMO wireless network, “multiple” refers to multiple antennas used simultaneously for transmission and multiple antennas used simultaneously for reception, over a radio channel. In this regard, “multiple-input” refers to multiple transmitter antennas, which input a radio signal into the channel, and “multiple-output” refers to multiple receiver antennas, which receive the radio signal from the channel and into the receiver. For example, in an N×M MIMO network system, N is the number of transmitter antennas, M is the number of receiver antennas, and N may or may not be equal to M. For the sake of simplicity, the respective numbers of transmitter antennas and receiver antennas are not discussed further in the present disclosure.

In a MIMO wireless network, single-user (SU) communications and multi-user (MU) communications can be deployed for communications between communication apparatuses such as APs and STAs. MIMO wireless network has benefits like spatial multiplexing and spatial diversity, which enable higher data rates and robustness through the use of multiple spatial streams. According to various embodiments, the term “spatial stream” may be used interchangeably with the term “space-time stream” (or STS).

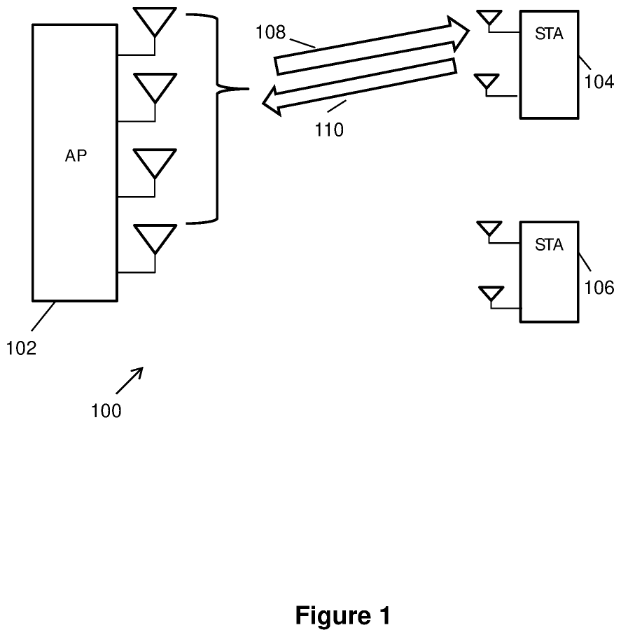

FIG. 1 depicts a schematic diagram illustrating a SU communication 100 between an AP 102 and a STA 104 in a MIMO wireless network. As shown, the MIMO wireless network may include one or more STAs (e.g., STA 104, STA 106, etc.). If the SU communication 100 in a channel is carried out over whole channel bandwidth, it is called full bandwidth SU communication. If the SU communication 100 in a channel is carried out over a part of the channel bandwidth (e.g., one or more 20 MHz subchannels within the channel is punctured), it is called punctured SU communication. In the SU communication 100, the AP 102 transmits multiple space-time streams using multiple antennas (e.g., four antennas as shown in FIG. 1) with all the space-time streams directed to a single communication apparatus, i.e., the STA 104. For the sake of simplicity, the multiple space-time streams directed to the STA 104 are illustrated as a grouped data transmission arrow 108 directed to the STA 104.

The SU communication 100 can be configured for bi-directional transmissions. As shown in FIG. 1, in the SU communication 100, the STA 104 may transmit multiple space-time streams using multiple antennas (e.g., two antennas as shown in FIG. 1) with all the space-time streams directed to the AP 102. For the sake of simplicity, the multiple space-time streams directed to the AP 102 are illustrated as a grouped data transmission arrow 110 directed to the AP 102.

As such, the SU communication 100 depicted in FIG. 1 enables both uplink and downlink SU transmissions in a MIMO wireless network.

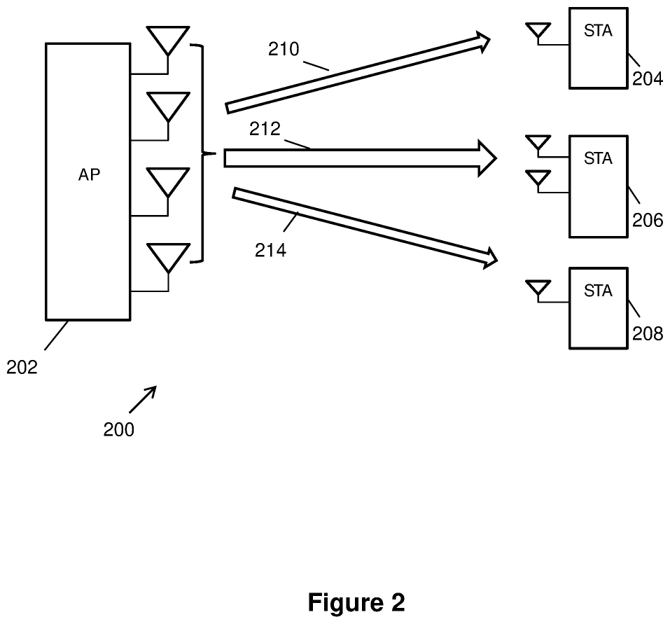

FIG. 2 depicts a schematic diagram illustrating a downlink MU (multiple-user) communication 200 between an AP 202 and multiple STAs 204, 206, 208 in a MIMO wireless network. The MIMO wireless network may include one or more STAs (e.g., STA 204, STA 206, STA 208, etc.). The MU communication 200 can be an OFDMA (orthogonal frequency division multiple access) communications or a MU-MIMO communication. For an OFDMA communication in a channel, the AP 202 transmits multiple streams simultaneously to the STAs 204, 206, 208 in the network at different resource units (Rus) within the channel bandwidth. For a MU-MIMO communication in a channel, the AP 202 transmits multiple streams simultaneously to the STAs 204, 206, 208 at same RU(s) within the channel bandwidth using multiple antennas via spatial mapping or precoding techniques. If the RU(s) for the OFDMA or MU-MIMO communication occupies whole channel bandwidth, the OFDMA or MU-MIMO communications is called full bandwidth OFDMA or MU-MIMO communications. If the RU(s) for the OFDMA or MU-MIMO communication occupies a part of channel bandwidth (e.g., one or more 20 MHz subchannel within the channel is punctured), the OFDMA or MU-MIMO communication is called punctured OFDMA or MU-MIMO communications. For example, two space-time streams may be directed to the STA 206, another space-time stream may be directed to the STA 204, and yet another space-time stream may be directed to the STA 208. For the sake of simplicity, the two space-time streams directed to the STA 206 are illustrated as a grouped data transmission arrow 212, the space-time stream directed to the STA 204 is illustrated as a data transmission arrow 210, and the space-time stream directed to the STA 208 is illustrated as a data transmission arrow 214.

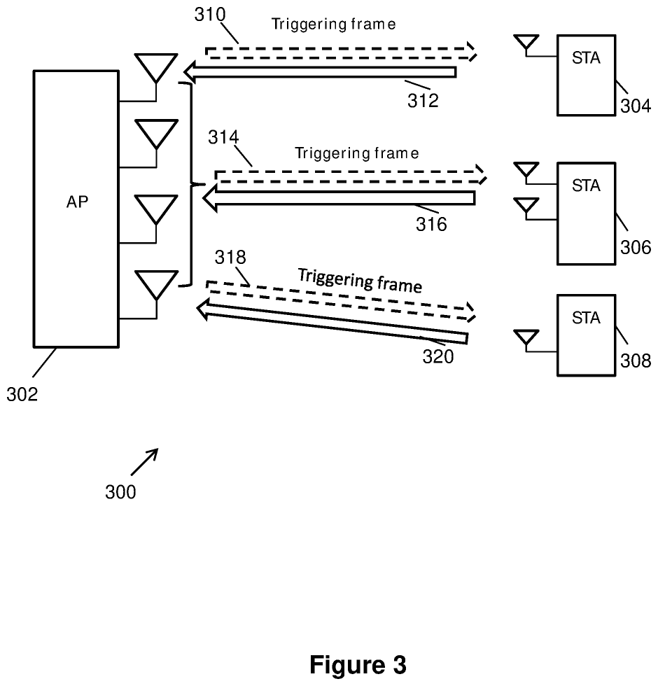

To enable uplink MU transmissions, trigger-based communication is provided to the MIMO wireless network. In this regard, FIG. 3 depicts a schematic diagram illustrating a trigger-based (TB) uplink MU communication 300 between an AP 302 and multiple STAs 304, 306, 308 in a MIMO wireless network.

Since there are multiple STAs 304, 306, 308 respectively participating in the trigger-based uplink MU communication, the AP 302 needs to coordinate simultaneous transmissions of multiple STAs 304, 306, 308.

To do so, as shown in FIG. 3, the AP 302 transmits triggering frames 310, 314, 318 simultaneously to STAs 304, 306, 308 respectively to indicate user-specific resource allocation information (e.g., the number of space-time streams, a starting STS number and the allocated Rus) that each STA can use. In response to the triggering frames, STAs 304, 306, 308 may then transmit their respective space-time streams simultaneously to the AP 302 according to the user-specific resource allocation information indicated in the triggering frames 310, 314, 318. For example, two space-time streams may be directed to the AP 302 from STA 306, another space-time stream may be directed to the AP 302 from STA 304, and yet another space-time stream may be directed to the AP 302 from STA 308. For the sake of simplicity, the two space-time streams directed to the AP 302 from STA 306 are illustrated as a grouped data transmission arrow 316, the space-time stream directed to the AP 302 from STA 304 is illustrated as a data transmission arrow 312, and the space-time stream directed to the AP 302 from STA 308 is illustrated as a data transmission arrow 320.

Due to packet/PPDU (physical layer protocol data unit) based transmission and distributed MAC (medium access control) scheme in 802.11 WLAN, time scheduling (e.g., TDMA (time division multiple access)-like periodic time slot assignment for data transmission) does not exist in 802.11 WLAN. Frequency and spatial resource scheduling is performed on a packet basis. In other words, resource allocation information is on a PPDU basis.

According to various embodiments, WLAN supports non-trigger-based communications as illustrated in FIGS. 1 and 2 and trigger-based communications as illustrated in FIG. 3. In non-trigger-based communications, a communication apparatus transmits a PPDU to one other communication apparatus or more than one other communication apparatuses in an unsolicited manner. In trigger-based communications, a communication apparatus transmits a PPDU to one other communication apparatus or more than one other communication apparatuses only after a soliciting triggering frame is received.

According to the present disclosure, the term “sensing initiator” refers to a device which initiates a sensing session with a STA (herein referred to as “client”) and requests for a sensing result from the STA. The term “sensing responder” is a STA which responds to the sensing initiator and participates in the sensing session. In various embodiments below, unless otherwise stated, the term “initiator” and “responder” refer to as “sensing initiator” and “sensing responder”, respectively. Typically (e.g., in Trigger Based (TB) sensing measurements), the initiator is an AP, while the responders are non-AP STAs; however this need not always be the case and at times non-AP STAs can also be the initiator, and an AP can be a responder (e.g., in Non-TB sensing measurements, or Fine Timing Measurements (FTM)/Ranging).

In contrast to “sensing initiator” and “sensing responder”, the term “Sensing By Proxy (SBP) initiator” refers to a STA which initiates an SBP procedure and requests a device (e.g., AP or sensing initiator) to be a proxy sensing initiator to initiate a sensing session and requests for a sensing result from another STA (e.g., the device's client) on its behalf. The term “SBP responder” refers to a device which responds to the SBP initiator and agrees to participate in the SBP procedure to be a proxy sensing initiator. It is noted that an SBP initiator can be a sensing responder or one of multiple sensing responders of an SBP responder (sensing initiator).

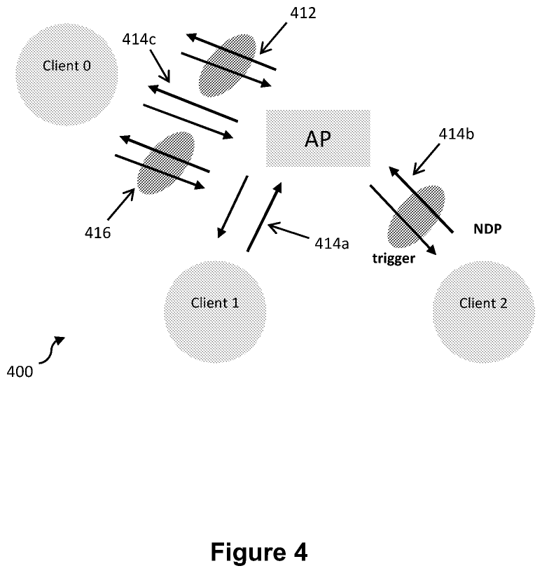

As mentioned earlier, SBP, which enables a client to obtain sensing measurement using multiple radio links, is introduced in IEEE 802.11 bf. FIG. 4 depicts a schematic diagram 400 illustrating communications between a STA (client 0) and an AP for a basic SBP procedure. According to the basic concept, a Sensing by Proxy procedure includes an SBP procedure setup, a sensing measurement, an SBP procedure reporting and an SBP procedure termination. During SBP procedure setup, a client (e.g., client 0) requests the AP to obtain sensing measurements with other clients (e.g., clients 1 and 2). The AP is configured to act as a proxy-initiator for the requesting client. In various embodiments illustrated in the present disclosure, such requesting client is referred to as SBP requesting STA or SBP Initiator while the AP is referred to proxy AP or SBP Responder. The proxy is established by exchanging SBP request/response frames 412 between the SBP Initiator and the SBP Responder. The AP then performs sensing measurement with one or more clients (e.g., clients 1 and 2), for example, by exchanging measurement setup request/response frames to establish sessions and/or measurement report frame 414a, 414b during measurement instance(s). In the FIG. 4 example, the SBP Initiator is one of the clients, and the AP may also perform sensing measurement with the SBP Initiator by exchanging the relevant frames 414c. During SBP procedure Reporting, the AP which obtained the client's measurement reports then reports them to the SBP Initiator, for example, by sending an SBP report frame 416. After the SBP procedure Reporting, the SBP procedure may be terminated at any time by either the SBP Initiator or the SBP Responder by transmitting an SBP Termination frame (not shown).

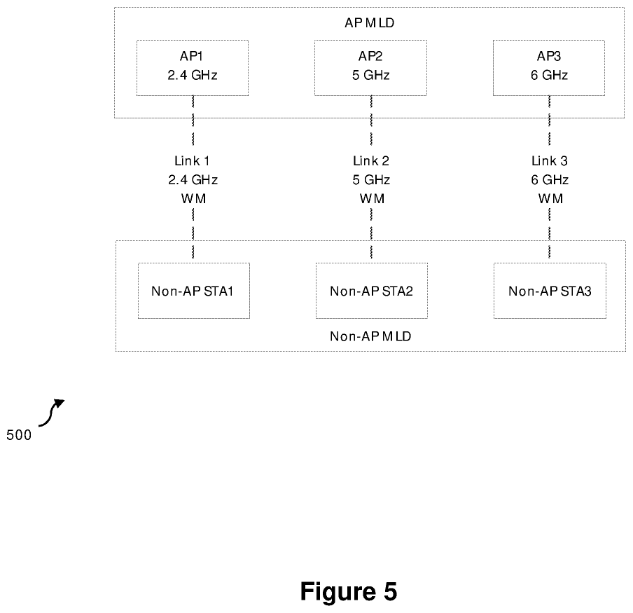

FIG. 5 depicts a schematic diagram 500 illustrating three wireless links between an AP MLD and a non-AP MLD. In particular, three APs (AP1, AP2, AP3) operating in 2.4 GHz, 5 GHz and 6 GHz frequencies respectively are affiliated with the AP MLD and three non-AP STAs (non-AP STA1, non-AP STA2, non-AP STA3) operating in 2.4 GHZ, 5 GHZ and 6 GHz frequencies respectively are affiliated with the non-AP MLD. The AP1 and non-AP STA1 operating in 2.4 GHz frequency communicate with each other through Link 1; the AP2 and non-AP STA2 operating in 5 GHz frequency communicate with each other through Link 2; and the AP3 and non-AP STA3 operating in 6 GHz frequency communication with each other through Link 3.

As mentioned earlier, with the current SBP procedure, a STA can only request sensing measurements for the links that are directly accessible via the AP receiving the SBP request (i.e., the Sensing Responder) and there is no discussion on extending the SBP procedure to enable an SBP Initiator to request an AP (other than the AP receiving the SBP request) that is not directly accessible by the SBP initiator for sensing measurements.

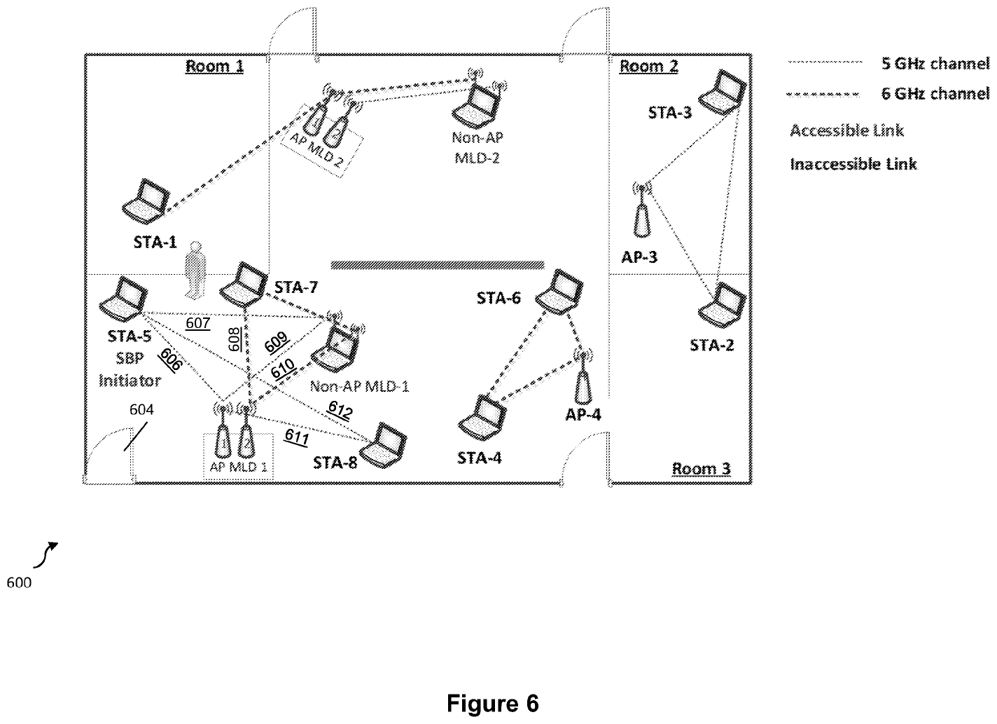

FIG. 6 shows a schematic diagram 600 showing a floor plan and devices located therein. In this figure, STA-5 is an SBP Initiator configured to perform human tracking on persons entering the floor from the door 604. There may be 17 possible links between the devices that may be used for sensing measurements, as illustrated using lines between devices, but only a few links such as links 606, 607, 609, 611, 612 (among non-AP MLD-1, STA8) are accessible to the SBP Initiator via AP-1 of AP-MLD-1 for the human tracking sensing application tasked with human tracking near the vicinity of the door 604. For example, the links 608, 610 via AP-2 of AP-MLD1 cannot be accessed for sensing measurement by STA-5. Similarly, links provided by APs that are out of wireless range of STA-5 cannot be accessed.

There is thus a need for communication apparatuses and methods for extended sensing by proxy that enables an SBP initiator to request an AP (other than the AP receiving the SBP request) that is not directly accessible by the SBP initiator for sensing measurements.

The present disclosure illustrates an extended sensing by proxy procedure that enables a non-AP STA, being an SBP initiator, to request the following APs that is not directly accessible to the SBP initiator for sensing measurement: (i) an AP which is a member of a co-hosted, co-located or multiple BSSID set (e.g., Virtual APs (VAPs)) as the AP (hereinafter may be referred to as “SBP Responder” or “primary sensing proxy initiator”) directly accessible by and receiving the SBP request from the SBP initiator; (ii) an AP which is affiliated with a same AP MLD as the SBP Responder and; and (iii) an AP which is part of multi-AP network (e.g.,) or connected to the SBP Responder. The present disclosure also seeks to propose related signalling and frame format for the sensing by proxy procedure.

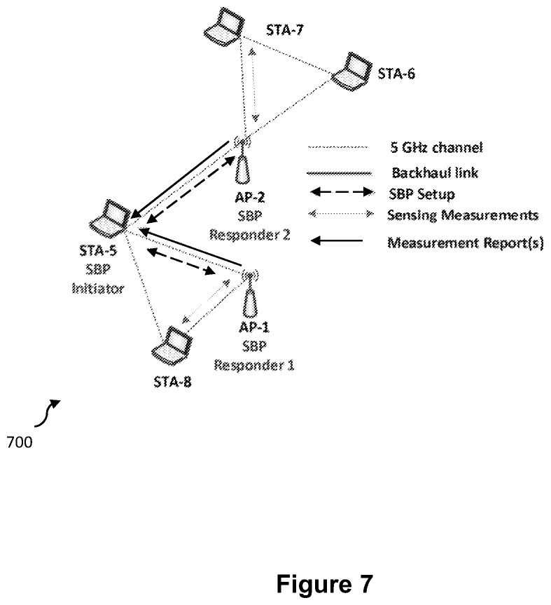

FIG. 7 depicts a schematic diagram 700 illustrating a conventional communication method for an SBP initiator to set up SBP procedures with multiple APs for sensing measurements on multiple links. Conventionally, when an SBP initiator (e.g., STA-5) cannot access to both APs (e.g., AP-1, AP-2) (e.g., AP-1 and AP-2 operate at different channels) or the SBP initiator would like to perform sensing measurements on links that are exclusively accessible by different APs, the SBP Initiator has to set up multiple SBP procedures with the APs, each AP acting as a proxy for performing sensing measurement on its link on behalf of STA-5, respectively. In this case, STA-5 is associated with AP-1 and unassociated with AP-1. STA-5 first requests its associated AP-1 to perform a first SBP procedure for one link and then requests the unassociated AP-2 to perform a second SBP procedure for one link. AP-1 and AP-2 select STA-8 and STA-7 as a sensing responder, respectively. The sensing measurements on STA-8 and STA-7 are performed by AP-1 and AP-2, respectively and the measurement results are forwarded to STA-5.

Beside requires multiple SBP procedures, the conventional communication method does not allow SBP procedure to be set up with AP that is not accessible by the SBP initiator. In this case, if, however, STA-5 is out of range of AP-2 or AP-2 is operating on a channel in a band not supported by STA-5, it would not be possible for STA-5 to obtain the results of the sensing measurements on links that are part of AP-2's BSS.

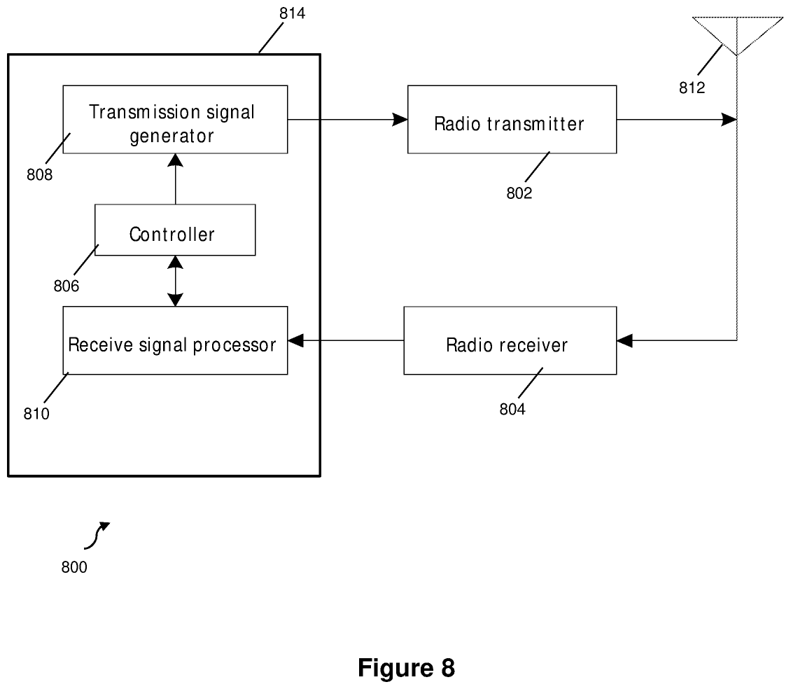

FIG. 8 shows a schematic view of a communication apparatus 800 according to the present disclosure. The communication apparatus 800 may also be implemented as a sensing initiator, a sensing responder, an SBP initiator or an SBP responder.

As shown in FIG. 8, the communication apparatus 800 may include circuitry 814, at least one radio transmitter 802, at least one radio receiver 804, and at least one antenna 812 (for the sake of simplicity, only one antenna is depicted in FIG. 8 for illustration purposes). The circuitry 814 may include at least one controller 806 for use in software and hardware aided execution of tasks that the at least one controller 806 is designed to perform, including control of communications with one or more other communication apparatuses in a MIMO wireless network. The circuitry 814 may further include at least one transmission signal generator 808 and at least one receive signal processor 810. The at least one controller 806 may control the at least one transmission signal generator 808 for generating MAC frames and PPDUs) to be sent through the at least one radio transmitter 802 to one or more other communication apparatuses, wherein the MAC frames, for example, may be Client Discovery Query/Request/Response frame, Sensing Measurement Setup Request/Response frame, SBP Request/Response frame, SBP Report frame, Sensing Measurement Report frame, Polling Trigger frame, Sounding Trigger frame, NFRP Trigger frame, Sensing Trigger frame, Sensing NDPA; and the PPDU, for example, may be PPDUs used for non-trigger-based communications, PPDUs used for trigger-based sounding/sensing measurement procedure, non-trigger-based sounding/sensing measurement procedure, PPDUs used for trigger-based downlink transmissions if the communication apparatus 800 is an AP, or PPDUs used for trigger-based uplink transmissions if the communication apparatus 800 is a STA. The at least one controller 806 may control the at least one receive signal processor 810 for processing MAC frames and PPDUs received through the at least one radio receiver 804 from the one or more other communication apparatuses under the control of the at least one controller 806, wherein the MAC frames, for example, may be Client Discovery Query/Request/Response frame, Sensing Measurement Setup Request/Response frame, SBP Request/Response frame, SBP Report frame, Sensing Measurement Report frame, Polling Trigger frame, Sounding Trigger frame, NFRP Trigger frame, Sensing Trigger frame, Sensing NDPA; and the PPDU, for example, may be PPDUs used for non-trigger-based communications, PPDUs used for trigger-based sounding/sensing measurement procedure, non-trigger-based sounding/sensing measurement procedure PPDUs used for trigger-based uplink transmissions if the communication apparatus 800 is an AP, or PPDUs used for trigger-based downlink transmissions if the communication apparatus 800 is a STA. The at least one transmission signal generator 808 and the at least one receive signal processor 810 may be stand-alone modules of the communication apparatus 800 that communicate with the at least one controller 806 for the above-mentioned functions, as shown in FIG. 8. Alternatively, the at least one transmission signal generator 808 and the at least one receive signal processor 810 may be included in the at least one controller 806. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 802, at least one radio receiver 804, and at least one antenna 812 may be controlled by the at least one controller 806.

The communication apparatus 800, when in operation, provides functions required for extended sensing by proxy. For example, the communication apparatus 800 may be an AP acting as an SBP responder (or primary proxy sensing initiator), and the at least one radio receiver 804 receives a first request frame from a STA acting as an SBP initiator, the first request frame indicating a condition to select one or more links, each of the one or more links attached to one or more sensing responders.

The circuitry 814 (for example the at least one receive signal processor 810 and the at least one transmission signal generator 808 of the circuitry 814, respectively) may be configured to process the first request frame, select another AP and generate a second request frame indicating the condition to the other AP to act as a (secondary) proxy sensing initiator to perform a measurement on the one or more links. If the communication apparatus 800 and the other AP are communicated through external means (e.g., wire or wireless communication), I at least one radio transmitter 802 may then transmit the second request in a frame to the other AP. The circuitry 814 (for example the at least one transmission signal generator 808 of the circuitry 814) may be configured to generate a first report frame carrying one or more reports of the measurement corresponding to the one or more links. The at least one radio transmitter 802 may then transmit the first report frame back to the STA (SBP initiator).

In one embodiment, the circuitry 814 (for example the at least one receive signal processor 810) (if the communication with the other AP is internal through primitives) or receives a second report carrying the one or more reports of the measurement corresponding to the one or more links from the other AP, and the circuitry 814 (for example the at least one transmission signal generator 808 of the circuitry 814, respectively) is configured to generate the first report frame when the at least one radio receiver 804 receives the second report. In an alternative embodiment, if the communication with the other AP is through external means, the at least one radio receiver 804 receives the second report in the form of a report frame from the other AP. In various embodiments below, the term “second request” generated and transmitted through internal means (e.g., through primitives) between two communication apparatuses (e.g., APs) may also be referred to as “second request frame” for the sake of simplicity.

In another embodiment, the circuitry 814 may be configured to assign an identifier to the measurement on the one or more links, and second request generated by the circuitry 814 (for example the at least one transmission signal generator 808 of the circuitry 814, respectively) comprises the identifier.

Yet in another embodiment, where the first request frame carries an identifier or a MAC address of the other AP (secondary proxy sensing initiator) and the second report carries an identifier or an MAC address of the communication apparatus 800, the at least one transmitter 802 forwards the first request frame received to the other AP and the second report to the STA.

According to an embodiment of the present disclosure, the secondary proxy sensing initiator is a member of a co-hosted, co-located or multiple BSSID set (e.g., Virtual APs (VAPs)) as the SBP responder (primary proxy sensing initiator) and therefore they are connected to or through a common physical device. In an alternative embodiment of the present disclosure, the primary and secondary proxy sensing initiators are affiliated with an AP MLD. In yet another alternative embodiment of the present disclosure, the primary and secondary proxy sensing initiators are both part of a multi-AP network (e.g., EasyMesh) or are connected to each other.

The communication apparatus 800 may be a STA acting as an SBP initiator, and the circuitry 814 (for example the at least one transmission signal generator 808 of the circuitry 814) may be configured to generate a first request frame indicating a condition to select one or more links and requesting for a measurement on the one or more links. The at least one radio transmitter 802 may then transmit the first request frame to an AP acting as an SBP responder (primary proxy sensing initiator), each of the one or more links attached to one or more sensing responders. The at least one radio receiver 804 receives a first report frame from the AP carrying one or more reports of the measurement corresponding to the one or more links.

In various embodiments of the present disclosure, the measurement is performed by another AP acting as a secondary proxy sensing initiator. In one embodiment, the first request frame generated by the circuitry 814 (for example the at least one transmission signal generator 808 of the circuitry 814) comprises an identifier or a MAC address of such AP (secondary proxy sensing initiator), and the condition indicated in the first request frame is transmitted to the other AP. In an alternative embodiment, the first request frame generated by the circuitry 814 (for example the at least one transmission signal generator 808 of the circuitry 814) comprises an identifier or a MAC address of the AP (SBP responder or primary proxy sensing initiator) and the measurement on the one or more links is performed by the SBP responder.

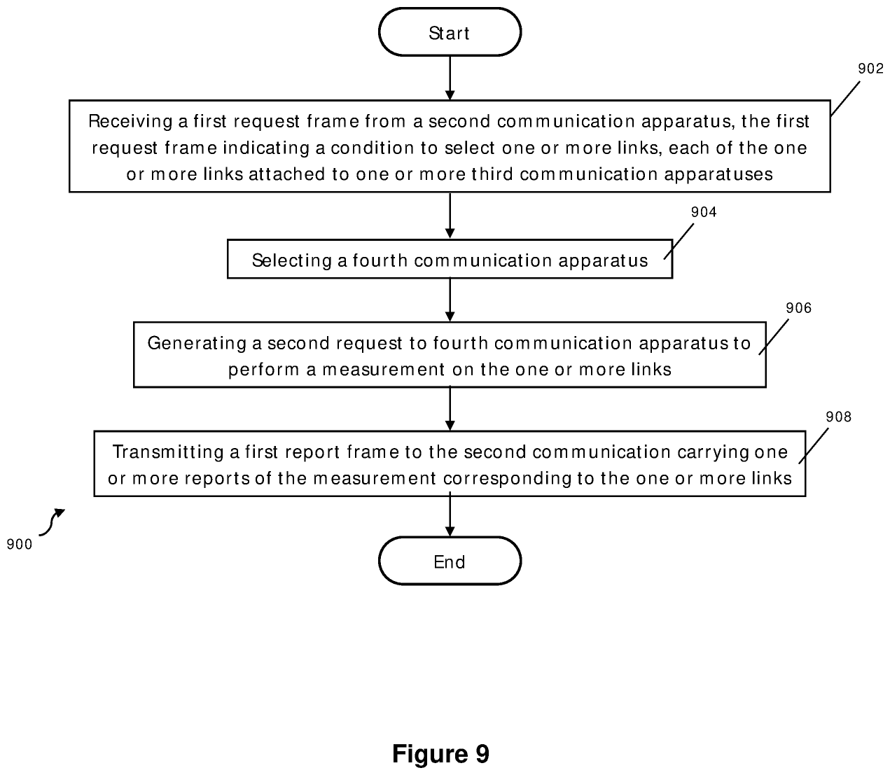

FIG. 9 shows a flowchart 900 illustrating a communication method implemented by a first communication apparatus such as an AP acting as a SBP responder according to various embodiments of the present disclosure. In step 902, a step of receiving a first request frame a second communication apparatus such as a STA acting as an SBP initiator is carried out, the first request frame indicating a condition to select one or more links, each of the one or more links attached to one or more third communication apparatuses such as STAs or sensing responders. In step 904, a step of selecting a fourth communication apparatus is carried out. In step 906, a step of generating a second request to the fourth communication apparatus to act as a secondary proxy sensing initiator and perform a measurement on the one or more links is carried out. In step 908, a step of transmitting a first report frame to the second communication apparatus carrying one or more reports of the measurement corresponding to the one or more links is carried out.

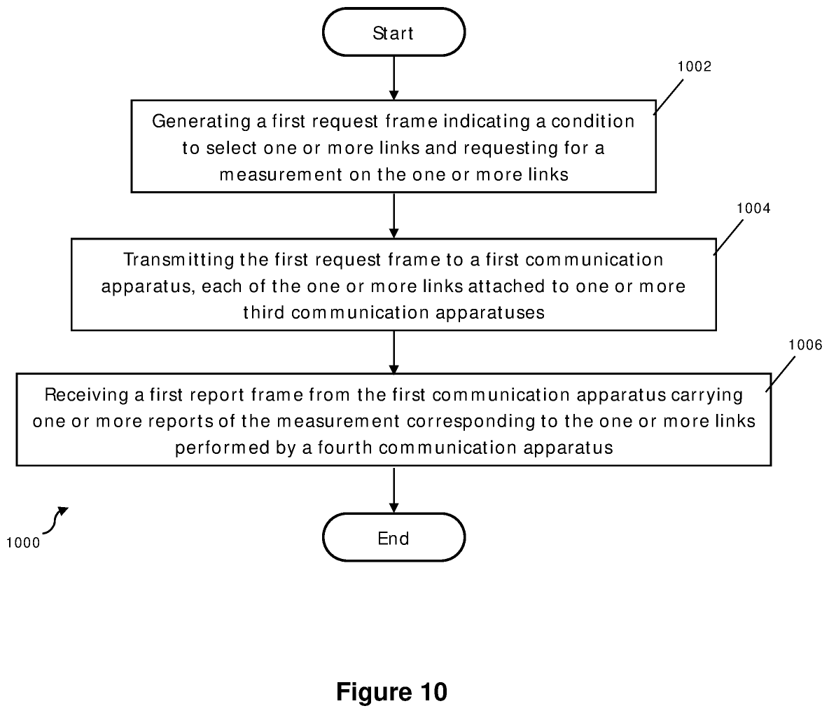

FIG. 10 shows a flowchart 1000 illustrating a communication method implemented by a second communication apparatus such as a STA acting as an SBP initiator according to various embodiments of the present disclosure. In step 1002, a step of generating a first request frame indicating a condition to select one or more links and requesting for a measurement on the one or more links is carried out. In step 1004, a step of transmitting the first request frame to a first communication apparatus such as an AP acting as a SBP responder (primary proxy sensing initiator) is carried out, each of the one or more links attached to one or more third communication apparatuses such as STAs or sensing responders. In step 1006, a step of receiving a first report frame from the first communication apparatus is carried out, the report frame carrying one or more reports of the measurement corresponding to the one or more links performed by a fourth communication apparatus (e.g., another AP).

In various embodiments of the present disclosure, the fourth communication apparatus is an AP that is different from the AP or SBP responder (primary proxy sensing initiator) to which the first request fame is transmitted tasked to act as a secondary proxy sensing initiator. In one embodiment, the first request frame generated in step 1002 comprises an identifier of such AP (secondary proxy sensing initiator), and a step of selecting such AP based on the identifier and transmitting the condition (for example in a second request) to such AP is carried out. In an alternative embodiment, the first request frame generated in step 1002 comprises an identifier of the first communication apparatus (SBP responder or primary proxy sensing initiator) and in such case, the measurement corresponding to the or more links is performed by the SBP responder.

According to the present disclosure, an SBP initiator is enabled to obtain sensing measurements from an AP which does not have a direct Wireless Medium (WM) connection and to obtain sensing measurements from multiple APs acting as proxies for the SBP initiator in a single SBP procedure. To setup such SBP procedure, the SBP initiator (non-AP STA) specifies, in the SBP request, the sensing operation condition(s) and attribute(s) such as sampling rate, report type, number of links, etc. to help the SBP responder (AP) to select a link(s) for the SBP procedure. Upon receipt of the SBP requesting specifying the condition(s), the SBP responder (AP) then decides/selects a STA(s)/link(s) in its own basic service set (BSS) to be used for the sensing measurements based on the condition(s)/attribute(s) provided in the SBP request. In addition, the SBP responder (AP) may request other AP(s) to act as a secondary proxy sensing initiator and perform WLAN sensing for the SBP procedure. The other AP(s) then also decides/selects a STA(s)/link(s) in its own BSS to be used for the sensing measurements based on the condition(s)/attribute(s). The SBP responder then collects the sensing reports from the selected STA(s)/link(s) and also from the other AP(s) and sends the sensing reports to the SBP initiator.

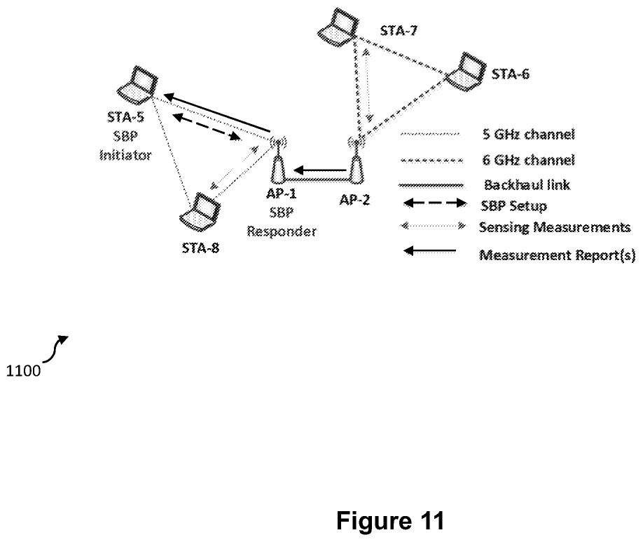

FIG. 11 shows a schematic diagram 1100 illustrating communications in an exemplary extended SBP procedure according to various embodiments of the present disclosure. FIG. 11 only illustrates a general and simplified idea of an extended SBP. Communications specific to each different embodiment may be illustrated using a different figure accompanied by its own description below. STA-5 is the SBP initiator and requests AP-1 to perform SBP procedure for two links. The SBP responder (AP-1) select STA-8 as a sensing responder and perform sensing measurement on its link attached to STA-8 on behalf of STA-5. As STA-5 stated the SBP procedure to be performed over two links, and AP-1 only has one link, AP-1 also requests AP-2 to perform sensing measurements on behalf of STA5. AP-2 then select STA-7 as a sensing responder and perform sensing measurement on its link attached to STA-7. The sensing measurement results on STA-7 performed by AP-2 is forwarded to AP-1, and AP-1 forwards the sensing measurement results on STA-8 and STA-7 to STA-5.

As mentioned earlier, with conventional SBP procedure, if STA-5 is out of range AP-2, it would not be possible for STA-5 to obtain the results of the sensing measurements on links that are part of AP-2's BSS. Such SBP request to perform sensing measurement over two links sent to AP-1 also cannot be fulfilled as there is no mechanism for AP-1 to request AP-2 to perform sensing measurement on behalf of STA-5.

In the following paragraphs, a first embodiment of the present disclosure where an extended SBP procedure through APs which are members of a co-hosted, co-located or multiple BSSID set and typically housed in the same physical device, is described.

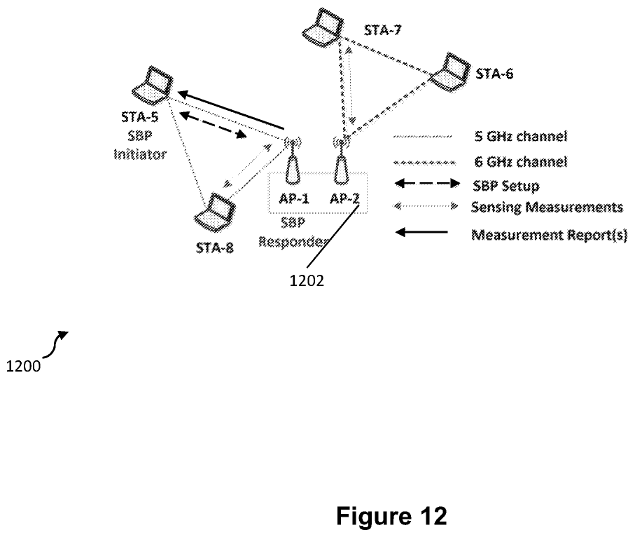

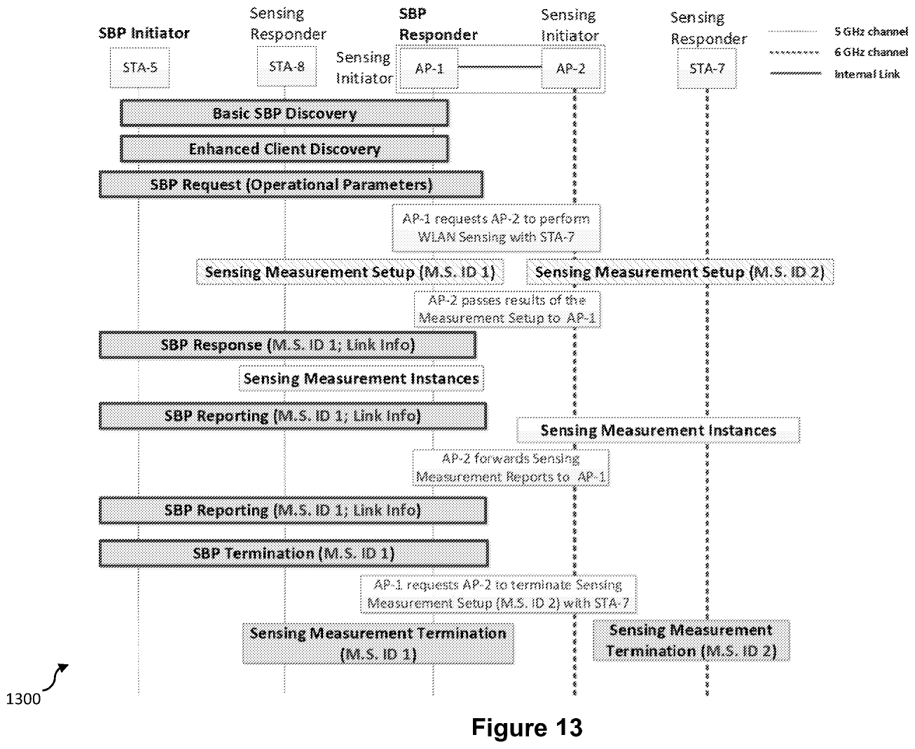

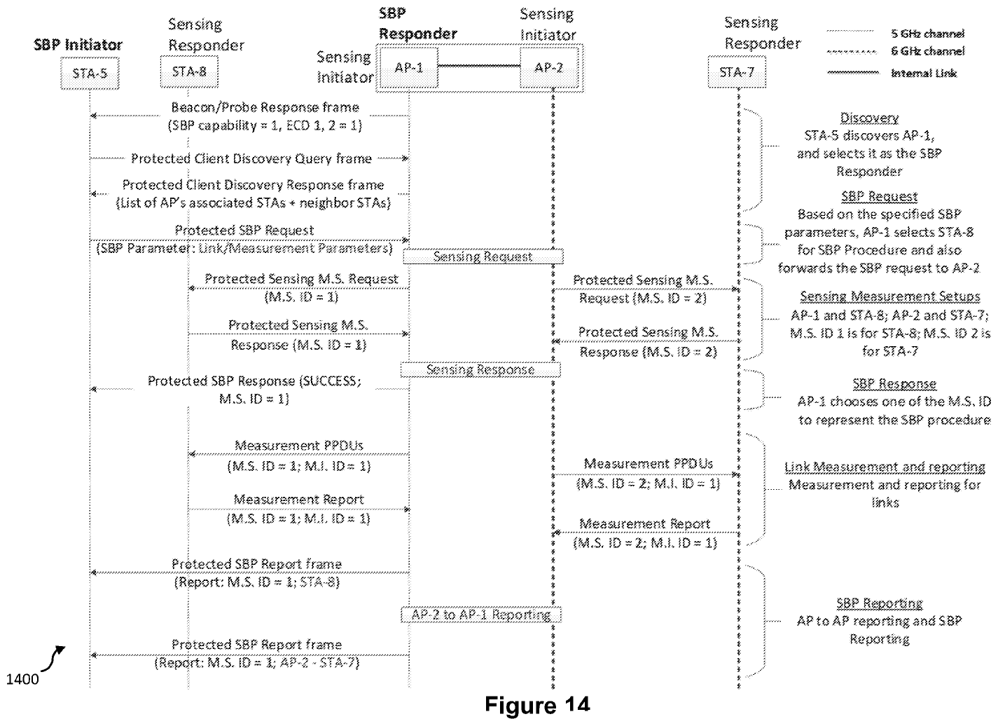

FIG. 12 shows a schematic diagram 1200 illustrating communications in an extended SBP procedure according to an example of the first embodiment of the present disclosure. In the first embodiment, AP-1 and AP-2 are both members of co-located BSSID set housed in the same physical device 1202. FIG. 13 shows an exemplary flowchart 1300 illustrating an overview of an extended SBP procedure between the two APs (AP-1, AP-2) and the three non-AP STAs (STA-5, STA-7, STA-8) in FIG. 12. FIG. 14 shows an exemplary flowchart 1400 illustrating a detailed procedural flow of the extended sensing by proxy procedure between the two APs and the three non-AP STAs in FIG. 12. In this example, AP-1 and AP-2 are co-located and housed in the same physical device.

Firstly, the AP (e.g., AP-1 and AP-2) advertises its capability to support enhanced client discovery and basic information about associated non-AP STAs (e.g., count/number of associated STAs etc.) using a Beacon/Probe Response frame. STA-5 may perform a basic SBP discovery procedure and discover an AP-1's support of the SBP function. STA-5 may then select the AP-1 as its SBP responder.

Secondly, STA-5 may then initiate an enhanced client discovery procedure by transmitting a protected client discovery query frame to request the AP-1 to provide a list of non-AP STAs (associated non-AP STAs and optionally unassociated non-AP STAs). The AP-1 then transmits a protected Client Discovery Response frame with the requested list of non-AP STAs and, optionally, their respective neighboring STAs, and the enhanced client discovery procedure ends. In this enhanced client discovery procedure, the SBP initiator discovers the information of AP-1 and potential sensing responders. In particular, the AP-1 already has basic information about its associated STAs, e.g., their operating channel(s), sensing capabilities and responder-to-responder (R2R) sensing capabilities etc., The SBP Initiator (STA-5) can obtain such information from the AP-1 using Level 1 Client Discovery Query. Although it is not shown in the figure, upon receiving request from the SBP Initiator (or even on its own), the AP may collect other relevant information from its associated STAs for example their location/position of the STAs, RSSI (or propagation loss) to/from the STAs (to represent a distance between the STAs and the AP-1) and information about the STA's neighboring STAs including link metrics etc. With that, the SBP Initiator can obtain such relevant information about the AP's associated STAs (and their neighboring STAs) from the AP using Level 2 Client Discovery Query. Based on the above information, the SBP Initiator can select one or more APs as SBP Responder(s) as well as one or more non-AP STAs as target sensing responders for the SBP Procedure. Alternatively, if, for example, the AP does not support Enhanced Client Discovery, or in addition to the information collected via Enhanced Client Discovery, the SBP Initiator may also use information received via other means (e.g., IP/MAC Addresses provided by the upper layer applications etc.) to select the SBP Responder and sensing responders for the SBP Procedure.

Alternatively, it is also possible that initially SBP Initiator requests measurement results from “all/many” available links but subsequently selects a subset of links that are most suitable for the sensing application in subsequent SBP request(s). The link selection may be based on statistical analysis of the sensing measurement reports for the links; for example, the links in which the CSI feedback are insensitive to the needs of the sensing application may be omitted in later SBP requests.

It is noted that the SBP initiator (STA-5) may either be associated with the AP-1 (SBP Responder) in which case it is assumed to have already completed the usual authentication/association procedure with the AP-1 as well as setting up of security association (SA), for example, through a 4-way handshake prior to the initiation of the SBP Request; or, it may be unassociated with the AP-1 in which case it is assumed to have already completed the setting up of security associated with the AP-1, for example, through a pre-association security negotiation (PASN) through a 3-way handshake prior to the initiation of the SBP request.

STA-5 discovers AP-1 through the client discovery procedure and select it as the SBP responder. It then initiates an SBP procedure and requests the AP-1 to be a SBP responder (i.e., a proxy sensing initiator on STA-5's behalf) by transmitting a Protected SBP Request frame (addressed to AP-1) specifying operational parameters relating to SBP links and measurement attributes, such as minimum receive signal strength indicator (RSSI) or received channel power indicator (RCPI) and number of measurement links, as a condition to select one or more links to perform the sensing measurement.

In this case, STA-5 may specify a number of links of 2. Based on the operational parameter, AP-1 then decides one STA/link that is more relevant for the sensing measurements (in this case, an initiator-to-responder (I2R) link attached to STA-8) and sends a sensing request (or forward the SBP request frame) to another co-located AP (AP-2) operating in different channel, requesting AP-2 to act as a secondary proxy sensing initiator for the SBP procedure to select one other link and perform WLAN sensing to meet the condition specified by STA-5. Alternatively or additionally, the SBP initiator may indicate one or more STA/link explicitly during the SBP Request phase. (e.g., the SBP initiator includes, in a request frame for SBP request, the addresses/IDs of candidate sensing responders and/or link ID/frequency band information.) It is noted that, although communications between AP-1 and AP-2 through air (wireless) are depicted in the FIGS. 13 and 14, the communication of the sensing request between the APs (AP-1 and AP-2) may be internal to or through wire within the device. The AP-1 may indicate in the sensing request the link and the STA, i.e., STA-7, on which AP-2 is to perform the WLAN sensing.

Each AP (AP-1, AP-2) initiates a sensing session setup and a sensing measurement setup with the selected STA or sensing responder (STA-8, STA-7) by transmitting a Protected Sensing Measurement Setup Request frame to it, respectively. In this embodiment, a different measurement setup identifier (ID) may be assigned to different measurement links by each AP (or in some embodiments, AP-1 (SBP responder)) for the SBP procedure. The measurement setup ID to be used by AP-2 is transmitted in the sensing request. In this case, the measurement setup ID of 1 is assigned and to be used by AP-1 for its sensing measurement with STA-8 and the measurement setup ID of 2 is assigned and to be used by AP-2 for its sensing measurement with STA-7.

Each STA or sensing responder (STA-8, STA-7) receiving the Protected Sensing Measurement Setup Request frame then transmits a Protected Sensing Measurement Setup Response frame back to its respective AP (AP-1, AP-2) indicating a successful sensing measurement setup, respectively. AP-2 (secondary proxy sensing initiator) sends a sensing response and passes the sensing measurement setup result back to AP-1 (SBP responder or primary proxy sensing initiator). Similarly, although communications between AP-1 and AP-2 through air (wireless) are depicted in the FIGS. 13 and 14, the communications between the APs may be internal to the device.

AP-1 consolidates the sensing response received from AP-2 and transmits a Protected SBP Response frame to indicate a successful setup with the sensing responders (links) to complete the SBP setup. AP-1 also chooses a measurement setup ID (in this case, ID “1”) to represent the SBP procedure. It is noted that, AP-1 may perform the translation or conversion between the two measurement setup IDs if needed (e.g., for SBP reporting, SBP termination etc.), that is, if the measurement setup (M.S.) IDs assigned by the other AP(s) such as AP-2 is different from the M.S. ID assigned by AP-1 for the SBP procedure, AP-1 will replaces the M.S. ID(s) of the applicable Sensing Measurement Reports to the M.S. ID that represents the SBP procedure. Such selected measurement setup ID that represents the SBP procedure is included in the SBP response frame. Additionally, Link information such as the STA IDs or other IDs which can be used to identify the measurement links is included in the response frame.

Subsequently, AP-1 and AP-2 each performs a sensing measurement instance with its selected STA (STA-8, STA-7) by transmitting an I2R Measurement PPDU (e.g., Sensing NDP). STA-8, STA-7, in response, measure their respective channels upon receiving the I2R Measurement PPDUs, and if requested, transmit their measurement reports. The measurement reports comprise their respective assigned measurement setup IDs. AP-2 forwards the sensing measurement report of its I2R link with STA-7 to AP-1.

AP-1 collects and consolidates the measurement report(s) on I2R link with STA-8, and transmits a Protected SBP Report frame comprising the measurement report to STA-5. The measurement report ID (ID “1”) and/or the Link information such as the STA IDs or other IDs are included in the report frame for identifying the STA-8 measurement link by STA-5. AP-1 also collects and consolidates the measurement report(s) on I2R link with STA-7 received from AP-2, and transmits a separate Protected SBP Report frame comprising the measurement report to STA-5. The SBP Report frame for other AP's link has a same format as a report for a responder-to-responder (R2R) link. Similarly, the measurement report ID (ID “2”), the AP ID and/or the Link information such as the STA IDs or other IDs are included in the report frame for identifying the STA-7 measurement link with by STA-5. In an alternative embodiment, AP-1 may consolidate the measurement reports on AP-1-STA-8 link and AP-2-STA-7 link and transmits a single Protected SBP Report frame comprising the measurement reports to STA-5.

Finally, after SBP procedure, STA-5 may initiate an SBP procedure termination by transmitting an SBP Termination frame (shown in FIG. 13 only) to AP-1. AP-1 then performs sensing measurement termination and sensing session termination with STA-8 for the sensing measurement setup ID (ID “1”) corresponding to the SBP procedure. AP-1 also sends a termination request to request AP-2 to perform sensing measurement termination and sensing session termination with STA-7 for the sensing measurement setup ID (ID “2”) corresponding to the SBP procedure.

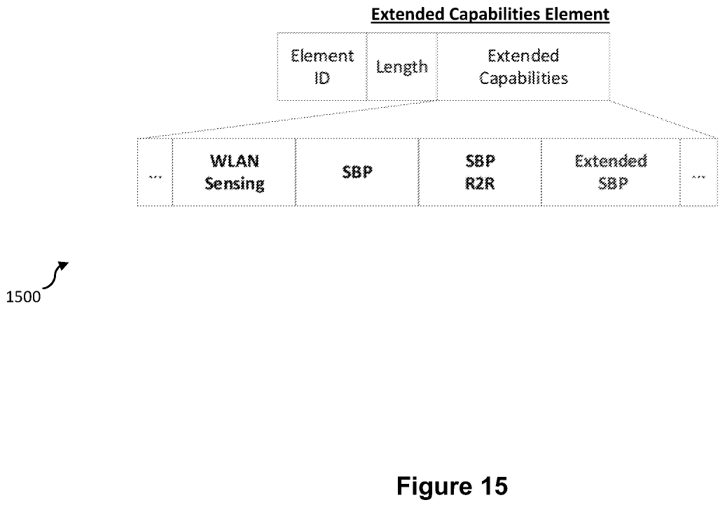

FIG. 15 shows an example format of an Extended Capabilities element 1500 used for basic discovery according to various embodiments of the present disclosure. The Extended Capabilities element 1500 is used to indicate a STA's or an AP's capabilities and support of certain services and communication features in applicable frames such as Beacon/Probe Response frames (in the frame body itself or within the Non-transmitted BSSID profile subelement). It comprises an Element ID field, a Length field and an Extended Capabilities field. The Extended Capabilities field comprises a WLAN sensing subfield, an SBP subfield, an SBP R2R subfield and an Extended SBP subfield. The SBP subfield indicates that the AP is capable of providing the Sensing By Proxy Service with its associated STAs. The SBP R2R subfield indicates that the AP is capable of providing the Sensing By Proxy Service for R2R links with its associated STAs. The Extended SBP subfield indicates that the AP is capable of providing extended SBP service. A requesting AP receiving the information in the Extended SBP subfield transmitted by another AP will understand that the other AP is able to accept request from the requesting AP to collect sensing measurement results on the requesting AP's behalf.

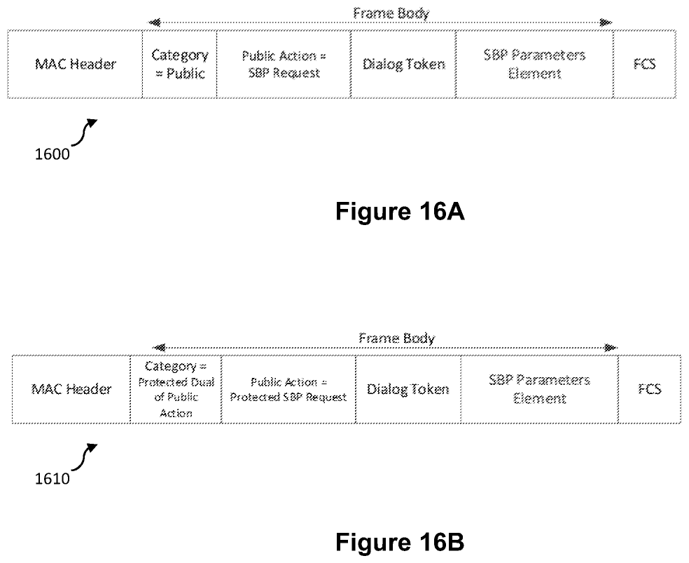

According to the present disclosure, an SBP initiator and an SBP Responder exchange SBP Request/Response/Termination frames to setup SBP procedure if security associated (SA) does not exist between them; otherwise, they exchange Protected SBP Request/Response frames. FIGS. 16A and 16B show example formats of an SBP Request frame 1600 and a Protected SBP Request frame 1610, respectively, according to various embodiments of the present disclosure. The SBP Request frame 1600 comprises a MAC Header (Frame Control field, Duration field, Recipient Address (RA) field and Transmitter Address (TA) field), a Category field which is set to “Public”, a Public Action field which is set to a value indicating that this frame is an SBP Request frame, a Dialog Token field, an SBP Parameter Element and a frame checking sequence (FCS) field. The SBP Protected frame 1610 comprises a MAC Header (Frame Control field, Duration field, RA field and TA field), a Category field which is set to “Protected Dual of Public Action”, a Public Action field which is set to a value indicating that this frame is a Protected SBP Request frame, a Dialog Token field, an SBP Parameter Element field and an FCS field.

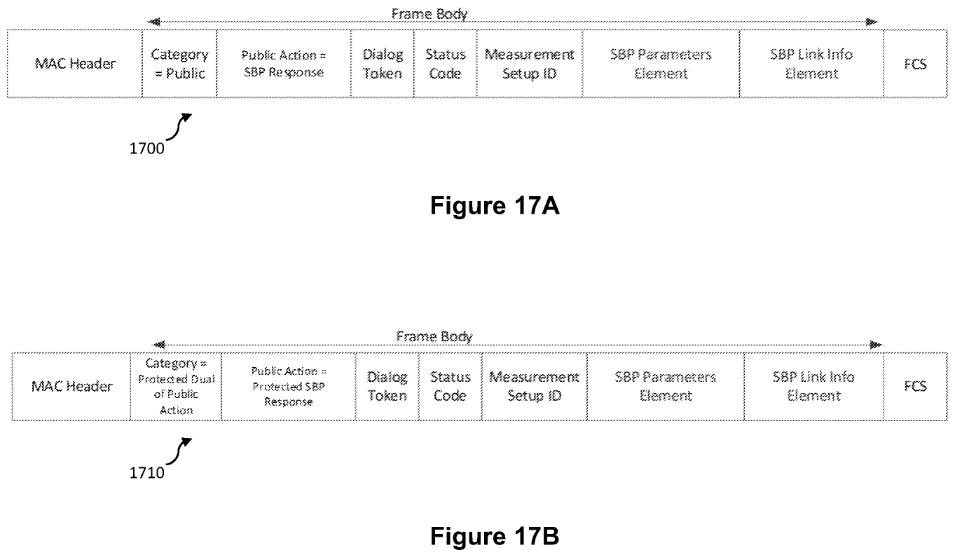

FIGS. 17A and 17B show example formats of an SBP Response frame 1700 and a Protected Response frame 1710, respectively, according to the first embodiment of the present disclosure. The SBP Response frame 1700 comprises a MAC Header (Frame Control field, Duration field, RA field and TA field), a Category field which is set to “Public”, a Public Action field which is set to a value indicating that this frame is an SBP Response frame, a Dialog Token field, a Status Code field, a Measurement Setup ID field, an SBP Parameter Element field, an SBP Link Info Element field and an FCS field. The Protected SBP Response frame 1710 comprises a MAC Header (Frame Control field, Duration field, RA field and TA field), a Category field which is set to “Protected Dual of Public Action”, a Public Action field which is set to a value indicating that this frame is a Protected SBP Response frame, a Dialog Token field, a Status Code field, a Measurement Setup ID field, an SBP Parameter Element field, an SBP Link Info Element field and an FCS field.

The Measurement Setup ID field is set to the Measurement Setup ID value chosen that uniquely represents an SBP procedure by the AP that accepts the corresponding SBP request. The Measurement Setup ID field is present in an SBP Response frame 1700, 1710 only if the status code field indicate “SUCCESS”.

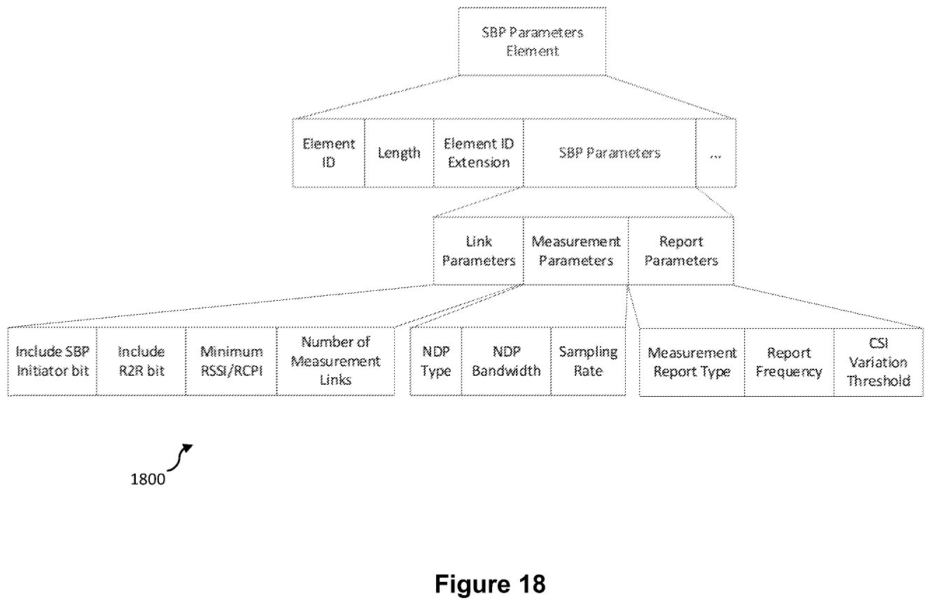

FIG. 18 shows an example format of the SBP Parameter Element field 1800 in the SBP Request/Response frames 1600, 1610, 1700, 1710 in FIGS. 16A-17B, according to the first embodiment of the present disclosure. The SBP Parameter Element field 1800 comprises an Element ID field, a Length field, an Element ID Extension field and an SBP Parameters field. The SBP Parameter field comprises a Link Parameters subfield, a Measurement Parameters subfield and a Report Parameter subfield which specify attributes related to the links to be measured, the measurement PPDUs and the SBP Reporting respectively.

The Link Parameter subfield comprises an Include SBP Initiator bit, an Include R2R bit, a Minimum RSSI/RCPI subfield and a Number of Measurement Links subfield. The Include SBP Initiator bit is set to 1 indicating a request to include the SBP Initiator as one of the sensing responder, therefore the measurement report on a link to which the SBP Initiator is attached will also be measured and included in the SBP report frame. The Include R2R bit is set to 1 to indicate that the R2R links may also be considered. The Minimum RSSI/RCPI subfield indicates an average RSSI or RCPI observed for the frames transmitted on a selected link is expected to be above the indicated level. The Number Of Links subfield indicates the number of links to be used for the sensing measurements.

The Measurement Parameters subfield comprises an NDP type subfield, an NDP Bandwidth subfield and a Sampling Rate subfield. The NDP type subfield indicate the NDP type or format (e.g., High Efficiency (HE), Extremely High Throughput (EHT) or Ranging, etc.) to be used to measure the channels. The NDP Bandwidth subfield indicates the channel bandwidth of the NDP to be used to measure the channels. The Sampling Rate subfield indicates the frequency of performing the measurements, that is, how often the sensing measurements are performed, in terms of Hz or number of measurements per second.

The Report Parameters subfield comprises a Measurement Report Type subfield, a Report Frequency subfield and a Channel State Information (CSI) Variation Threshold subfield. The Measurement Report Type subfield indicate the type of sensing measurement report to be used during the SBP Reporting procedure. The Report Frequency subfield indicates the frequency to transmit the SBP Report, that is, how often the SBP Reports are transmitted, in terms of Hz or number of transmissions per second. The CSI Variation Threshold subfield indicate a number between 0 to 1, which corresponds to a threshold value to be used to determine whether the change in measured CSI is significant enough for the AP to generate the SBP report.

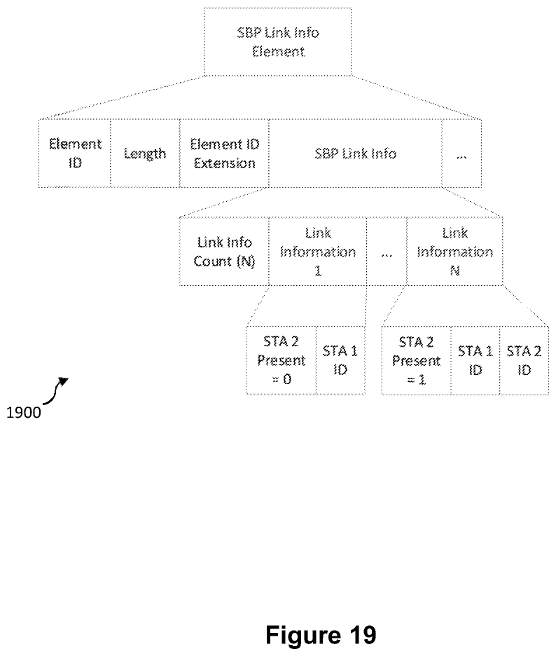

FIG. 19 shows an example format of the SBP Link Info Element field 1900 in the SBP Response frames 1700, 1710 in FIGS. 17A and 17B according to the first embodiment of the present disclosure. The SBP Link Info Element field comprises an Element ID field, a Length field, an Element ID Extension field and an SBP Link Info field. The SBP Link Info field comprises a Link Info Count (N) subfield and one or more Link Information field corresponding to one or more links. The Link Info Count (N) subfield indicates the number of links (Links Information subfields) present in the SBP Link Info field. Each Link Information subfield comprises a STA2 Present subfield, a STA1 ID subfield and a STA2 ID subfield (if the STA2 Present subfield is set to 1). For initiator-to-responder (I2R) or responder-to-initiator (R2I) links in which the SBP Responder itself is attached, the STA2 Present subfield is set to 0 and the STA1 ID subfield indicates the STA ID (e.g., MAC address or Associated Identifier (AID)) of the STA attached to the other end of the link. Although not shown in the figure, a bit in the Link Information field may indicate whether the link is I2R or R2I, e.g. I2R if the bit is set to 0 and R2I if the bit is set to 1. For R2R links or links of other APs, the STA2 Present subfield is set to 1 and the STA1 and STA2 ID subfields indicate the STA IDs (e.g., MAC addresses or AIDs) of the two STAs attached to the two ends of the link. Alternatively, instead of STA IDs, a unique Link ID for each measurement link (assigned during sensing measurement setups for the SBP procedure) may be included in the Link Information subfield(s). The SBP Initiator will use the Link ID(s) to identify the measurement links in subsequent frames.

Regarding SBP Reporting, the sensing measurement results obtained in the WLAN sensing procedure resultant from an SBP request is reported to the SBP initiator by the SBP responder in a Protected SBP Report frame which is either constructed by the SBP responder (AP) itself (if the AP is also the sensing receiver), or constructed by adding the Link Information field (depicted in FIG. 19) and updating a Report Length field in each Sensing Measurement Report field obtained in the Sensing Measurement Report frame sent by the Sensing Responders on the link.

According to the first embodiment of the present disclosure, the selection of other AP(s) and sensing measurements in other BSS(s) can be achieved. Referring to FIG. 12, when STA-5 (SBP initiator) requests AP-1 (SBP responder) to perform SBP procedure for 2 links while AP-1 and AP-2 are members of a multiple BSSID set, AP-2 corresponding to the transmitted BSSID (i.e., it transmits Beacon frames) and AP-2 corresponding to non-transmitting BSSID, in addition to selecting a STA(s)/link(s) (e.g., STA-8) to be used for SBP sensing measurement in its own BSS based on the condition(s)/attribute(s) indicated in an SBP request, the SBP responder (e.g., AP-1) may also request another co-located AP (e.g., AP-2) to select one or more STAs/links to perform sensing measurement in the other AP's BSS on behalf of SBP initiator (STA-5). If AP-2 accepts the request, it proceeds to setup sensing measurements with its associated non-AP STA(s). If the sensing measurement setups are successful, AP-2 proceeds to perform sensing measurement instances on the selected link(s) (e.g., STA-7) based on the attributes indicated in the SBP request and collects the sensing measurement reports from the sensing responder(s) if applicable. Finally, AP-2 consolidates the sensing measurement report(s) and forwards it (them) to the SBP responder (AP-1), which in turn forwards the sensing measurement report(s) to the SBP initiator in a SBP report frame.

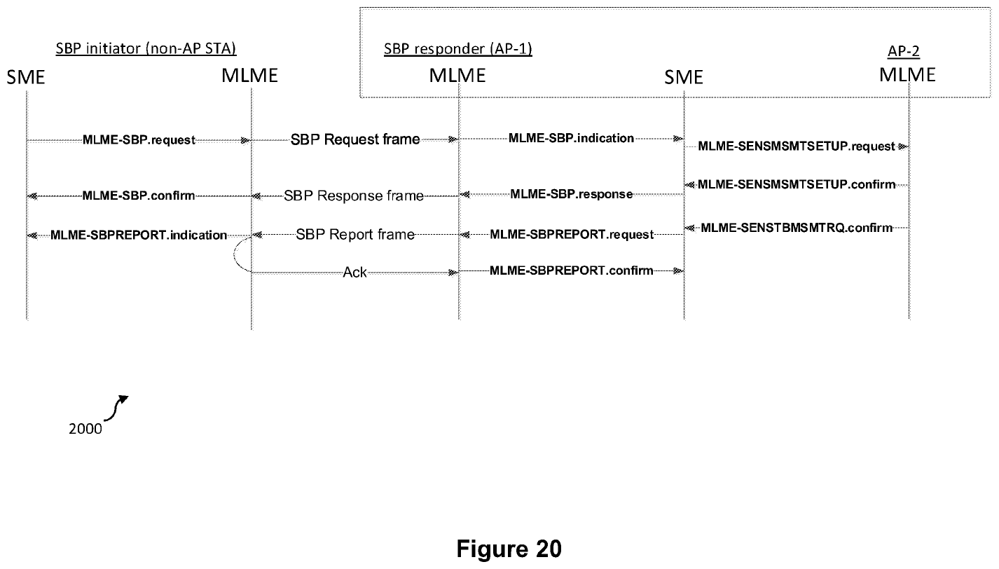

FIG. 20 shows a flowchart 2000 illustrating communications between an SBP Initiator (non-AP STA) and an SBP Responder (AP), such as communications between Station management entities (SMEs) and MAC Sublayer Management Entities (MLMEs) of the SBP Initiator and the SBP Responder, for sensing by proxy according to the first embodiment of the present disclosure.

A MLME-SBP.request primitive is issued to the MAC sublayer by the SME of non-AP STA (SBP Initiator) such as STA-5 to requests for a transmission of an SBP Request frame to a peer STA (SBP Responder) such as AP-1. Upon receipt of this primitive, the MLME of the SBP Initiator constructs an SBP Request frame and causes it to be transmitted to the SBP Responder's MAC address. The MLME-SBP.request primitive and its primitive parameters are illustrated as follows.

```
MLME-SBP.request(
  PeerSTAAddress,
  SBPParameters
  )
```

Table 1 shows details of primitive parameters included in a MLME-SBP.request primitive.

TABLE 1

| Name | Type | Valid range | Description |
|---|---|---|---|
| PeerSTAAddress | MAC Address | Any valid individual | Specifies the |
| | | MAC address | address of the peer |
| | | | MAC entity with |
| | | | which the SBP |
| | | | procedure is to be |
| | | | performed. |
| SBPParameters | SBP Parameters | As defined in the | Specifies the |
| | Element | SBP Parameters | parameters for the |
| | | Element | SBP Setup. |

The MLME-SBP.indication primitive is issued by the MAC sublayer to the SME of AP-1 to inform the reception of the SBP Request frame from a peer STA (SBP Initiator). Upon receipt of this primitive, the SME initiates an SBP procedure (e.g., perform sensing measurements with STA-8) on behalf of the peer STA. The MLME-SBP.inidication primitive and its primitive parameters are illustrated as follows.

```
MLME-SBP.indication (
  PeerSTAAddress,
  SBPParameters
  )
```

Table 2 shows details of primitive parameters included in a MLME-SBP.indication primitive.

TABLE 2

| Name | Type | Valid range | Description |
|---|---|---|---|
| PeerSTAAddress | MAC Address | Any valid individual | Specifies the |
| | | MAC address | address of the peer |
| | | | MAC entity from |
| | | | which the SBP |
| | | | Request frame is |
| | | | received. |
| SBPParameters | SBP Parameters | As defined in the | Specifies the |
| | Element | SBP Parameters | parameters for the |
| | | Element | SBP Setup. |

When the APs (e.g., AP-1 and AP-2) are co-located in the same physical device (e.g., if the APs are members of a multiple BSSID set), they may share a common station management entity (SME) and the SME may perform selection of the AP(s) for SBP procedure. Since the information included in the SBP request (e.g., link/measurement information etc.) are passed up the SME, the SME can use the information to decide additional APs to act as sensing initiators as well as the STAs/links to be chosen for sensing measurements for the SBP procedure. For example, upon receiving a MLME-SBP.indication primitive from AP-1's MLE (triggered by reception of the SBP request frame), the SME may select AP-2 (co-located AP) to act as an additional sensing initiator (in addition to AP-1) for the SBP procedure and issue an MLME-SENSMSMTSETUP.request primitive to AP-2 instructing it to perform a sensing measurement setup with one of its non-AP STA (e.g., STA-7) according to the condition(s)/attribute(s) specified in the SBP request frame. The MLME-SENSMSMTSETUP.request primitive is illustrated as follows.

```
MLME-SENSMSMTSETUP.request (
  PeerSTAAddress,
  SensingMeasurementParameters
  )
```

Table 3 shows details of primitive parameters included in an MLME-SBP.indication primitive.

TABLE 3

| Name | Type | Valid range | Description |
|---|---|---|---|
| PeerSTAAddress | MAC Address | Any valid individual | Specifies the |
| | | MAC address | address of the peer |
| | | | MAC entity with |
| | | | which the Sensing |
| | | | Measurement |
| | | | Setup is to be |
| | | | performed. |
| SensingMeasurementParameters | Enumerated value | As defined in the | Specifies the |
| | | Sensing Measurement | parameters for the |
| | | Parameters Element | Sensing Measurement |
| | | | Setup. |

Once the MLME-SENSMSMTSETUP.confirm primitive is received from AP-2 indicating a successful sensing measurement setup, the SME issues a MLME-SBP.response primitive to the AP-1's MLME.

The MLME-SBP.response primitive is issued to the MAC sublayer by the SME of the SBP Responder in response to the MLME-SENSMSMTSETUP.confirm primitive and request for a transmission of an SBP Response frame to the peer STA (SBP Initiator). On receipt of the primitive, the MLME of AP-1 constructs an SBP Response frame and causes it to be transmitted to the SBP Initiator's MAC address. The MLME-SBP.response primitive and its primitive parameters are illustrated as follows.

```
MLME-SBP.response (
  PeerSTAAddress,
  StatusCode,
  SBPParameters,
  MeasurementSetupID,
  SBPLinkInfo
  )
```

Table 4 shows details of primitive parameters included in a MLME_SBP_response primitive.

TABLE 4

| Name | Type | Valid range | Description |
|---|---|---|---|
| PeerSTAAddress | MAC Address | Any valid individual | Specifies the |
| | | MAC address | address of the peer |
| | | | MAC entity with |
| | | | which the SBP |
| | | | procedure is to be |
| | | | performed. |
| StatusCode | Enumerated value | As defined in the | Indicates the status |
| | | Status Code field. | of the SBP Request |
| SBPLinkInfo | SBP Link Info | As defined in the | Identifies the link(s) |
| | Element | SBP Link Info | corresponding to the |
| | | Element | SBP sensing |
| | | | measurements. |
| MeasurementSetupID | Integer | Any valid ID | Specifies the |
| | | | Measurement Setup |
| | | | ID assigned for the |
| | | | SBP setup. |
| SBPParameters | SBP Parameters | As defined in the | Specifies the |
| | Element | SBP Parameters | parameters for the |
| | | Element | SBP Setup. |

The MLME-SBP.confirm primitive is issued by the MAC sublayer to the SME of the SBP Initiator to inform the results of the SBP Request upon receipt of the SBP Response from the peer STA (SBP Responder). THE MLME-SBP.confirm primitive and its primitive parameters are illustrated as follows.

```
MLME-SBP.confirm (
  PeerSTAAddress,
  StatusCode,
  SBPParameters,
  MeasurementSetupID,
  SBPLinkInfo
  )
```

Table 5 shows details of primitive parameters included in a MLME-SBP.confirm primitive.

TABLE 5

| Name | Type | Valid range | Description |
|---|---|---|---|
| PeerSTAAddress | MAC Address | Any valid individual | Specifies the |
| | | MAC address | address of the peer |
| | | | MAC entity from |
| | | | which the SBP |
| | | | Response frame is |
| | | | received. |
| StatusCode | Enumerated value | As defined in the | Indicates the status |
| | | Status Code field. | of the SBP Request |
| SBPLinkInfo | SBP Link Info | As defined in the | Identifies the link |
| | Element | SBP Link Info | corresponding to the |
| | | Element | SBP sensing |
| | | | measurements. |
| MeasurementSetupID | Integer | Any valid ID | Specifies the |
| | | | Measurement Setup |
| | | | ID assigned for the |
| | | | SBP setup. |
| SBPParameters | SBP Parameters | As defined in the | Specifies the |
| | Element | SBP Parameters | parameters for the |
| | | Element | SBP Setup. |

Subsequently, upon receiving the MLME-SENSMSMTRQ.confirm primitive indicating a receipt of sensing measurement reports for the link with STA-7, the SME issues a MLME-SBPREPORT.request primitive to AP-1's MLME to cause it to transmit a SBP report frame carrying the sensing measurement reports to the SBP initiator.

The MLME-SBPREPORT.request primitive is issued to the MAC sublayer by the SME of the SBP Responder to requests a transmission of an SBP Report frame to the Peer STA (SBP Initiator). Upon receipt of the primitive, the MLME of the SBP Responder constructs an SBP Report frame and causes it to be transmitted to the SBP Initiator's MAC address. The MLME-SBPREPORT.request primitive and its primitive parameters are illustrated as follows.

```
MLME-SBPREPORT.request (
  PeerSTAAddress,
  SensingMeasurementReportList
  )
```

Table 6 shows details of primitive parameters included in a MLME-SBPREPORT.request primitive.

TABLE 6

| Name | Type | Valid range | Description |
|---|---|---|---|
| PeerSTAAddress | MAC Address | Any valid individual | Specifies the |
| | | MAC address | address of the peer |
| | | | MAC entity to |
| | | | which the SBP |
| | | | Report frame is |
| | | | to be transmitted. |
| SensingMeasurementReportList | Sensing Measurement | As defined in the | Carries one or |
| | Report List | SBP Report frame | more Sensing |
| | | | Measurement Reports |
| | | | corresponding to |
| | | | the SBP procedure |

The MLME-SBRREPORT.indication primitive is issued by the MAC sublayer to the SME of the SBP Initiator to inform the receipt of SBP Report frame from the peer STA (SBP Responder). The MLME-SBRREPORT.indication primitive and its primitive parameters are illustrated as follows.

```
MLME-SBPREPORT.indication (
  PeerSTAAddress,
  SensingMeasurementReportList
  )
```

Table 7 shows details of primitive parameters included in a MLME-SBPREPORT.request primitive.

TABLE 7

| Name | Type | Valid range | Description |
|---|---|---|---|
| PeerSTAAddress | MAC Address | Any valid individual | Specifies the |
| | | MAC address | address of the peer |
| | | | MAC entity from |
| | | | which the SBP |
| | | | Report frame is |
| | | | received. |
| SensingMeasurementReportList | Sensing Measurement | As defined in the | Carries one or |
| | Report List | SBP Report frame | more Sensing |
| | | | Measurement Reports |
| | | | corresponding to |
| | | | the SBP procedure |

The MLME-SBPREPORT.confirm primitive is issued by the MAC sublayer to the SME of SBP Responder to inform the result of the request for the transmission of the SBP Report frame. The MLME-SBPREPORT.confirm primitive and its primitive parameters are illustrated as follows.

```
MLME-SBPREPORT.confirm (
  PeerSTAAddress,
  StatusCode,
  )
```

Table 8 shows details of primitive parameters included in a MLME-SBPREPORT.confirm primitive.

TABLE 8

| Name | Type | Valid range | Description |
|---|---|---|---|
| PeerSTAAddress | MAC Address | Any valid individual | Specifies the |
| | | MAC address | address of the peer |
| | | | MAC entity to |
| | | | which the SBP |
| | | | Report frame is |
| | | | transmitted. |
| StatusCode | Enumerated value | As defined in the | Indicates the status |
| | | Status Code field. | of the request to |
| | | | transmit the SBP |
| | | | Report frame. |

It is noted that, if the co-hosted AP does not share the same SME as the AP acting as the SBP responder receiving the SBP request frame, a similar setup or information exchange may be performed by upper layer application which performs similar roles as the common SME for the Multiple BSSID set.

According to the first embodiment of the present disclosure, the Sensing Measurement results obtained in a WLAN sensing procedure resultant from an SBP request is reported to the SBP initiator (by the SBP Responder) in a Protected SBP Report frame which is either constructed by the AP itself (if the AP is also the sensing receiver), or, constructed by adding a Link Information field to each Sensing Measurement Report field obtained in the Sensing Measurement Report frame sent by the Sensing Responders in its own BSS as well as those received from other APs. If the measurement setup (M.S.) IDs assigned by the other AP(s) is different from the M.S. ID assigned by the SBP Responder for the SBP procedure, the SBP Responder also replaces the M.S. ID(s) of the applicable Sensing Measurement Reports to the M.S. ID that represents the SBP procedure.

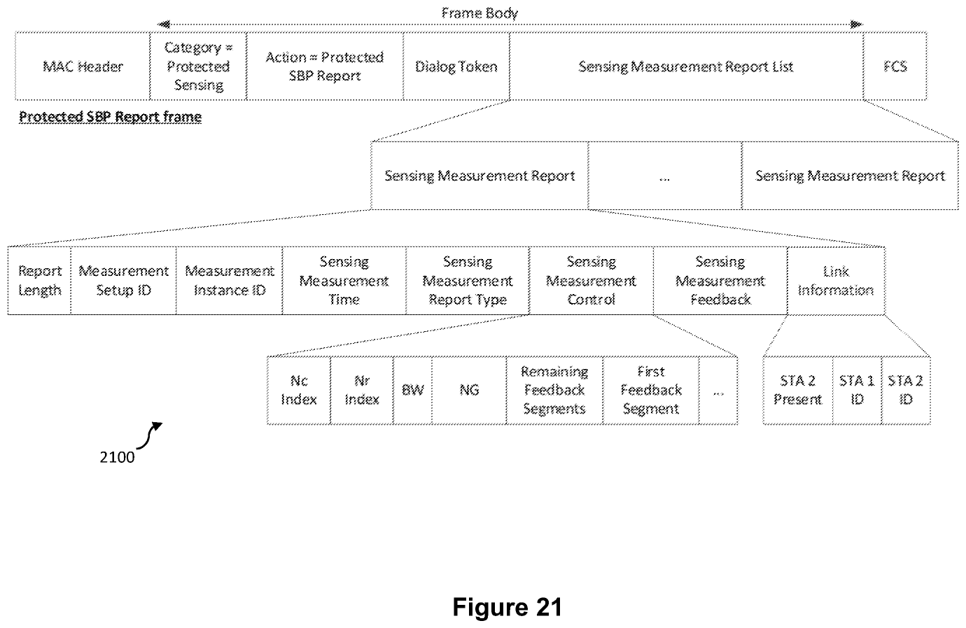

FIG. 21 shows an example format of a Protected SBP Report frame 2100 according to the first embodiment of the present disclosure. The SBP Report frame 2100 comprises a MAC Header (Frame Control field, Duration field, RA field and TA field), a Category field which is set to “Protected Sensing”, an Action field which is set to “Protected SBP Report”, a Dialog Token field, a Sensing Measurement Report List field, and an FCS field. The Sensing Measurement Report List field comprises one or more Sensing Measurement Report fields corresponding to one or more links. Each Sensing Measurement Report field comprises a Report Length field, a Measurement Setup ID field, a Measurement Instance ID field, a Sensing Measurement Time field, a Sensing Measurement Report Type field, a Sensing Measurement Control field, a Sensing Measurement Feedback field and a Link Information field. The Report Length field indicates the length of the Sensing Measurement Report field. If Link Information field is added, the Report Length field should also be updated accordingly. The Measurement Setup ID field indicates the Measurement Setup ID value corresponding to the SBP procedure. The Measurement Instance ID field identifies the measurement instance in which the sensing measurement is performed. The Sensing Measurement Time field indicates the measurement timestamp at which the measurement was performed by the Sensing Receiver (responder). The Sensing Measurement Control field may comprise an Nc Index subfield, an Nr index subfield, a Bandwidth (BW) subfield, an NG (number of group) subfield, a Remaining Feedback Segments subfield and a First Feedback Segment subfield. The Sensing Measurement Feedback comprises the sensing measurement results for example, CSI or partial CSI, etc. The Link Information, which is described in FIG. 19, comprises a STA2 Present subfield, a STA1 ID subfield and a STA2 ID subfield (STA2 ID subfield is only present if the STA2 Present subfield is set to 1 to indicate an R2R link or another BSS's link). The STA1 and STA2 ID subfields carry IDs (e.g., MAC Address or AID) of the sensing responders to identify the link corresponding to the sensing measurement report. Alternatively, instead of STA IDs, a unique Link ID for each measurement link may be assigned and included in the Link Information subfield(s).

In the following paragraphs, a second embodiment of the present disclosure where an extended SBP procedure through APs which are affiliated/attached to the same AP MLD, is described. Two examples of the second embodiment are illustrated. In the first example, an extended SBP procedure initiated by a non-AP STA which is a non-MLD STA is illustrated; whereas in the second example, an extended SBP procedure initiated by a non-AP MLD is illustrated.

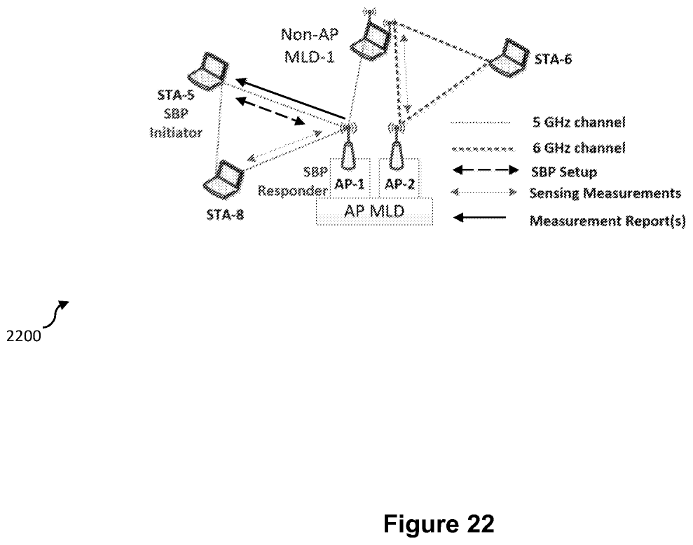

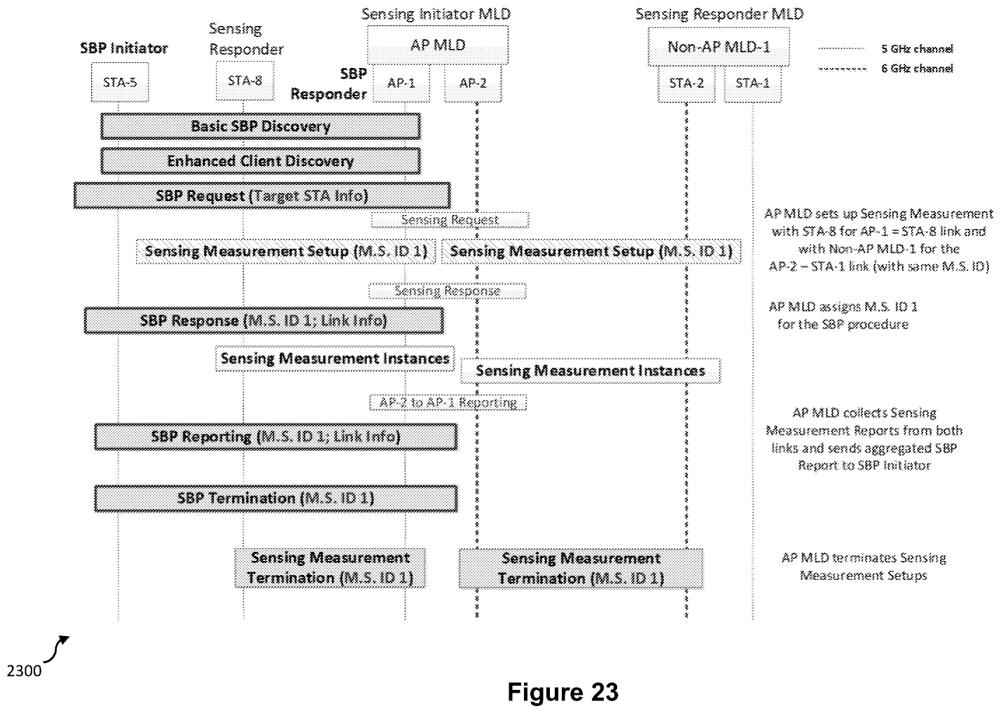

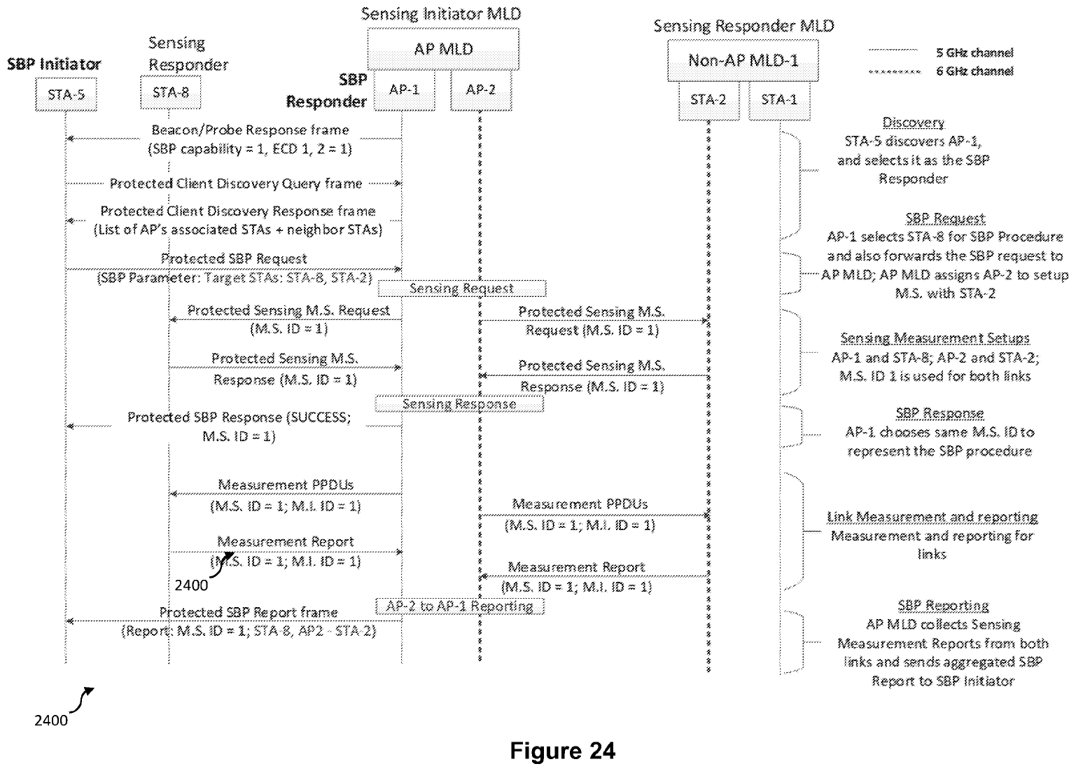

FIG. 22 shows a schematic diagram 2200 illustrating communications in an extended SBP procedure according to the first example of the second embodiment of the present disclosure. In this example of the second embodiment, the SBP initiator is a non-MLD STA while the SBP responder AP and the other AP selected by the SBP responder are affiliated to an AP MLD. FIG. 23 shows a flowchart 2300 illustrating an overview of an extended SBP procedure among the two APs (AP-1, AP-2), the non-AP MLD (non-AP MLD-1) and STA-8 in FIG. 22. FIG. 24 shows a flowchart 2400 illustrating a detailed procedural flow of the extended sensing by proxy procedure among the two APs, the non-AP MLD and the STA-8 in FIG. 22. In this example, AP-1 and AP-2 are affiliated with an AP MLD, while STA-1 and STA-2 are affiliated with the non-AP MLD-1.

Firstly, AP MLD (or AP-1 or AP-2 separately) advertises its capability to support enhanced client discovery and basic information about associated non-AP STAs (e.g., count/number of associated STAs etc.) using a Beacon/Probe Response frame. STA-5 may perform a basic SBP discovery procedure and discover an AP-1's support of the SBP function. STA-5 may then select the AP-1 as its SBP responder.

Secondly, STA-5 may then initiate an enhanced client discovery procedure by transmitting a protected client discovery query frame to request AP-1 to provide a list of non-AP STAs (AP-1's associated non-AP STAs and optionally unassociated non-AP STAs, AP-2's associated non-AP STAs and unassociated non-AP STAs). In this case, the AP MLD then transmits, through AP-1, a protected Client Discovery Response frame with the requested list of non-AP STAs and, optionally, their respective neighboring STAs, and the enhanced client discovery procedure ends. In this enhanced client discovery procedure, the SBP initiator discovers the information of AP-1 and potential sensing responders. In particular, AP-1 already has basic information about associated STAs, e.g., their operating channel(s), sensing capabilities and R2R sensing capabilities etc., The SBP Initiator (STA-5) can obtain such information from AP-1 using Level 1 Client Discovery Query. Although it is not shown in the figure, upon receiving request from the SBP Initiator (or even on its own), AP-1 may collect other relevant information from its associated STAs for example their location/position of the STAs, RSSI (or propagation loss) to/from the STAs (to represent a distance between the STAs and AP-1) and information about the STA's neighboring STAs including link metrics etc. With that, the SBP Initiator can obtain such relevant information about AP-1's associated STAs (and their neighboring STAs) from AP-1 using Level 2 Client Discovery Query. Based on the above information, the SBP Initiator can select one or more APs as SBP Responder(s) as well as one or more non-AP STAs as target sensing responders for the SBP Procedure. Alternatively, if, for example, AP-1 does not support Enhanced Client Discovery, or in addition to the information collected via Enhanced Client Discovery, the SBP Initiator may also use information received via other means (e.g., IP/MAC Addresses provided by the upper layer applications etc.) to select the SBP Responder and sensing responders for the SBP Procedure.

Alternatively, it is also possible that initially SBP Initiator requests measurement results from “all/many” available links but subsequently selects a subset of links that are most suitable for the sensing application in subsequent SBP request(s). The link selection may be based on statistical analysis of the sensing measurement reports for the links; for example, the links in which the CSI feedback are insensitive to the needs of the sensing application may be omitted in later SBP requests.

It is noted that the SBP initiator (STA-5) may either be associated with AP-1 in which case it is assumed to have already completed the usual authentication/association procedure with AP-1 as well as setting up of security association (SA), for example, through a 4-way handshake prior to the initiation of the SBP Request; or, it may be unassociated with AP-1 in which case it is assumed to have already completed the setting up of security associated with the AP-1, for example, through a pre-association security negotiation (PASN) through a 3-way handshake prior to the initiation of the SBP request.

STA-5 discovers AP-1 through the client discovery procedure and select it as the SBP responder. It then initiates an SBP procedure and requests the AP-1 to be a SBP responder (i.e., a proxy sensing initiator on STA-5's behalf) by transmitting a Protected SBP Request frame (addressed to AP-1) specifying operational parameters relating to SBP links and measurement attributes, such as specific target STA(s)/link(s), minimum receive signal strength indicator (RSSI) or received channel power indicator (RCPI) and number of measurement links, as a condition to select one or more links to perform the sensing measurement. In this case, STA-5 includes information of two target STAs/links related to STA-8 and STA-2 as the operational parameters for the SBP procedure.

Based on the operational parameters, AP-1 selects one STA/link (I2R link attached to STA-8) and also forwards the SBP request frame to the AP MLD. The AP MLD then assigns AP-2 as an additional AP to act as a secondary proxy sensing initiator, for example by forwarding a sensing request (e.g., with the SBP request frame) to AP-2, to select another STA/link (I2R link attached to STA-2) under AP-2 to perform WLAN sensing to meet the condition specified by STA-5. Alternatively or additionally, the SBP initiator may indicate one or more STA/link explicitly during the SBP Request phase. (e.g., the SBP initiator includes, in a request frame for SBP request, the addresses/IDs of candidate sensing responders and/or link ID/frequency band information.)

Each AP (AP-1, AP-2) initiates a sensing session setup (not shown in the figure) and a sensing measurement setup with the selected STA or sensing responder (STA-8, non-AP MLD-1 through STA-2) by transmitting a Protected Sensing Measurement Setup Request frame to it, respectively. In this example, a same measurement setup ID (ID “1”) is assigned by the SBP responder to different measurement links for the SBP procedure. The measurement setup ID to be used by AP-2 is transmitted in the sensing request.

Each STA or sensing responder (STA-8, non-AP MLD-1 through STA-2) receiving the Protected Sensing Measurement Setup Request frame then transmits a Protected Sensing Measurement Setup Response frame back to its respective AP (AP-1, AP-2) indicating a successful sensing measurement setup, respectively. AP-2 (secondary proxy sensing initiator) sends a sensing response and passes the sensing measurement setup result back to AP-1 (SBP responder).

AP-1 consolidate the sensing response received from AP-2 and transmits a Protected SBP Response frame to indicate a successful setup with the sensing responders (links) to complete the SBP setup.

Subsequently, AP-1 and AP-2 each performs a sensing measurement instance (in this case under a same measurement instance ID “1”) with its selected STA (STA-8, STA-2, respectively) by transmitting an I2R Measurement PPDU (e.g., Sensing NDP). STA-8, STA-2, in response, measure their respective channels upon receiving the I2R Measurement PPDUs, and if requested, transmit their measurement reports. The measurement reports comprise their respective assigned measurement setup IDs. AP-2 forwards the sensing measurement report of its I2R link with STA-2 to AP-1.

AP-1 collects and consolidates the measurement report(s) on I2R link with STA-8, and the measurement report(s) on I2R link with STA-2 received from AP-2, and transmits a Protected SBP Report frame (aggregated measurement report) comprising the measurement reports back to STA-5. The measurement report ID (ID “1”) and/or the Link information such as the STA IDs or other IDs are included in the report frame for identifying the STA-8 measurement link and AP-2-STA-2 measurement link by STA-5.

Finally, after SBP procedure, STA-5 may initiate an SBP procedure termination by transmitting an SBP Termination frame (shown in FIG. 23 only) to AP-1. AP-1 then performs sensing measurement termination and sensing session termination with STA-7 for the sensing measurement setup ID (ID “1”) corresponding to the SBP procedure. AP-1 also sends the Termination frame to AP MLD which in turn forward to AP-2 to perform sensing measurement termination and sensing session termination with STA-2 for the sensing measurement setup ID (ID “1”) corresponding to the SBP procedure.

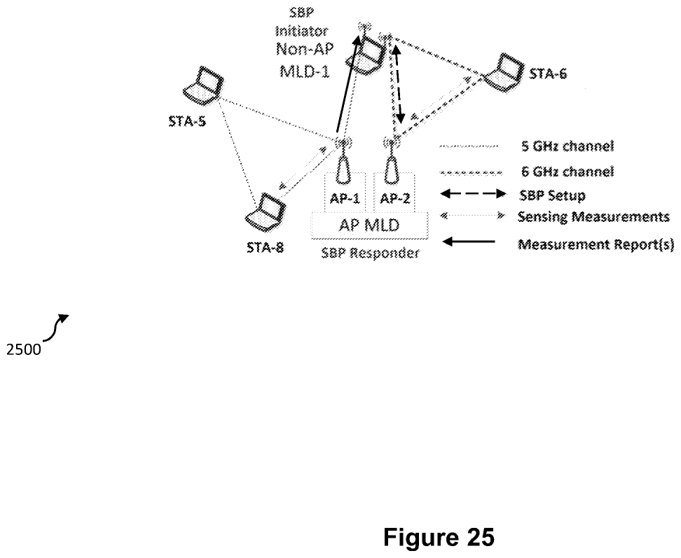

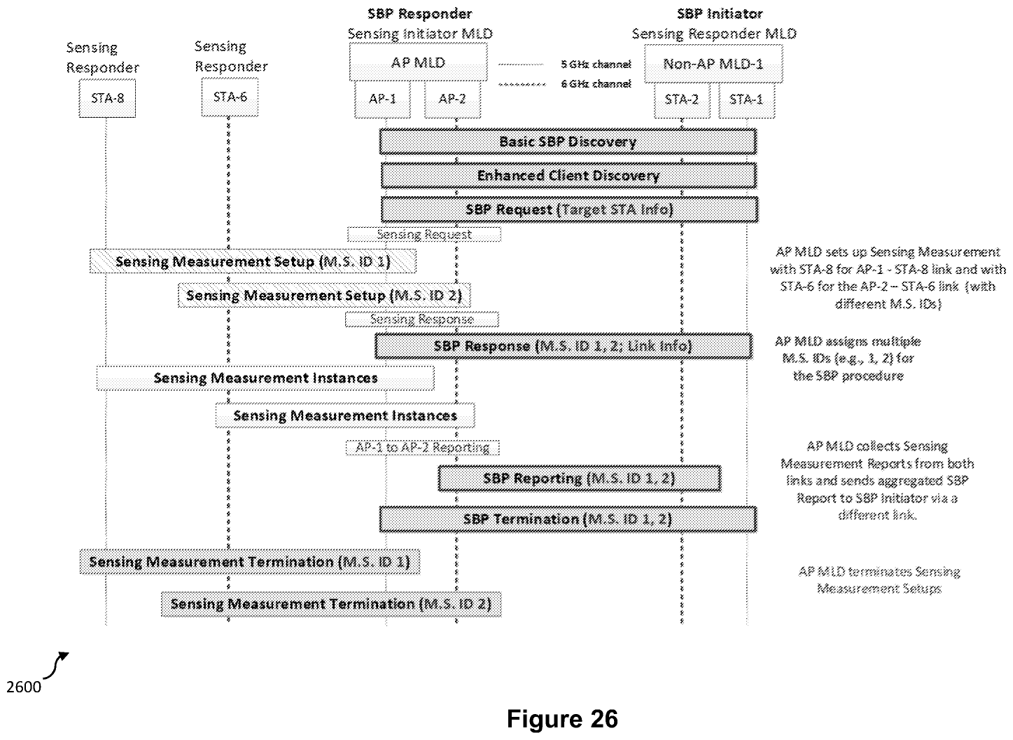

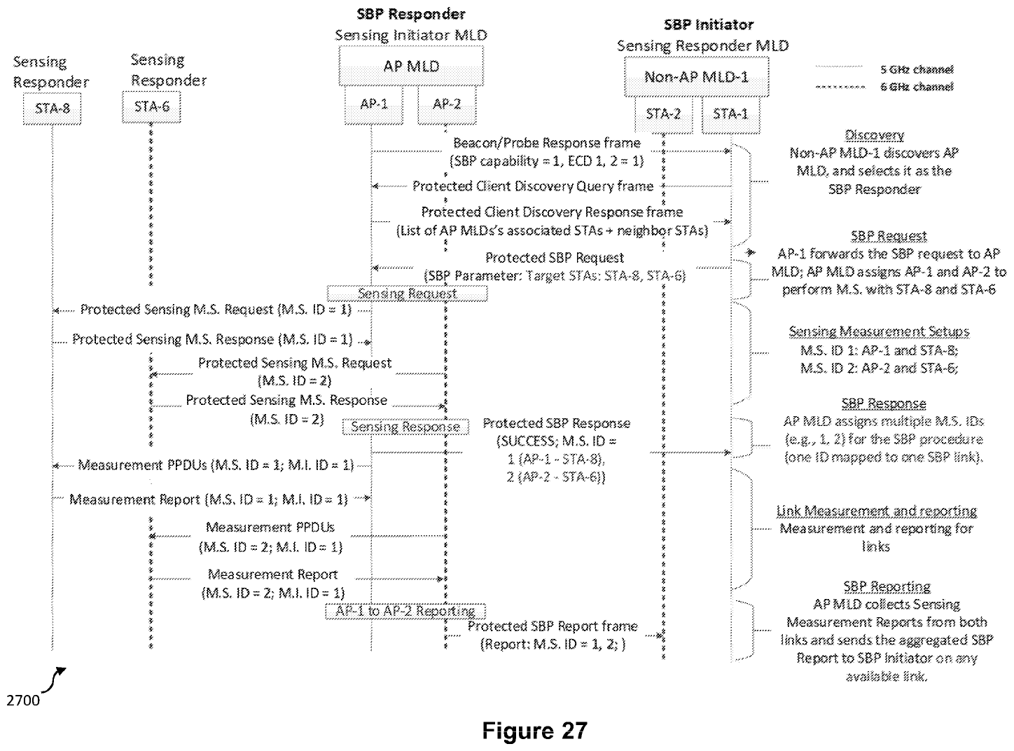

FIG. 25 shows a schematic diagram 2500 illustrating communications in an extended SBP procedure according to the second example of the second embodiment of the present disclosure. In this example of the second embodiment, the SBP initiator is a STA affiliated with a non-AP MLD while the SBP responder AP and the other AP selected by the SBP responder are affiliated to an AP MLD. FIG. 26 shows a flowchart 2600 illustrating an overview of an extended SBP procedure among the two APs (AP-1, AP-2), the non-AP MLD (non-AP MLD-1) and the two STAs (STA-6, STA-8) in FIG. 25. FIG. 27 shows a flowchart 2700 illustrating a detailed procedural flow of the extended sensing by proxy procedure among the two APs, the non-AP MLD and the two STAs in FIG. 25. In this example, AP-1 and AP-2 are affiliated with an AP MLD, while STA-1 and STA-2 are affiliated with the non-AP MLD-1. According to the present disclosure, in the case of MLDs, the SBP frames, such as SBP request, response, report frames, are considered MLD level frames and may be transmitted over any available links between the MLDs (in this example, between the AP MLD and the non-AP MLD-1).

Firstly, AP MLD (or AP-1 or AP-2 separately) advertises its capability to support enhanced client discovery and basic information about associated non-AP STAs (e.g., count/number of associated STAs etc.) using a Beacon/Probe Response frame. The non-AP MLD (non-AP MLD-1) may perform a basic SBP discovery procedure and discover an AP-1's support of the SBP function. The non-AP MLD may then select the AP MLD as its SBP responder.

Secondly, non-AP MLD may then initiate, through STA-1, an enhanced client discovery procedure by transmitting a protected client discovery query frame to request the AP-MLD to provide a list of non-AP STAs (AP-1's associated non-AP STAs and optionally unassociated non-AP STAs, AP-2's associated non-AP STAs and unassociated non-AP STAs). In this case, the AP MLD then transmits, through AP-1, a protected Client Discovery Response frame with the requested list of non-AP STAs and, optionally, their respective neighboring STAs, and the enhanced client discovery procedure ends. In this enhanced client discovery procedure, the SBP initiator discovers the information of the AP MLD and potential sensing responders. In particular, the AP-MLD already has basic information about associated STAs, e.g., their operating channel(s), sensing capabilities and R2R sensing capabilities etc., The SBP Initiator (non-AP MLD) can obtain such information from the AP-MLD using Level 1 Client Discovery Query. Although it is not shown in the figure, upon receiving request from the SBP Initiator (or even on its own), the AP MLD may collect other relevant information from its associated STAs for example their location/position of the STAs, RSSI (or propagation loss) to/from the STAs (to represent a distance between the STAs and AP-1) and information about the STA's neighboring STAs including link metrics etc. With that, the SBP Initiator can obtain such relevant information about the AP-MLD's associated STAs (and their neighboring STAs) using Level 2 Client Discovery Query. Based on the above information, the SBP Initiator can select one or more APs of the AP-MLD (e.g., AP-1 and AP-2) as SBP Responder(s) as well as one or more non-AP STAs as target sensing responders for the SBP Procedure. Alternatively, if, for example, AP-1 does not support Enhanced Client Discovery, or in addition to the information collected via Enhanced Client Discovery, the SBP Initiator may also use information received via other means (e.g., IP/MAC Addresses provided by the upper layer applications etc.) to select the SBP Responder and sensing responders for the SBP Procedure.

Alternatively, it is also possible that initially SBP Initiator requests measurement results from “all/many” available links but subsequently selects a subset of links that are most suitable for the sensing application in subsequent SBP request(s). The link selection may be based on statistical analysis of the sensing measurement reports for the links; for example, the links in which the CSI feedback are insensitive to the needs of the sensing application may be omitted in later SBP requests.

It is noted that the SBP initiator may be associated with the AP MLD in which case it is assumed to have already completed the usual authentication/association procedure with the AP or the AP MLD as well as setting up of security association (SA), for example, through a 4-way handshake prior to the initiation of the SBP Request; or, it may be unassociated with the AP MLD in which case it is assumed to have already completed the setting up of security associated with the AP or the AP MLD, for example, through a pre-association security negotiation (PASN) through a 3-way handshake prior to the initiation of the SBP request.

The non-AP MLD discovers the AP MLD through the client discovery procedure and select it as the SBP responder. It then initiates, e.g., through the AP-1 and STA-1 link, an SBP procedure and requests the AP MLD to be a SBP responder (i.e., a proxy sensing initiator on the non-AP MLD's behalf) by transmitting a Protected SBP Request frame on any available link (in this case, on the AP-1 to STA-1 link and the Request frame address to AP-1) specifying operational parameters relating to SBP links and measurement attributes, such as specific target STA(s)/link(s), minimum receive signal strength indicator (RSSI) or received channel power indicator (RCPI) and number of measurement links, as a condition to select one or more links to perform the sensing measurement. In this case, the non-AP MLD includes information of two target STAs/links related to STA-6 and STA-8 as the operational parameter for the SBP procedure.

AP-1 forwards the SBP request frame to the AP MLD. Based on the operational parameter, the AP MLD selects one STA/link (I2R link attached to STA-8) through AP-1 and another STA/link (I2R link attached to STA-6) through AP-2, assign the affiliated APs to act as sensing initiators to perform WLAN sensing to meet the condition specified by the non-AP MLD. A sensing request (e.g., with the SBP request frame) may be forwarded to AP-2 notify the assignment and WLAN sensing role.

Each AP (AP-1, AP-2) initiates a sensing session setup and a sensing measurement setup with the selected STA or sensing responder (STA-8, STA-6) by transmitting a Protected Sensing Measurement Setup Request frame to it, respectively. In this example, a different M.S. ID is assigned by the AP MLD to each measurement link for the SBP procedure. In this example, the I2R link between AP-2 and STA-8 is assigned to M.S. ID “1” and the I2R link between AP-1 and STA-6 is assigned to M.S. ID “2”. The M.S. ID to be used by AP-2 is transmitted in the sensing request to AP-2 by AP-1.

Each STA or sensing responder (STA-8, STA-6) receiving the Protected Sensing Measurement Setup Request frame then transmits a Protected Sensing Measurement Setup Response frame back to its respective AP (AP-1, AP-2) indicating a successful sensing measurement setup, respectively. AP-2 sends a sensing response and passes the sensing measurement setup result back to AP-1.

The AP-MLD consolidate the sensing response received from AP-1 and AP-2 and transmits a Protected SBP Response frame on any available link (in this case, on the AP-1 to STA-1 link) to indicate a successful setup with the sensing responders (links) to complete the SBP setup.

Subsequently, AP-1 and AP-2 each performs a sensing measurement instance (in this case under a same measurement instance ID “1”) with its selected STA (STA-8, STA-6, respectively) by transmitting an I2R Measurement PPDU (e.g., Sensing NDP). STA-8, STA-6, in response, measure their respective channels upon receiving the I2R Measurement PPDUs, and if requested, transmit their measurement reports. The measurement reports comprise their respective assigned measurement setup IDs. AP-2 forwards the sensing measurement report of its I2R link with STA-6 to AP-1.

The AP MLD collects and consolidates the measurement report(s) on I2R link with STA-8 through AP-1, and the measurement report(s) on I2R link with STA-6 through AP-2, and transmits a Protected SBP Report frame (aggregated measurement report) comprising the measurement reports back to the non-AP MLD on any available link (in this case, on AP-2 to STA-2 link). The measurement report IDs and/or the Link information such as the STA IDs or other IDs are included in the report frame for identifying the measurement links by the non-AP MLD.

Finally, after SBP procedure, the non-AP MLD may initiate an SBP procedure termination by transmitting an SBP Termination frame (shown in FIG. 26 only) to the AP MLD on any available link (in this case, on the AP-1 to STA-1 link). AP-1 and AP-2 then perform sensing measurement termination and sensing session termination with STA-8 and STA-6 for the sensing measurement setup IDs “1” and “2” corresponding to the SBP procedure, respectively.

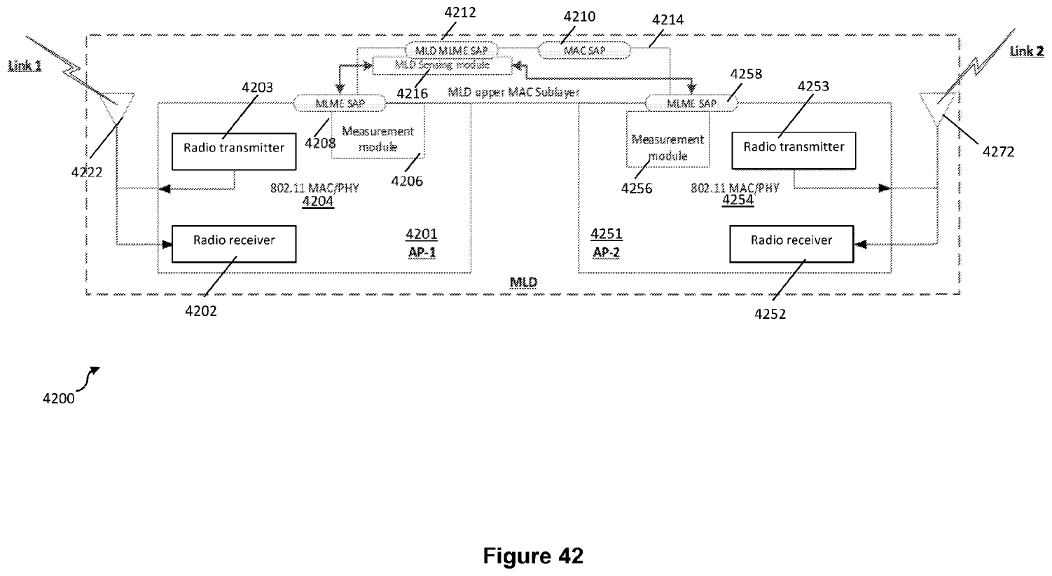

According to the second embodiment, the APs (AP-1 and AP-2) affiliated with the AP MLD are connected via the MLD upper MAC sublayer (see FIG. 42), where the MLD upper MAC sublayer comprises a MLD sensing module configured to coordinate the exchange of information among the affiliated APs for the SBP setup as well as SBP reporting. In this case, since the information included in the SBP Request (e.g., link/measurement, Target STA information etc.) are passed up the MLD Sensing module, the AP MLD uses the information to decide the additional affiliated APs to act as sensing initiators as well as the STAs/links to be chosen for sensing measurements for the SBP procedure, and instructions are passed on to the selected additional affiliated APs accordingly (e.g., by issuing MLME-SENSMSMTSETUP.request primitive(s)) to setup the sensing measurement setups derived from the attributes specified in the SBP Request frame.

Alternatively, the coordination between the affiliated APs may also happen via the SME except that if a same M.S. ID is to be used by all APs for sensing measurement setups corresponding to a single SBP setup, the MLME-SENSMSTSETUP.request primitive also includes the M.S. ID to be used. The AP MDLs also needs to ensure that the assigned M.S. ID is not already used by any of the affiliated APs.

The MLME-SENSMSMTSETUP.request primitive is issued to the MAC sublayer by the SME to requests the transmission of a Sensing Measurement Setup Request frame to a peer STA. On receipt of this primitive, the MLME constructs a Sensing Measurement Setup Request frame with the Measurement Setup ID set to MeasurementSetupID and causes it to be transmitted to the peer MAC address. The MLME-SBP.

SENSMSMTSETUP.request primitive and its primitive parameters are illustrated as follows.

```
MLME-SENSMSMTSETUP.request (
  PeerSTAAddress,
  SensingMeasurementParameters,
  MeasurementSetupID
  )
```

Table 9 shows details of primitive parameters included in an MLME-SBP.indication primitive.

TABLE 9

| Name | Type | Valid range | Description |
|---|---|---|---|
| PeerSTAAddress | MAC Address | Any valid individual | Specifies the |
| | | MAC address | address of the peer |
| | | | MAC entity with |
| | | | which the Sensing |
| | | | Measurement |
| | | | Setup is to be |
| | | | performed. |
| SensingMeasurementParameters | Enumerated value | As defined in the | Specifies the |
| | | Sensing Measurement | parameters for |
| | | Parameters Element | the Sensing |
| | | | Measurement Setup. |
| MeasurementSetupID | Integer | 0-255 | The same |
| | | | Measurement Setup |
| | | | (M.S.) ID to |
| | | | be used for the |
| | | | sensing measurement |
| | | | setup. |

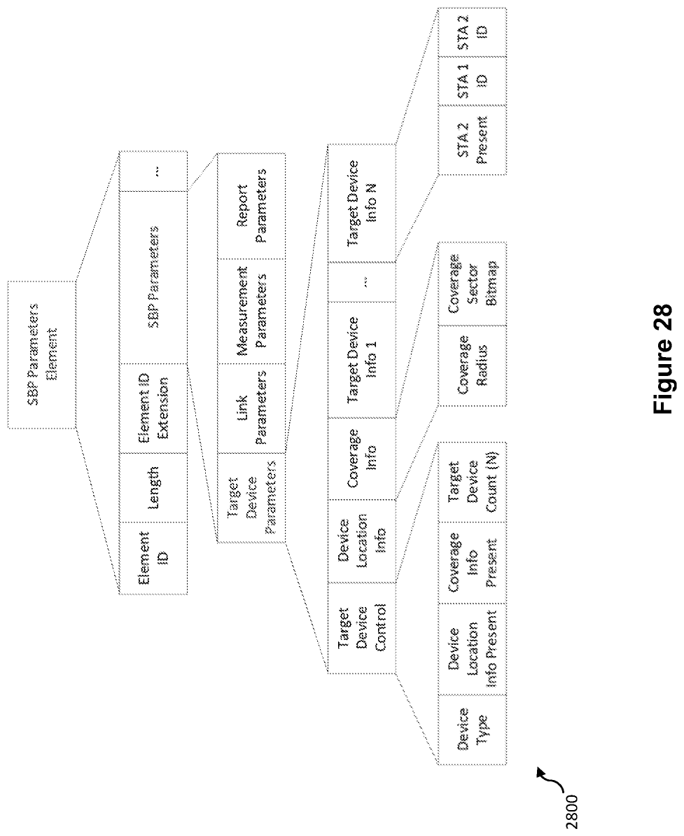

FIG. 28 shows an example format of the SBP Parameter Element field 2800 in the SBP Request/Response frames 1600, 1610, 1700, 1710 in FIGS. 16A-17B according to the second embodiment of the present disclosure. The SBP Parameter Element field 2800 comprises an Element ID field, a Length field, an Element ID Extension field and an SBP Parameters field. Unlike the SBP Parameter Element field described in FIG. 18 according to the first embodiment, the SBP Parameter field comprises an additional Target Device Parameter subfield, a Link Parameters subfield, a Measurement Parameters subfield and a Report Parameter subfield which specify attributes related to the target STAs/links, the links to be measured, the measurement PPDUs and the SBP Reporting respectively.

The Link Parameter subfield, the Measurement Parameters subfield and Report Parameters subfield may be the same as that described in FIG. 15. The Target Device Parameters subfield comprises a Target Device Control field, a Device Location Info field, a Coverage Info field and one or more Target Device Info fields. The Target Device Control field comprises a Device Type subfield, a Device Location Info Present subfield, a Coverage Info Present subfield and a Target Device Count (N) subfield. The Device Type subfield specifies the device type restrictions for the sensing responder.

Table 10 shows various device types corresponding to the Device Type subfield values.

TABLE 10

| Device Type subfield value | Meaning |
|---|---|
| 0 | Include all types |
| 1 | Only non-mobile devices |
| 2 | Desktop PCs |
| 3 | Laptops |
| 4 | Smartphones |
| 5 | IOT |

The Device Location Info Present and the Coverage Info Present subfields indicates the presence of the corresponding fields in the Target Device Parameters subfield. The Target Device Count (N) subfield indicates the number of Target Device Info field(s) in the Target Device Parameters subfield.

The Device Location Info field specifies the location of the device which is then used to as a center to determine a coverage area or radio range extended from the location. The Coverage Info field comprises a Coverage Radius subfield and a Coverage Sector Bitmap subfield. The Coverage Radius subfield specifies the radius (e.g., as presented by RSSI/RCPI level (dBm) or as distance (m)) of the coverage area with device location specified in the Device Location Info field. The Coverage Sector Bitmap subfield indicates a segment or an area relative to the device's location.

The Device Location Info field carries information about the location in which the target STAs should be located. For example, the field may carry the Device Location Information Body field as described in 9.4.1.56 of 802.11-2020. A Device Location Information Body field includes the location configuration information (LCI), which contains latitude, longitude, and altitude information. Together with the Coverage Info field, the SBP Initiator can specify the coverage area (with the located indicated in the Device Location Info field) in which it requests the AP (SBP Responder) to select the target sensing responders. If the Device Location Info field is not present, but the Coverage info field is present, the SBP Responder (AP)'s location will be considered the center of the target coverage area.

Table 11 shows various sectors indicated by the Coverage Sector Bitmap bits.

TABLE 11

| Coverage Sector Bitmap bit | Indicated sector |
|---|---|
| 0 | North |
| 1 | South |
| 2 | East |
| 3 | West |

Each Target Device Info field in the Target Device Parameters subfield specifies a target link and comprises a STA2 Present subfield, a STA1 ID subfield and a STA2 ID subfield. For I2R or R2I links, the STA2 Present subfield is set to 0 and the STA1 ID subfield indicates the STA ID (e.g., MAC address, Associated Identifier (AID) or Unassociated ID (UID)) of the STA attached to the link, while the SBP Responder is understood to be attached to the other end of the link. For R2R links, the STA2 Present subfield is set to 1 and the STA1 and STA2 ID subfields indicate the STA IDs (e.g., MAC addresses or AIDs) of the two STAs attached to the R2R link. Alternatively, instead of STA IDs, a unique Link ID for each measurement link may be assigned and included in the Link Information subfield(s).

Although it is not shown in the figure, other information regarding the Target Device may also be included in the Target Device Parameters fields, such as Device name, PHY version (HT/VHT/HE/EHT etc.), supported capabilities (WLAN Sensing supported, Fine Time Measurement (FTM) supported etc.).

According to the second embodiment of the present disclosure, the SBP Initiator provides target device parameters specified in Target Device Parameters subfield frame in addition to the link/measurement parameters of the SBP Parameter Element field in the SBP Request to the SBP Responder (AP), and the SBP Responder (AP) uses the provided target device parameters and the link parameters to select the STAs/links to be used for the SBP sensing measurement. For example, if the Device Location Info field and Coverage Info field are included, the AP may select STAs that are located within the specified sector of the Coverage area and that satisfy the link parameters (e.g., minimum RSSI/RCPI). Additionally or alternatively, if the Target Device Info fields are included, the AP directly select the indicated STAs that satisfy the other parameters such as link parameters. The SBP Responder (AP) then proceeds to act as a Sensing Initiator and performs sensing session setup and sensing measurement setup with the selected STAs (sensing responders), using a unique measurement setup ID for each measurement link.

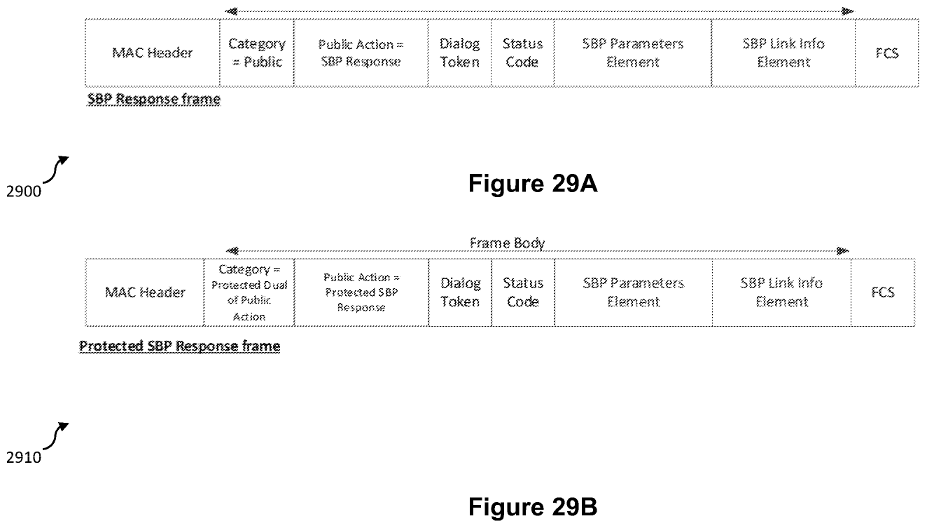

FIGS. 29A and 29B show example formats of an SBP Response frame 2900 and a Protected Response frame 2910, respectively, according to the second embodiment of the present disclosure. The SBP Response frame 2900 comprises a MAC Header (Frame Control field, Duration field, RA field and TA field), a Category field which is set to “Public”, a Public Action field which is set to a value indicating that this frame is an SBP Response frame, a Dialog Token field, a Status Code field, an SBP Parameter Element field, an SBP Link Info Element field and an FCS field. The Protected SBP Response frame 2910 comprises a MAC Header (Frame Control field, Duration field, RA field and TA field), a Category field which is set to “Protected Dual of Public Action”, a Public Action field which is set to a value indicating that this frame is a Protected SBP Response frame, a Dialog Token field, a Status Code field, an SBP Parameter Element field, an SBP Link Info Element field and an FCS field. It is noted that, as different measurement links are assigned to different measurement setup ID for the SBP procedure according to the second embodiment, the Measurement Setup ID may be included in the SBP Link Element field of the SBP Response frames 2400, 2410. This is different from the SBP Response frames 1700, 1710 described in FIGS. 17A and 17B. Alternatively, it is possible that a Measurement Setup ID field is also carried in the SBP Response frame itself, and a unique measurement setup ID is assigned to represent the SBP procedure.

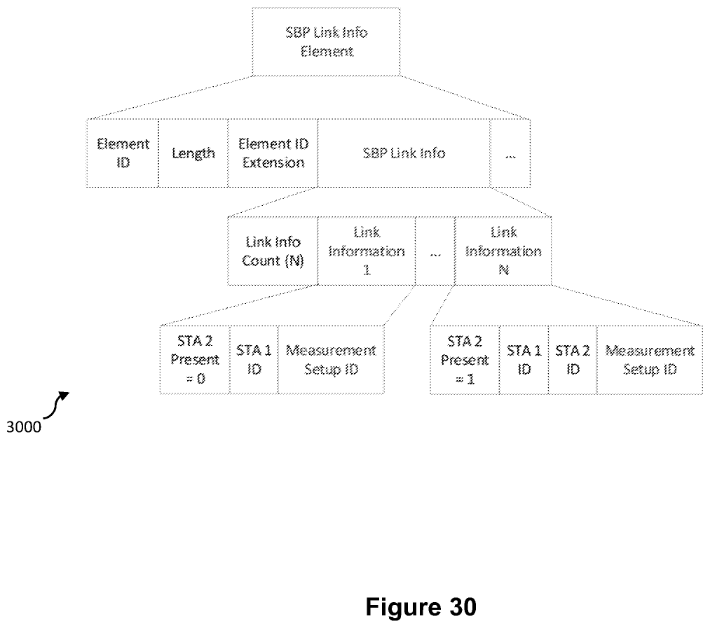

FIG. 30 shows an example format of the SBP Link Info Element field 3000 in the SBP Response frames 2900, 2910 in FIGS. 29A and 29B according to the second embodiment. The SBP Link Info Element field 3000 comprises an Element ID field, a Length field, an Element ID Extension field and an SBP Link Info field. The SBP Link Info field comprises a Link Info Count (N) subfield and one or more Link Information field corresponding to one or more links. The Link Info Count (N) subfield indicates the number of links (Links Information subfields) present in the SBP Link Info field. Unlike the SBP Link Info Element field described in FIG. 19 according to the first embodiment, each Link Information subfield comprises a STA2 Present subfield, a STA1 ID subfield, a STA2 ID subfield (if the STA2 Present subfield is set to 1) and an additional Measurement Setup ID subfield. Although not shown in the figure, a bit in the Link Information field may indicate whether the link is I2R or R2I, e.g. I2R if the bit is set to 0 and R2I if the bit is set to 1. For R2R links or links of other APs. For initiator-to-responder (I2R) or responder-to-initiator (R2I) links in which the SBP Responder itself is attached, the STA2 Present subfield is set to 0 and the STA1 ID subfield indicates the STA ID (e.g., MAC address, AID or UID) of the STA attached to the link. For R2R links, the STA2 Present subfield is set to 1 and the STA1 and STA2 ID subfields indicate the STA IDs (e.g., MAC addresses, AIDs, or UID) of the two STAs attached to the R2R link. A unique Link ID for each measurement link is assigned and included in the Measurement Setup ID subfield of the Link Information subfield(s).

If the setups are successful, the AP proceeds to perform sensing measurement instances on the selected links based on the attributes indicated in the SBP Request and collects the sensing measurement reports from the Sensing Responders if applicable.

Regarding SBP Reporting, the sensing measurement results obtained in the WLAN sensing procedure resultant from an SBP request is reported to the SBP initiator by the SBP responder in a Protected SBP Report frame which is either constructed by the SBP responder (AP) itself (if the AP is also the sensing receiver), or constructed by adding the Link Information field (depicted in FIG. 30) and updating a Report Length field in each Sensing Measurement Report field obtained in the Sensing Measurement Report frame sent by the Sensing Responders on the link. The SBP Report frame is constructed and transmitted to the SBP initiator either as soon a sensing measurement report is received or generated from a link, or by aggregating a few sensing measurement reports received/generated within a certain time window to be within a same SBP Report frame. If different Measurement Setup IDs are used for different measurement Links, the Measurement Setup ID value in each report uniquely identifies the link of measurement, else the Link Information field identifies the link.

In particular, referring to FIG. 21, in each of the Sensing Measurement Report field, the Measurement Setup ID field indicates the Measurement Setup ID value which uniquely identifies and corresponds to the link in which the sensing measurement is performed, especially in the case where different Measurement Setup IDs are used for different measurement links. The Link Information carries ID (e.g., comprises a STA2 Present subfield, a STA1 ID subfield and a STA2 ID subfield (STA2 ID subfield is only present if the STA2 Present subfield is set to 1 to indicate a R2R link or another BSS's link). The STA1 subfield of the Link Information field is always present and the STA2 ID subfield of the Link Information field is only present for R2R links. The STA1 and STA2 ID subfields carry IDs (e.g., MAC Address or AID) of the sensing responders to identify the link corresponding to the sensing measurement report. In this embodiment, if the Measurement Setup ID subfield is present indicating the measurement setup ID value in that uniquely identifies the link, the Link Information field can be omitted.

In the following paragraphs, a third embodiment of the present disclosure where an extended SBP procedure through APs which are not co-located but are interconnected over wire or wireless backhaul (over one or more hops), is described.

According to the third embodiment, the SBP initiator includes information of a target AP(s) as operational parameters in the SBP request. The AP receiving the SBP request will act as a primary SBP responder, it will then act as an AP SBP initiator and request one or more APs (e.g., among the target AP list) to act as a secondary (or extended) SBP responder and perform WLAN sensing on behalf of the SBP initiator. The secondary SBP responder (target AP) will perform the roles of the SBP responder of the SBP procedure, for example, performing SBP setup/report, selecting STAs/links and assigning M.S. IDs to be used in the link for the SBP procedure, while the primary SBP responder, beside its own roles, may also assist in exchange frames and information between the SBP initiator and secondary SBP responder. For example, the primary SBP Responder consolidates the result of the SBP setup(s) performed by the secondary SBP Responder(s) in their respective BSS and reports to the SBP Initiator in a SBP Response frame, as well as collects the SBP reports from the secondary SBP responder(s) and forwards them to the SBP initiator.

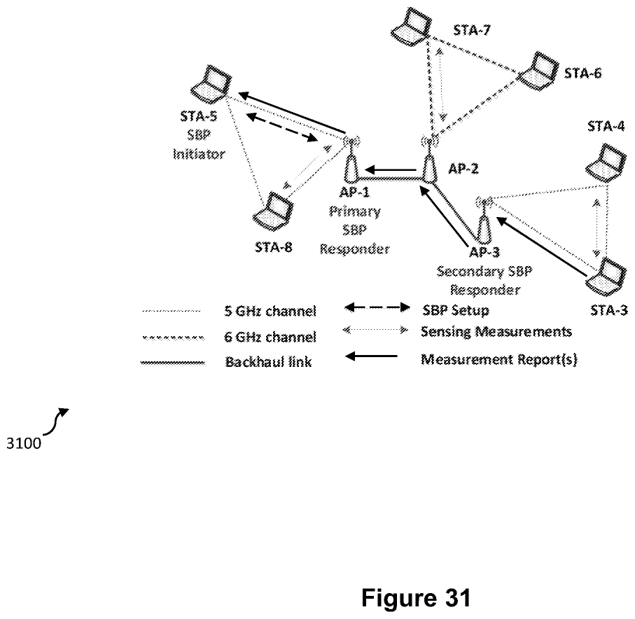

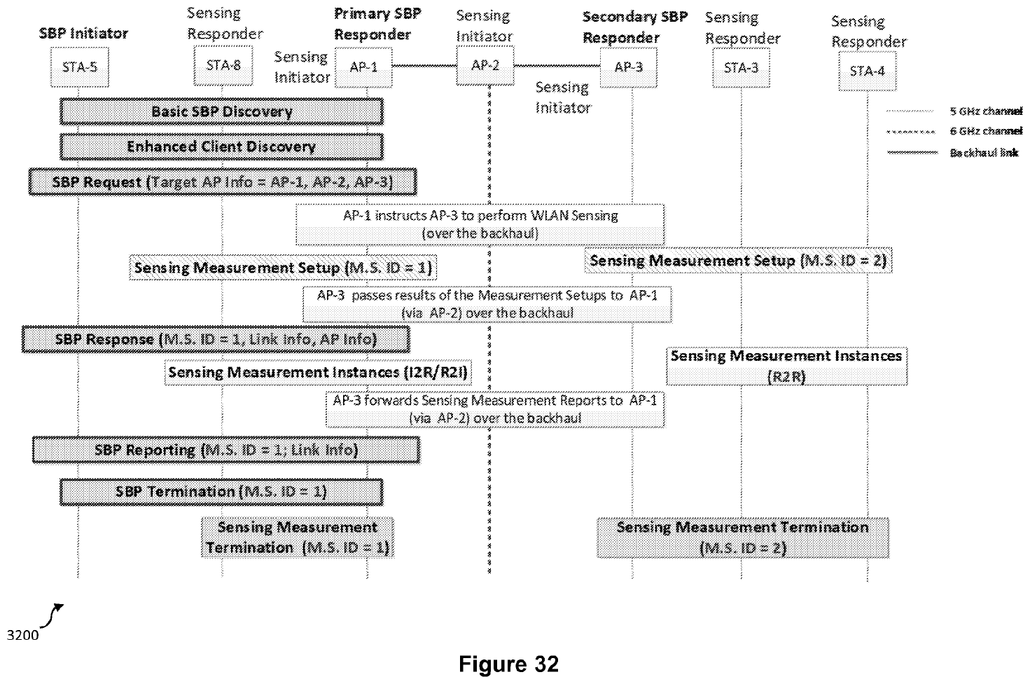

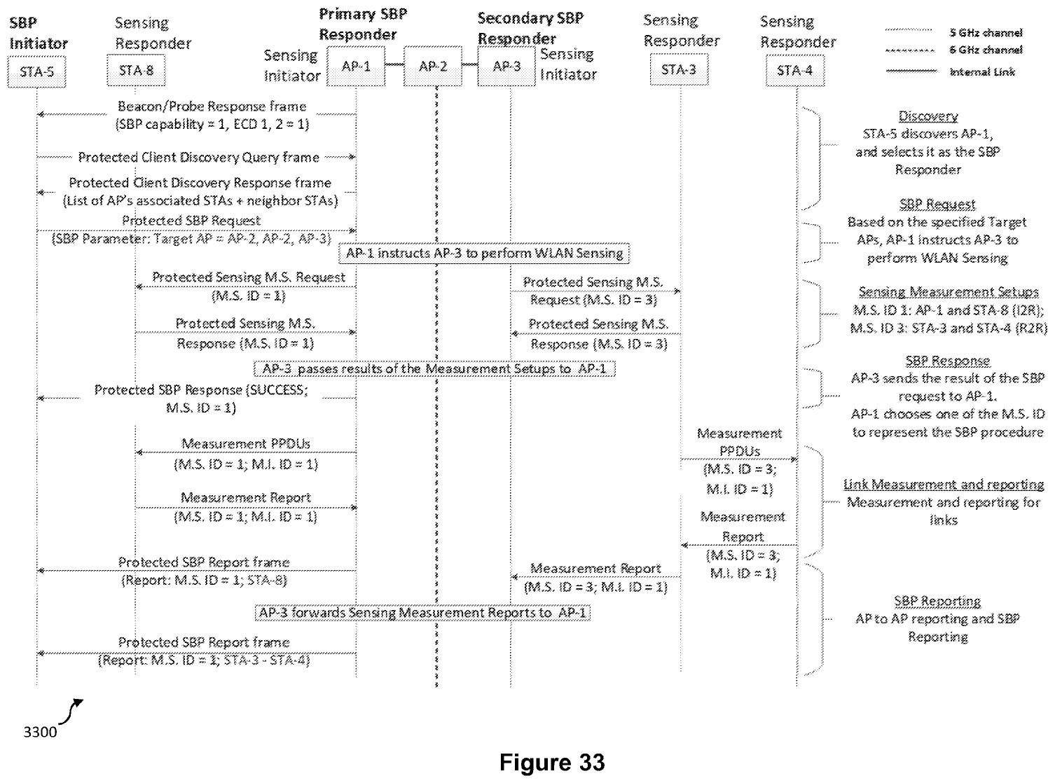

FIG. 31 shows a schematic diagram 3100 illustrating communications in an extended SBP procedure according to the third embodiment of the present disclosure. In this embodiment, there are primary and secondary proxy sensing responders and APs are interconnected over backhaul links (wired or wireless). FIG. 32 shows a flowchart 3200 illustrating an overview of an extended SBP procedure among the three APs (AP-1, AP-2, AP-3) and the six STAs (STA-3, STA-4, STA-5, STA-6, STA-7, STA-8) in FIG. 31. FIG. 33 shows a flowchart 3300 illustrating a detailed procedural flow of the extended sensing by proxy procedure among the three APs and the six STAs in FIG. 31. In this case, the AP-1, AP-2 and AP-3 are interconnected over backhaul links.

Firstly, the AP (e.g., AP-1, AP-2, AP-3) advertises its capability to support enhanced client discovery and basic information about associated non-AP STAs (e.g., count/number of associated STAs etc.) using a Beacon/Probe Response frame. STA-5 may perform a basic SBP discovery procedure and discover supports of the SBP function of AP-1 and AP-3. STA-5 may then select AP-1 as its SBP responder.

Secondly, STA-5 may then initiate an enhanced client discovery procedure by transmitting a protected client discovery query frame to request the AP-1 to provide a list of non-AP STAs (associated non-AP STAs and optionally unassociated non-AP STAs). The AP-1 then transmits a protected Client Discovery Response frame with the requested list of non-AP STAs and, optionally, their respective neighboring STAs, and the enhanced client discovery procedure ends. In this enhanced client discovery procedure, the SBP initiator discovers the information of AP-1 and potential sensing responders. In particular, the AP-1 already has basic information about associated STAs, e.g., their operating channel(s), sensing capabilities and R2R sensing capabilities etc., The SBP Initiator (STA-5) can obtain such information from the AP-1 using Level 1 Client Discovery Query. Although it is not shown in the figure, upon receiving request from the SBP Initiator (or even on its own), the AP may collect other relevant information from its associated STAs for example their location/position of the STAs, RSSI (or propagation loss) to/from the STAs (to represent a distance between the STAs and the AP-1) and information about the STA's neighboring STAs including link metrics etc. With that, the SBP Initiator can obtain such relevant information about the AP's associated STAs (and their neighboring STAs) from the AP using Level 2 Client Discovery Query. Based on the above information, the SBP Initiator can select one or more APs as SBP Responder(s) as well as one or more non-AP STAs as target sensing responders for the SBP Procedure. Alternatively, if, for example, the AP does not support Enhanced Client Discovery, or in addition to the information collected via Enhanced Client Discovery, the SBP Initiator may also use information received via other means (e.g., IP/MAC Addresses provided by the upper layer applications etc.) to select the SBP Responder and sensing responders for the SBP Procedure.

Alternatively, it is also possible that initially SBP Initiator requests measurement results from “all/many” available links but subsequently selects a subset of links that are most suitable for the sensing application in subsequent SBP request(s). The link selection may be based on statistical analysis of the sensing measurement reports for the links; for example, the links in which the CSI feedback are insensitive to the needs of the sensing application may be omitted in later SBP requests.

It is noted that the SBP initiator (STA-5) may either be associated with the AP-1 (SBP Responder) in which case it is assumed to have already completed the usual authentication/association procedure with the AP-1 as well as setting up of security association (SA), for example, through a 4-way handshake prior to the initiation of the SBP Request; or, it may be unassociated with the AP-1 in which case it is assumed to have already completed the setting up of security associated with the AP-1, for example, through a pre-association security negotiation (PASN) through a 3-way handshake prior to the initiation of the SBP request.

STA-5 discovers AP-1 through the client discovery procedure and select it as the SBP responder. It then initiates an SBP procedure and requests the AP-1 to be a SBP responder (i.e., a proxy sensing initiator on STA-5's behalf) by transmitting a Protected SBP Request frame (addressed to AP-1) specifying operational parameters relating to SBP links and measurement attributes, such as minimum receive signal strength indicator (RSSI) or received channel power indicator (RCPI) and number of measurement links, as a condition to select one or more links to perform the sensing measurement.

In this case, STA-5 may specify the information of target APs (AP-1, AP-2 and AP-3). Based on the operational parameter, the AP-1 then decides 1 STA/link for the sensing measurements (in this case, an I2R link attached to STA-8) and sends a sensing request (or forward the SBP request frame) to AP-2 and AP-3 (through AP-2) over the backhaul links, requesting AP-2 and AP-3 to act as a secondary SBP responder for the SBP procedure. AP-2 and AP-3 selects one link each and perform WLAN sensing based on the condition(s) specified by STA-5. In this case, AP-3 selects a R2R link between STA-3 and STA-4 to perform the measurement. The link selected by AP-2 is not shown in the figure. In this example, AP-1 acts as the Primary SBP Responder (and secondary SBP Initiator), while each of AP-2 and AP-3 act as secondary SBP Responders (to AP-1).

Each AP (AP-1, AP-2, AP-3) initiates a sensing session setup and a sensing measurement setup with the selected STA/link or sensing responders (STA-8, STA-3/STA-4) by transmitting a Protected Sensing Measurement Setup Request frame to it, respectively. In this embodiment, a different measurement setup identifier (ID) may be assigned to different measurement links for the SBP procedure. The measurement setup ID to be used by AP-3 is transmitted in the sensing request. In this case, the measurement setup ID of 1 is assigned and to be used by AP-1 for its sensing measurement with STA-8 and the measurement setup ID of 3 is assigned and to be used by AP-3 for its R2R link sensing measurement.

Each STA or sensing responder (STA-8, STA-3) receiving the Protected Sensing Measurement Setup Request frame then transmits a Protected Sensing Measurement Setup Response frame back to its respective AP (AP-1, AP-3) indicating a successful sensing measurement setup, respectively. AP-3 (secondary SBP responder) sends a sensing response and passes the sensing measurement setup result back to AP-1 (primary SBP responder) through AP-2 over the backhaul links.

AP-1 consolidate the sensing response received from AP-3 through AP-2 and transmits a Protected SBP Response frame to indicate a successful setup with the sensing responders (links) to complete the SBP setup. AP-1 also chooses one of the measurement setup ID (in this case, ID “1”) to represent the SBP procedure.

Subsequently, AP-1 performs a sensing measurement instance with its selected STA (STA-8) by transmitting an I2R Measurement PPDU (e.g., Sensing NDP) to STA-8 while AP-3 requests STA-3, the sensing initiator of the R2R measurement to transmit the R2R Measurement PPDU to STA-4. STA-8 and STA-4, in response, measure their respective channels upon receiving the I2R Measurement PPDU and R2R Measurement PPDU, and if requested, transmit their measurement reports back to AP-1 and STA-3 respectively. The measurement reports comprise their respective assigned measurement setup IDs. STA-3 forwards the sensing measurement report back to AP-3 and AP-3 forwards the sensing measurement report of its R2R link to AP-1 through AP-2 over the backhaul link.

AP-1 collects and consolidates the measurement reports and transmits a Protected SBP Report frame comprising the measurement reports to STA-5. The measurement report ID (ID “1”) and/or the Link information such as the STA IDs or other IDs are included in the report frame for identifying the STA-8 measurement link by STA-5. AP-1 also collects and consolidates the measurement report(s) on I2R link with STA-7 received from AP-2 and transmits a separate Protected SBP Report frame comprising the measurement report to STA-5. The SBP Report frame for other AP's link has a same format as a report for a responder-to-responder (R2R) link. Similarly, the measurement report IDs (ID “3”), the AP ID and/or the Link information such as the STA IDs or other IDs are included in the report frame for identifying the R2R measurement link between STA-3 and STA-4 by STA-5. It is noted that, the SBP initiator may perform the translation or conversion between the two measurement setup IDs and add link information to the measurement report(s). In an alternative embodiment, AP-1 may consolidate the measurement reports on STA-8 link and STA-3-STA-4 link and transmits a single Protected SBP Report frame comprising the measurement reports to STA-5.

Finally, after SBP procedure, STA-5 may initiate an SBP procedure termination by transmitting an SBP Termination frame (shown in FIG. 32 only) to AP-1. AP-1 then performs sensing measurement termination and sensing session termination with STA-8 for the sensing measurement setup ID (ID “1”) corresponding to the SBP procedure. AP-1 also sends a termination request to AP-2 and through AP-2 over the backhaul links to request AP-3 to perform sensing measurement termination and sensing session termination with the link between STA-3 and STA-4 for the sensing measurement setup ID (ID “3”) corresponding to the SBP procedure.

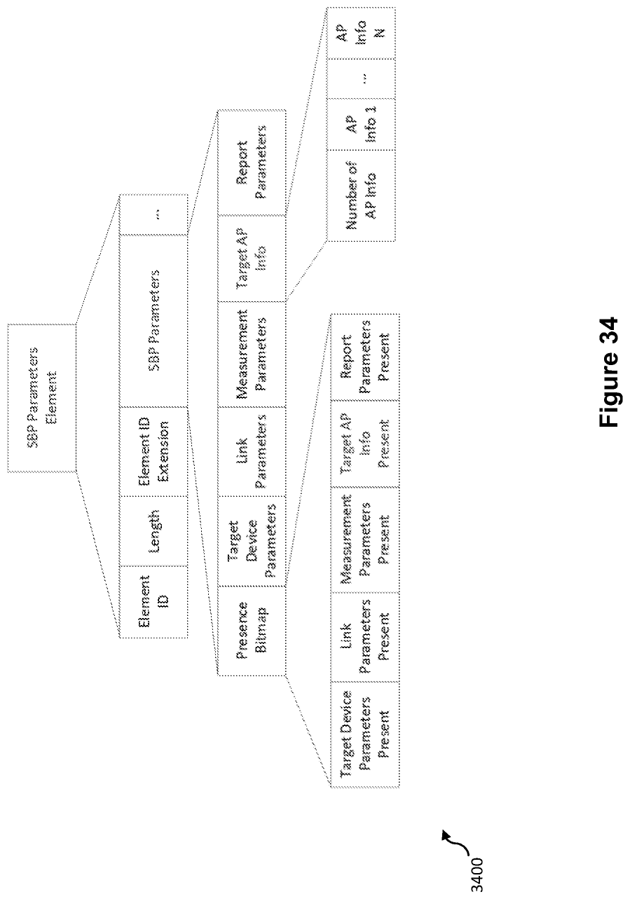

FIG. 34 shows an example format of the SBP Parameter Element field 3400 in the SBP Request/Response frames 1600, 1610, 1700, 1710 in FIGS. 16A-17B according to the third embodiment. The SBP Parameter Element field comprises an Element ID field, a Length field, an Element ID Extension field and an SBP Parameters field. Unlike the SBP Parameter Element field described in FIG. 18 according to the first embodiment and FIG. 28 according to the second embodiment, the SBP Parameter field comprises an additional Presence Bitmap subfield, a Target Device Parameters subfield, a Link Parameters subfield, a Measurement Parameters subfield, an additional Target AP Info subfield and a Report Parameter subfield which specify attributes related to the presence of each parameter subfield, the target STAs/links, the links to be measured, the measurement PPDUs, the target APs and the SBP Reporting respectively.

The Presence Bitmap subfield comprises a Target Device Parameters Present subfield, a Link Parameters Present subfield, a Measurement Parameters Present subfield, Target AP Info Present subfield and a Report Parameter Present subfield, each indicating the presence of a corresponding appending field used as criteria for selecting APs/STAs/links. The Target AP Info subfield carries information of a target AP(s) to be used as sensing initiator(s). The Target AP Info subfield comprises a Number Of AP Info subfield indicating a number of AP Info fields in the Target AP Info subfield, and each AP Info field carries an AP ID (e.g., MAC address).

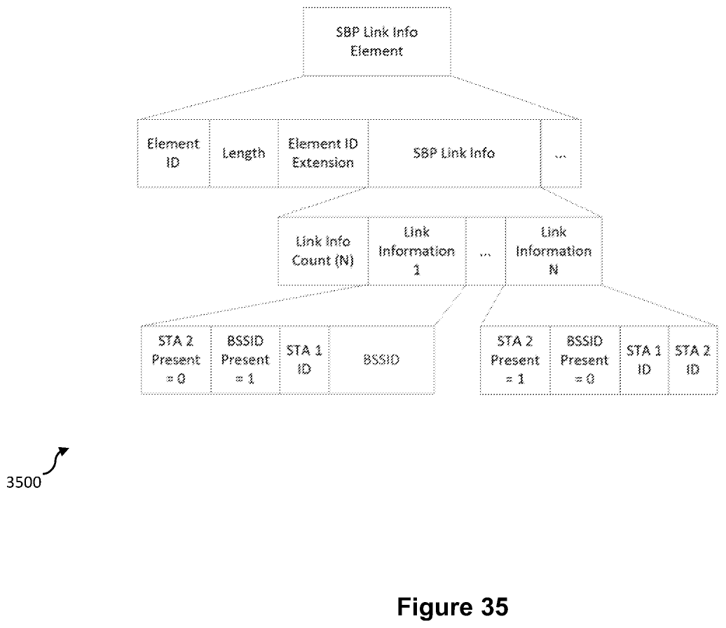

FIG. 35 shows an example format of the SBP Link Info Element field 3500 in the SBP Response frames 2900, 2910 in FIGS. 29A and 29B according to the third embodiment. The SBP Link Info Element field 3500 comprises an Element ID field, a Length field, an Element ID Extension field and an SBP Link Info field. The SBP Link Info field comprises a Link Info Count (N) subfield and one or more Link Information field corresponding to one or more links. The Link Info Count (N) subfield indicates the number of links (Links Information subfields) present in the SBP Link Info field. Unlike the SBP Link Info Element field described in FIG. 19 according to the first embodiment, each Link Information subfield comprises a STA2 Present subfield, an additional BSSID Present subfield, a STA1 ID subfield, a STA2 ID subfield (if the STA2 Present subfield is set to 1) and an additional BSSID subfield. Although not shown in the figure, a bit in the Link Information field may indicate whether the link is I2R or R2I, e.g. I2R if the bit is set to 0 and R2I if the bit is set to 1. For R2R links or links of other APs. For I2R or R2I links, the STA2 Present subfield is set to 0 and the STA1 ID subfield indicates the STA ID (e.g., MAC address, AID or UID) of the STA attached to the link. For R2R links, the STA2 Present subfield is set to 1 and the STA1 and STA2 ID subfields indicate the STA IDs (e.g., MAC addresses, AIDs, or UID) of the two STAs attached to the R2R link. If the link belongs to a different BSSID (other than the SBP responder's BSSID), the BSSID is included in the BSSID subfield of the Link Information field. The BSSID Present subfield indicates whether the BSSID subfield is present in the Link Information field.

If the setups are successful, the AP proceeds to perform sensing measurement instances on the selected links based on the attributes indicated in the SBP Request and collects the sensing measurement reports from the Sensing Responders if applicable.

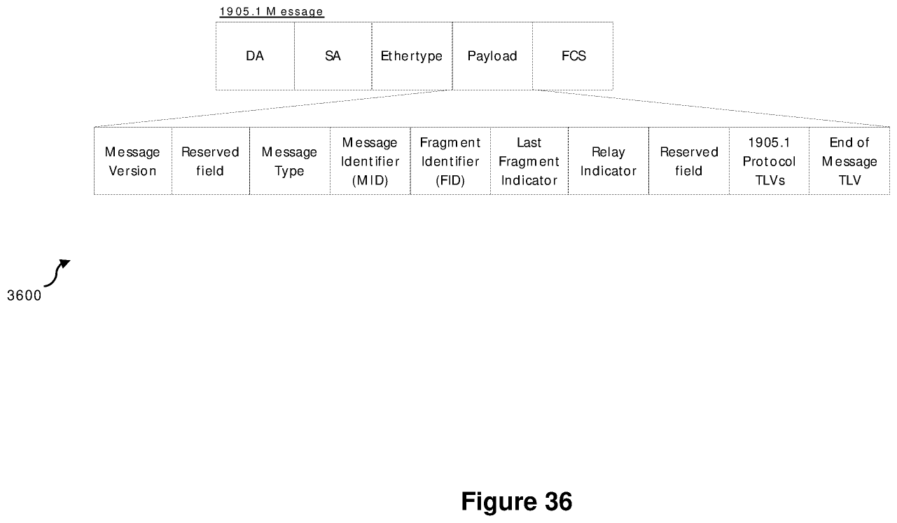

For the interconnected APs where they can communicate through wire or wireless backhaul links, a 1905.1 Message Type (SBP) can be used to communicate the SBP related messages. FIG. 36 shows an example format of a 1905.1 Message 3600 used for extended SBP procedure according to the third embodiment of the present disclosure. The 1905.1 Message 3600 comprises a Destination Address (DA) field, a Source Address (SA) field, an Ethertype field, a Payload field and an FCS field. The Payload field comprises a Message Version field, a Message Type field, a Message Identifier (MID) field, a Fragment Identifier (FID) field, a Last Fragment Indicator field, a Last Fragment Indicator field, a Relay Indicator field, a 1905.1 Protocol TLVs (Type, Length, Value) field and an End Of Message TLV field.

Table 12 shows the message type corresponding to the Message Type field values.

TABLE 12

| Message Type | Protocol | Value | Description |
|---|---|---|---|
| SBP Request | SBP | 0x8036 | An SBP Request |
| | | | from an AP (AP SBP |
| | | | Initiator) to another |
| | | | AP (Secondary SBP |
| | | | Responder). |
| SBP Response | SBP | 0x8037 | An SBP Request |
| | | | from the Secondary |
| | | | SBP Responder to |
| | | | the AP SBP Initiator. |
| SBP Report | SBP | 0x8038 | An SBP Report from |
| | | | the Secondary SBP |
| | | | Responder to the AP |
| | | | SBP Initiator. |
| SBP Termination | SBP | 0x8039 | An SBP Termination |
| | | | between two APs. |

The 1905.1 Protocol TLVs field carries one or more 1905.1 TLVs are defined to carry the contents of the respective SBP messages. In particular, a 1905 SBP Request message carries the link/measurement/Target STAs information present in the original SBP Request received from the non-AP STA SBP Initiator, but the Target AP info is not included. The Secondary SBP Responder uses the link/measurement/Target STAs information to select the STAs/links for their respective sensing measurements.

In the following paragraphs, a fourth embodiment of the present disclosure where an extended SBP procedure with an AP which does not have a direct Wireless Medium (WM) connection to act as an SBP responder, is described.

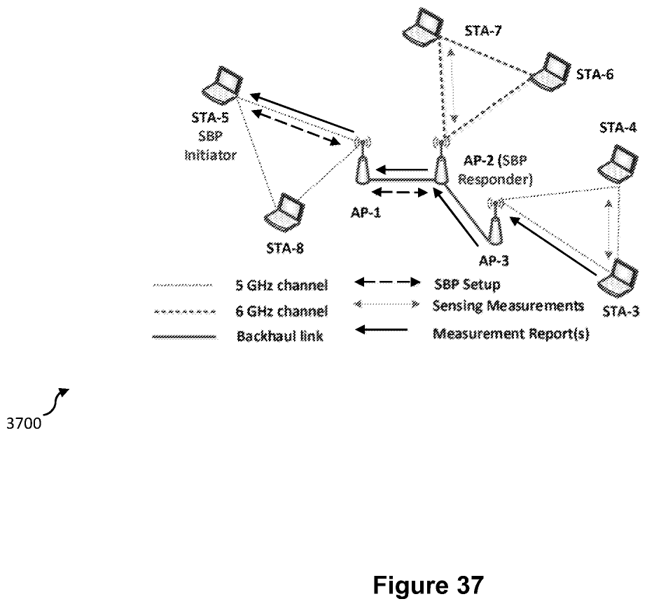

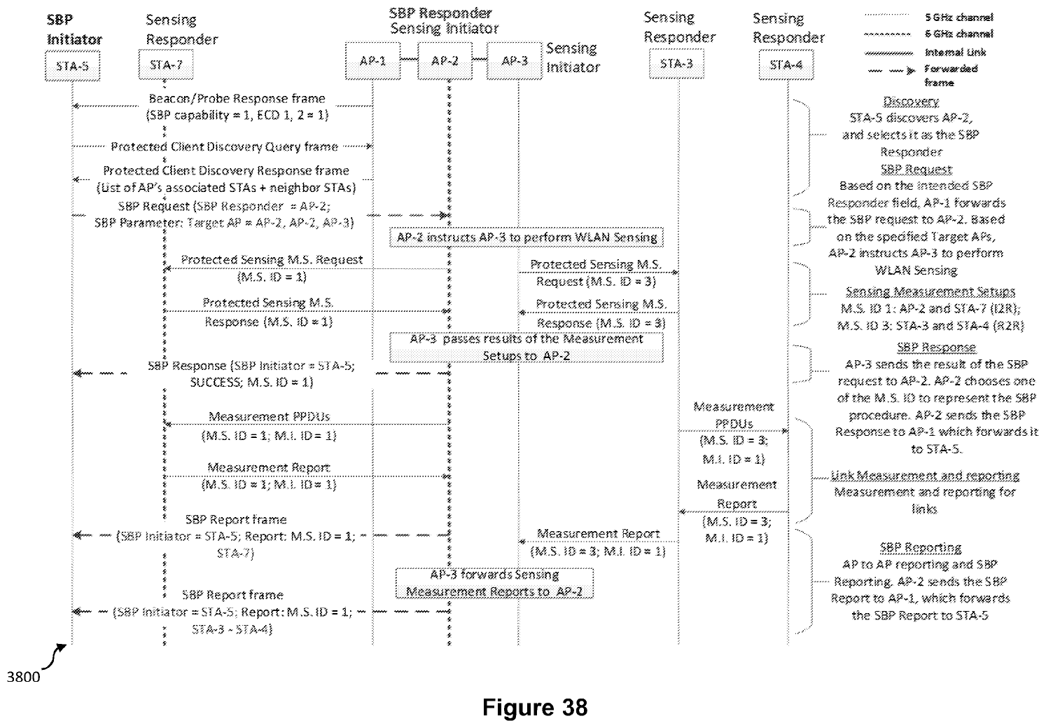

FIG. 37 shows a schematic diagram 3700 illustrating communications in an extended SBP procedure according to an example of the fourth embodiment of the present disclosure. In this embodiment, STA-5 which is the SBP responder and AP-2 which is the target SBP responder do not have a direct WM connection between them. FIG. 38 shows a flowchart 3800 illustrating a detailed procedural flow of the extended sensing by proxy procedure among the three APs (AP-1, AP-2, AP-3) and the six STAs (STA-1, STA-2, STA-3, STA-4, STA-5, STA-6) in FIG. 31. In this case, the AP-1, AP-2, and AP-3 are interconnected over backhaul links.

Firstly, the AP (e.g., AP-1, AP-2, AP-3) advertises its capability to support enhanced client discovery and basic information about associated non-AP STAs (e.g., count/number of associated STAs etc.) using a Beacon/Probe Response frame.

Additionally, AP-2 may also advertise its capability to support extended SBP feature in the Beacon/Prob Response frame. This means that AP-2 is able to accept request from another AP (requesting AP) to collect sensing measurement results on behalf of the requesting AP. The AP is also able to accept SBP request from a non-AP STA (SBP initiator) that is not directly connected to it over a wired medium (e.g., routed via another AP (e.g., requesting AP) or over wired backhaul, etc.).

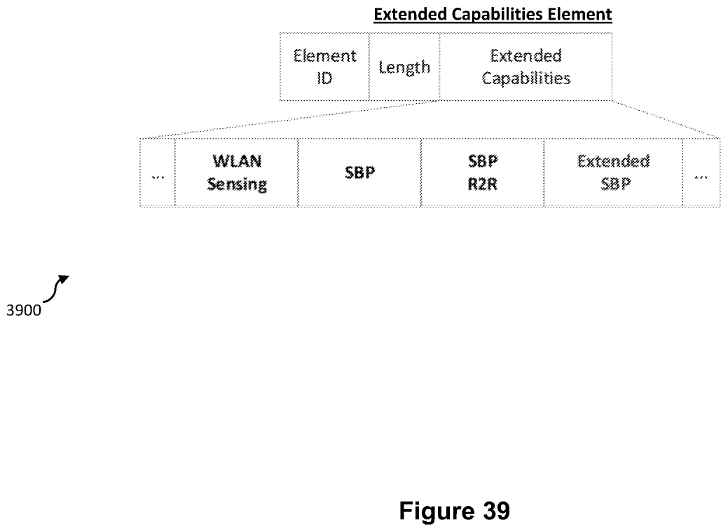

FIG. 39 shows an example format of an Extended Capabilities element 3900 used for basic discovery according to the fourth embodiment of the present disclosure. The Extended Capabilities element 3900 comprises an Element ID field, a Length field, an Extended Capabilities field and an Extended SBP field. The Extended Capabilities field, SBP subfield and SBP R2R subfield comprises the same indications as that described in FIG. 15. The additional Extended SBP field indicates the AP is capable of providing SBP service to another AP or non-AP STA. Such Extended Capabilities element 3700 is included in the Beacon/Probe Response frame transmitted by an AP with which the SBP initiator is directly connected over the WM such as AP-1 in FIG. 37 as well as other APs on route to the SBP responder. It is noted that AP-1 or the AP transmitting such Extended Capabilities element 3900 in its Beacon/Probe Response frame indicating that it supports Extended SBP feature need not even be SBP capable.

Returning to FIG. 38, after basic client discovery procedure, STA-5 may then initiate an enhanced client discovery procedure by transmitting a protected client discovery query frame to request AP-1 (which has a direct WM connection with STA-5) to provide a list of non-AP STAs (associated non-AP STAs and optionally unassociated non-AP STAs). The AP-1 then transmits a protected Client Discovery Response frame with the requested list of non-AP STAs and, optionally, their respective neighboring STAs, and the enhanced client discovery procedure ends. In this enhanced client discovery procedure, the SBP initiator discovers the information of AP-1 and potential sensing responders. In particular, the AP-1 already has basic information about associated STAs, e.g., their operating channel(s), sensing capabilities and R2R sensing capabilities etc., The SBP Initiator (STA-5) can obtain such information from the AP-1 using Level 1 Client Discovery Query. Although it is not shown in the figure, upon receiving request from the SBP Initiator (or even on its own), the AP may collect other relevant information from its associated STAs for example their location/position of the STAs, RSSI (or propagation loss) to/from the STAs (to represent a distance between the STAs and the AP-1) and information about the STA's neighboring STAs including link metrics etc. With that, the SBP Initiator can obtain such relevant information about the AP's associated STAs (and their neighboring STAs) from the AP using Level 2 Client Discovery Query. Based on the above information, the SBP Initiator can select one or more APs as SBP Responder(s) as well as one or more non-AP STAs as target sensing responders for the SBP Procedure. Alternatively, if, for example, the AP does not support Enhanced Client Discovery, or in addition to the information collected via Enhanced Client Discovery, the SBP Initiator may also use information received via other means (e.g., IP/MAC Addresses provided by the upper layer applications etc.) to select the SBP Responder and sensing responders for the SBP Procedure.

Alternatively, it is also possible that initially SBP Initiator requests measurement results from “all/many” available links but subsequently selects a subset of links that are most suitable for the sensing application in subsequent SBP request(s). The link selection may be based on statistical analysis of the sensing measurement reports for the links; for example, the links in which the CSI feedback are insensitive to the needs of the sensing application may be omitted in later SBP requests.

It is noted that the SBP initiator (STA-5) may either be associated with the AP-1 (SBP Responder) in which case it is assumed to have already completed the usual authentication/association procedure with the AP-1 as well as setting up of security association (SA), for example, through a 4-way handshake prior to the initiation of the SBP Request; or, it may be unassociated with the AP-1 in which case it is assumed to have already completed the setting up of security associated with the AP-1, for example, through a pre-association security negotiation (PASN) through a 3-way handshake prior to the initiation of the SBP request.

STA-5 discovers AP-2 through the client discovery procedure and select it as the SBP responder. It then initiates an SBP procedure and requests the AP-2 to be a SBP responder (i.e., a proxy sensing initiator on STA-5's behalf) by transmitting a Protected SBP Request frame (indicating AP-2 as the SBP Responder) to AP-1. The Request frame specifies operational parameters such as AP-2 and AP-3 as Target APs to perform the SBP procedure. In such case, although the initial SBP request frame (from STA-5) is addressed to AP-1, since a different AP is indicated as the SBP Responder and AP-1 is not listed as a Target AP, AP-1 is not require to perform the sensing measurement, and AP-1 is only require to support the extended SBP by exchanging information and frames between the SBP responder (AP-2) and the SBP initiator (STA-5).

AP-1, which receives the SBP request frame, forwards the SBP request frame to AP-2. AP-2 then decides one STA/link for the sensing measurements (in this case, an I2R link attached to STA-7) and sends a sensing request (or forward the SBP request frame) to AP-3 over a backhaul link, requesting AP-3 to act as a secondary SBP responder for the SBP procedure, select one or more links and perform WLAN sensing to meet the condition specified by STA-5. In this case, AP-3 selects a R2R link between STA-3 and STA-4 to perform the measurement.

Each proxy SBP AP (AP-2, AP-3) initiates a sensing session setup and a sensing measurement setup with the selected STA/link or sensing responders (STA-7, STA-3/STA-4) by transmitting a Protected Sensing Measurement Setup Request frame to it, respectively. In this embodiment, a different measurement setup identifier (ID) may be assigned to different measurement links for the SBP procedure. The measurement setup ID to be used by AP-3 is transmitted in the sensing request. In this case, the measurement setup ID of 1 is assigned and to be used by AP-2 for its sensing measurement with STA-8 and the measurement setup ID of 3 is assigned and to be used by AP-3 for its R2R link sensing measurement.

Each STA or sensing responder (STA-7, STA-3) receiving the Protected Sensing Measurement Setup Request frame then transmits a Protected Sensing Measurement Setup Response frame back to its respective AP (AP-2, AP-3) indicating a successful sensing measurement setup, respectively. AP-3 (secondary SBP responder) sends a sensing response and passes the sensing measurement setup result back to AP-2 (primary SBP responder) over the backhaul link.

AP-2 consolidates the sensing response received from AP-3 and transmits a Protected SBP Response frame to indicate a successful setup with the sensing responders (links) to complete the SBP setup to AP-1. AP-2 also chooses one of the measurement setup ID (in this case, ID “1”) to represent the SBP procedure. AP-1 then forwards the response frame to STA-5.

Subsequently, AP-2 performs a sensing measurement instance with its selected STA (STA-7) by transmitting an I2R Measurement PPDU (e.g., Sensing NDP) to STA-7 while STA-3, the sensing initiator of the R2R measurement as it received the sensing request frame, transmits R2R Measurement PPDU to STA-4. STA-7 and STA-4, in response, measure their respective channels upon receiving the I2R Measurement PPDU and R2R Measurement PPDU, and if requested, transmit their measurement reports back to AP-2 and STA-3 respectively. The measurement reports comprise their respective assigned measurement setup IDs. STA-3 forwards the sensing measurement report back to AP-3 and AP-3 forwards the sensing measurement report of its R2R link to AP-2 over the backhaul link.

AP-2 collects and consolidates the measurement reports and transmits a Protected SBP Report frame comprising the measurement reports to AP-1 and AP-1 forwards the report frame to STA-5. The measurement report ID (ID “1”) and/or the Link information such as the STA IDs or other IDs are included in the report frame for identifying the I2R measurement link with STA-7 by STA-5.

AP-2 also collects and consolidates the measurement report(s) on R2R link received from AP-3 and transmits a separate Protected SBP Report frame comprising the measurement report to AP-1 and AP-1 forwards the report frame to STA-5. Similarly, the measurement report IDs (ID “3”) and/or the Link information such as the STA IDs or other IDs are included in the report frame for identifying the R2R measurement link between STA-3 and STA-4 by STA-5. It is noted that, the SBP Responder may perform the translation or conversion between the two measurement setup IDs and add link information to the measurement report(s). In an alternative embodiment, AP-2 may consolidate the measurement reports on STA-7 link and STA-3-STA-4 link and transmits a single Protected SBP Report frame comprising the measurement reports to AP-1 and AP-1 forwards the single report frame to STA-5.

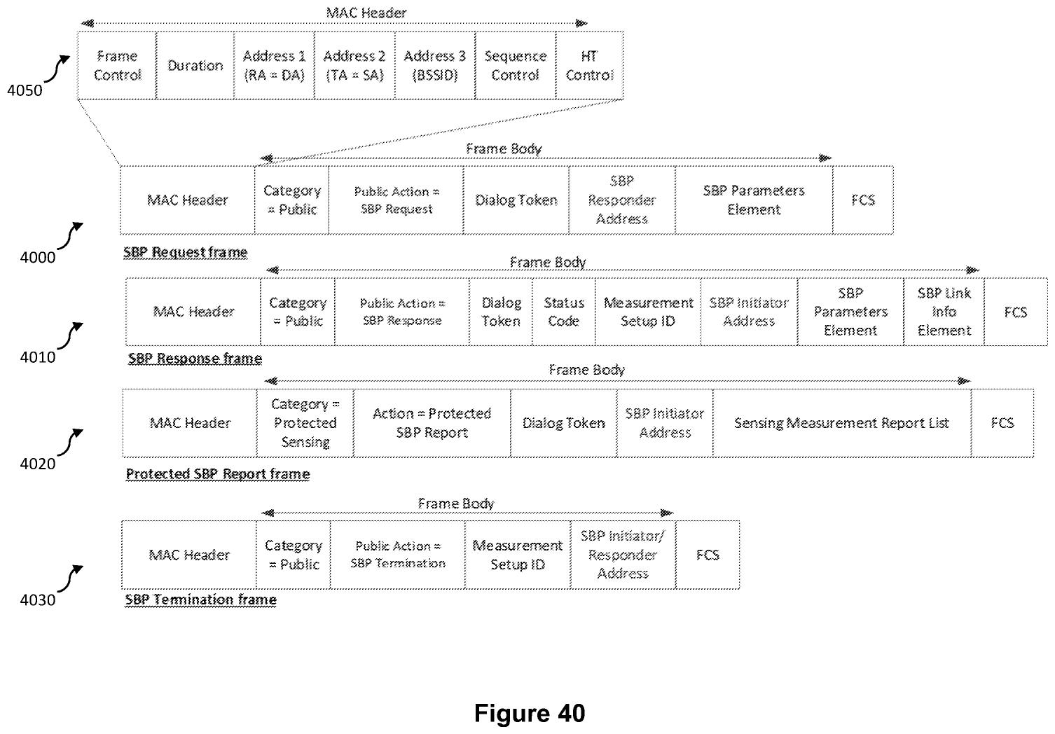

FIG. 40 depicts example formats of a SBP Request frame 4000, a SBP Response frame 4010, a Protected SBP Report frame 4020 and a SBP Termination frame 4030 according to the fourth embodiment of the present disclosure.

The SBP Request frame 4000 comprises a MAC Header 4050 (Frame Control field, Duration field, an Address 1 field, an Address 2 field, an Address 3 field, a Sequence Control field and a High Throughput (HT) Control field), a Category field which is set to “Public”, a Public Action field which is set to a value indicating that this frame is a SBP Request frame, a Dialog Token field, an SBP Responder Address field, an SBP Parameter Element and an FCS field. The SBP Responder Address field indicates the address (e.g., MAC address or ID) of the intended SBP Responder.

The Address 1, Address 2 and Address 3 fields are set according to baseline rules. The Address 1 field is set to RA which is also the destination address (DA), for example, MAC address of AP-1 in the SBP Request frame in FIGS. 37 and 38. The Address 2 field is set to TA which is also the source address (SA), for example, MAC address of STA-5 in the SBP Request frame FIGS. 37 and 38. The Address 3 field indicates the BSSID of the receiving AP (e.g., AP-1) in the SBP Request frame in FIGS. 37 and 38) of the BSS. The AP Addressed in the SBP Responder Address field in the SBP Request acts as the sole SBP Responder for the SBP procedure but not the AP that is addressed in the RA field of the SBP Request frame. All subsequent SBP frames are communicated between the SBP Initiator and the SBP Responder. The AP addressed in the RA field may also participate in the SBP procedure, but not as an SBP Responder.

The AP (e.g., AP-1) receiving the frame (addressed to AP-2) will forward the frame according to the address to the intended SBP responder (AP-2) or the intended SBP initiator (STA-5) and also update the Address 1, Address 2, Address 3 fields as necessary.

The SBP Response frame 4010 comprises the MAC Header 4050 (with updated Address fields), a Category field which is set to “Public”, a Public Action field which is set to a value indicating that this frame is a SBP Response frame, a Dialog Token field, a Status Code field, a Measurement Setup ID field, an SBP Initiator Address field, an SBP Parameter Element field, an SBP Link Info Element field and an FCS field. Unlike the SBP Response frame 1700 in FIG. 17A, the SBP Response frame 4010 comprises an additional SBP Initiator Address field which indicates the address (e.g., MAC address or ID) of the intended SBP initiator. The AP (e.g., AP-1) receiving the SBP Response frame from another AP (e.g., AP-2) will use this field to correctly forward the SBP Response frame.

The Protected SBP Report frame 4020 comprises the MAC Header 405 (with updated Address fields), a Category field which is set to “Protected Sensing”, an Action field which is set to “Protected SBP Report”, a Dialog Token field, an SBP Initiator Address, a Sensing Measurement Report List field, and an FCS field. The Protected SBP Report frame 4020 also an additional SBP Initiator Address field which indicates the address (e.g., MAC address or ID) of the intended SBP initiator. The AP (e.g., AP-1) receiving the Protected SBP Report frame from another AP (e.g., AP-2) will use this field to correctly forward the Protected SBP Report frame.

The SBP Termination frame 4030 (not shown in FIG. 38) used for terminating SBP procedure comprises the MAC Header 4050 (with updated Address fields), a Category field which is set to “Public”, a Public Action field which is set to a value indicating that this frame is a SBP Termination frame, a Measurement Setup ID field, an SBP Initiator/Responder Address field and an FCS field. The SBP Initiator/Responder Address field indicates the intended SBP Initiator or SBP Responder field. It is noted that the protected version of the SBP Request frame 4000, SBP Response frame 4010 and the SBP Termination frame 4030 have the same frame body format.

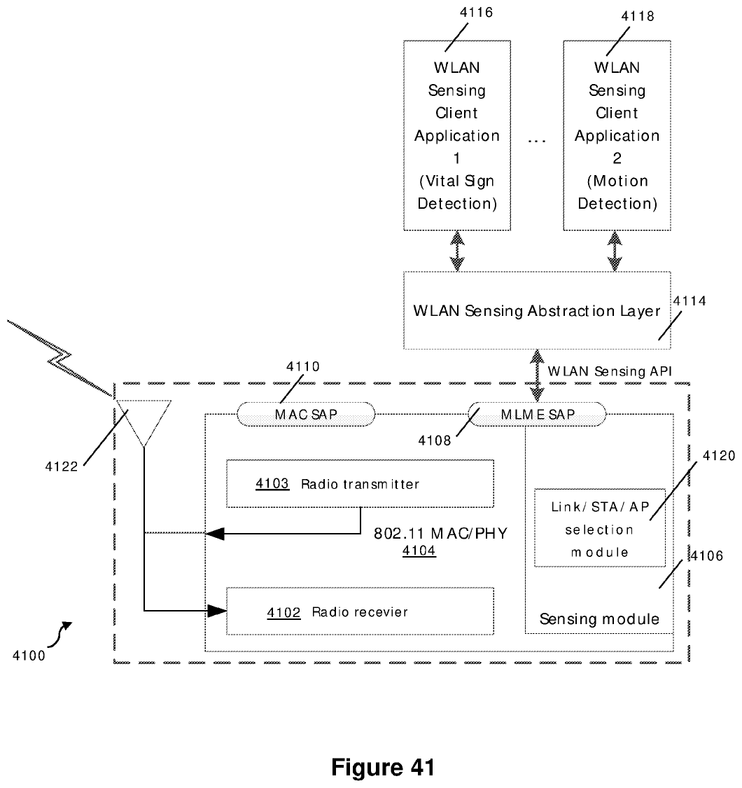

FIG. 41 shows an example configuration of a communication apparatus 4100. The communication apparatus 4100 is implemented as a STA for extended sensing by proxy in accordance with various embodiments of the present disclosure. The communication apparatus may include at least one radio transmitter 4103 and at least one radio receiver 4102 in collaboration with at least one antenna 4122 (for the sake of simplicity, only one radio transmitter, radio receiver and antenna are shown in FIG. 41) for transmission and reception of signals, respectively. The communication apparatus 4100 further comprises circuitry 4104 implementing 802.11 MAC/PHY sublayer functions (the 802.11 MAC/PHY sublayers 4104) which comprises a Sensing module 4106 for channel measurements; layer management service interfaces such as MLME SAP 4108 and MAC SAP 4110 through which defined primitives are exchanged to pass information and layer management functions such as WLAN sensing may be invoked; and higher layer applications (e.g., WLAN Sensing Abstraction Layer 4114) communicating with the 802.11 MAC/PHY 4104 through MLME SAP 4108.

Further, the 802.11 MAC/PHY sublayers 4104 may communicate with WLAN Data Applications (not shown) through MAC SAP 4110. In this example, the Sensing module 4106 performs channel measurements and provides raw results to WLAN Sensing Abstraction Layer 4114 via WLAN Sensing API. The WLAN Abstraction Layer 4114 collects and consolidates the channel measurement results from 802.11 device and may process the results (e.g., smoothing compression etc.) before passing the processed results to WLAN Sensing Client Applications like WLAN Sensing Client Application 1 (Vital Sign Detection) 4116 and WLAN Sensing Client Application 2 (Motion Detection) 4118. The WLAN Sensing Client Applications like 4116, 4118 may perform WLAN Sensing based on the channel measurements (e.g., using application specific machine learning algorithms etc.) and provides the results of the WLAN sensing, in this case, presence/absence of human detection and human motion detection.

The communication apparatus further comprises a layer-dependent entity Station Management Entity (SME) (not shown) which perform functions on behalf of general system management entities and would implement standard management protocol such as to ensure correct MAC operation. The layer-dependent entity provides interfaces such as MLME SAP 4108 and PLME SAP (not shown) for exchanging primitives and communicating with MLME and PLME, respectively.

In one embodiment, the communication apparatus may be an SBP Initiator and the higher layer applications may generate MLME primitives (not shown), e.g., MLME-SBP.request primitive, to initiate an SBP procedure.

The MAC/PHY Sublayer 4104 may be configured to receive information or WLAN sensing related MAC/PHY parameters to form an SBP request frame. The trigger frame or PPDU is then transmitted to one or more communication apparatuses (e.g., AP or SBP Responder), via at least one radio transmitter 4103 through the antenna 4222, 4252.

The MAC/PHY Sublayer 4104 may also be configured to unpack response or measurement PPDU, e.g., SBP Response frame and SBP Report frame received from another communication apparatus, and pass the information related to the received PPDU to the Sensing module 4106.

The Sensing module 4106 further comprises a CSI feedback encode/decode module configured to decode and encode CSI information, e.g., information of a CSI sub-component (e.g., amplitude, phase, I and Q) indicated by a report type indicator, according to various embodiments above in the present disclosure

FIG. 42 shows another example configuration of a communication apparatus 4200. The communication apparatus 4200 is implemented as an AP MLD for extended sensing by proxy in accordance with various embodiments of the present disclosure. The communication apparatus may two devices (AP-1 4201 and AP-2 4251), each of which includes at least one radio transmitter 4203, 4253 and at least one radio receiver 4202, 4252 in collaboration with at least one antenna 4122, 4272 (for the sake of simplicity, only one radio transmitter, radio receiver and antenna are shown in each of the devices in FIG. 42) for transmission and receipt of signals, respectively. Each device 4201, 4251 further comprises circuitries 4204, 4254, which implements 802.11 MAC/PHY sublayer functions (802.11 MAC/PHY sublayers 4204, 4254), comprising a Measurement module 4206, 4256 for channel measurements; layer management service interfaces such as MLME SAP 4208, 4258 which defined primitives are exchanged to pass information and layer management functions such as WLAN sensing may be invoked. The two devices 4201, 4251 shared a MLD upper MAC sublayer 4214 which communicates with the 802.11 MAC/PHY 4204, 4254 of each device 4201, 4251 through MLME SAP 4208, 4258.

The MLD supper MAC sublayer comprises an MLD Sensing module 4216 which coordinate channel measurements among devices; layer management service interfaces such as MLD MLME SAP 4212 and MAC SAP 4210 through which defined primitives are exchanged to pass information and layer management functions such as WLAN sensing may be invoked; and higher layer applications (e.g., WLAN Sensing Abstraction Layer (not shown)) communicating with the MLD through MLD MLME SAP 4212.

Further, the 802.11 MAC/PHY sublayers 4204, 4254 may communicate with WLAN Data Applications (not shown) through MAC SAP 4210. In this example, the Measurement module 4206 performs channel measurements and provides raw results to the MLD Sensing module 4216 and then WLAN Sensing Abstraction Layer via WLAN Sensing API. The WLAN Abstraction Layer collects and consolidates the channel measurement results from 802.11 device and may process the results (e.g., smoothing compression etc.) before passing the processed results to WLAN Sensing Client Applications. The WLAN Sensing Client Applications may perform WLAN Sensing based on the channel measurements (e.g., using application specific machine learning algorithms etc.) and provides the results of the WLAN sensing, in this case, presence/absence of human detection and human motion detection.

The communication apparatus further comprises a layer-dependent entity Station Management Entity (SME) (not shown) which perform functions on behalf of general system management entities and would implement standard management protocol such as to ensure correct MAC operation. The layer-dependent entity provides interfaces such as MLD MLME SAP 4212 and PLME SAP (not shown) for exchanging primitives and communicating with MLME and PLME, respectively.

In one embodiment, the communication apparatus 4200 or one of its device may be an SBP Responder and the higher layer applications may receive MLME primitives (not shown), e.g., MLME-SBP.request primitive, to initiate an SBP procedure.

The MAC/PHY Sublayer 4204, 4254 may also be configured to unpack SBP request frame or measurement PPDU, received from another communication apparatus, and pass the information related to the received PPDU to the Measurement module 4206, 4256 and MLD Sensing Module 4216.

The MAC/PHY Sublayer 4204, 4254 may be configured to receive information or WLAN sensing related MAC/PHY parameters to form an SBP response frame or an SBP report frame and the SBP response frame or SBP report frame are transmitted to one or more to one or more communication apparatuses (e.g., non-AP or SBP Initiator), via at least one radio transmitter 4203, 4253 through the antenna 4222, 4252.

The Measurement module 4206, 4256 and/or Sensing module 4216 further comprises a CSI feedback encode/decode module configured to decode and encode CSI information, e.g., information of a CSI sub-component (e.g., amplitude, phase, I and Q) indicated by a report type indicator, according to various embodiments above in the present disclosure.

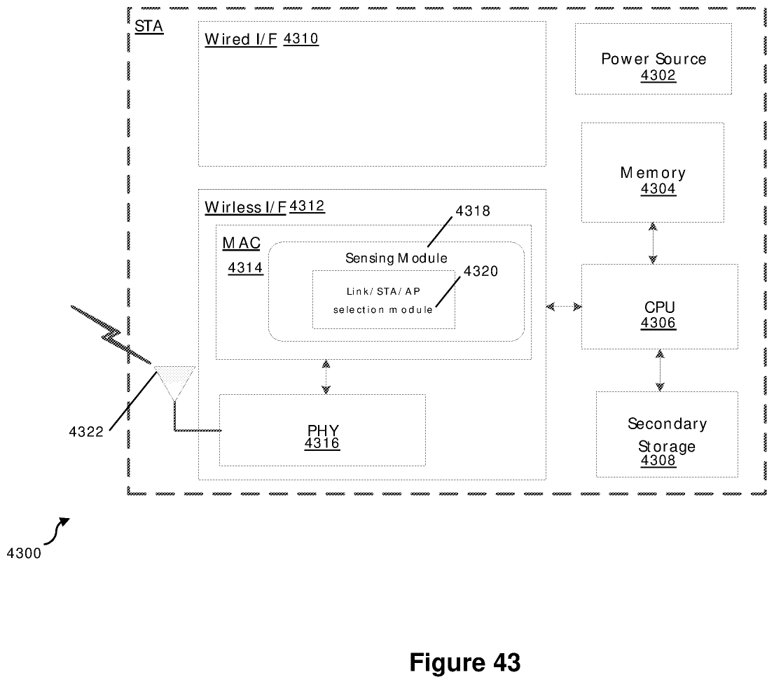

FIG. 43 shows yet another example configuration of a communication apparatus 4300. The communication apparatus 4300 is implemented as a non-AP STA for extended sensing by proxy in accordance with various embodiments of the present disclosure. The communication apparatus 4300 comprises a power source 4302, a memory 4304, a central processing unit (CPU) 4306 comprising at least one process, a secondary storage 4308, a wired interface (I/F) 4310 and a wireless I/F 4312. The memory 4304 may be a non-transitory computer-readable storage medium having stored therein data representing instructions executable by the at least one processor of the CPU 4306 to communicate with the wireless I/F 4312 to perform enhanced client discovery procedure according to various embodiments described in the present disclosure. The Wireless I/F 4312 comprises a MAC layer 4314 and a PHY layer 4316. The PHY layer 4316 connects with a radio transmitter (not shown), a radio receiver (not shown) and an antenna 4322 used for transmitting/receiving signals to/from other communication apparatuses (e.g., STAs). Alternatively, the communication apparatus 4300 may transmit/receive signals to/from other communication apparatus (e.g., STAs) via the Wired I/F 4310. The secondary storage 4308 may be configured to store AIDs of associated communication apparatus.

The MAC layer 4314 further comprises a Sensing Module 4318. The Sensing Module 4318 configured to generate and process frames (e.g., client discovery query/response frames, authorization validation request/response frames, report frame) to perform extended SBP procedure (e.g., as SBP initiator) according to various embodiments described above. The Sensing Module 4318 comprises a Link/STA/AP selection module 4320 which is configured to select one or more links, STAs and/or APs to participate in the SBP procedure. The selection may be included in the frames, for example, as Target STAs/Links or Target APs information.

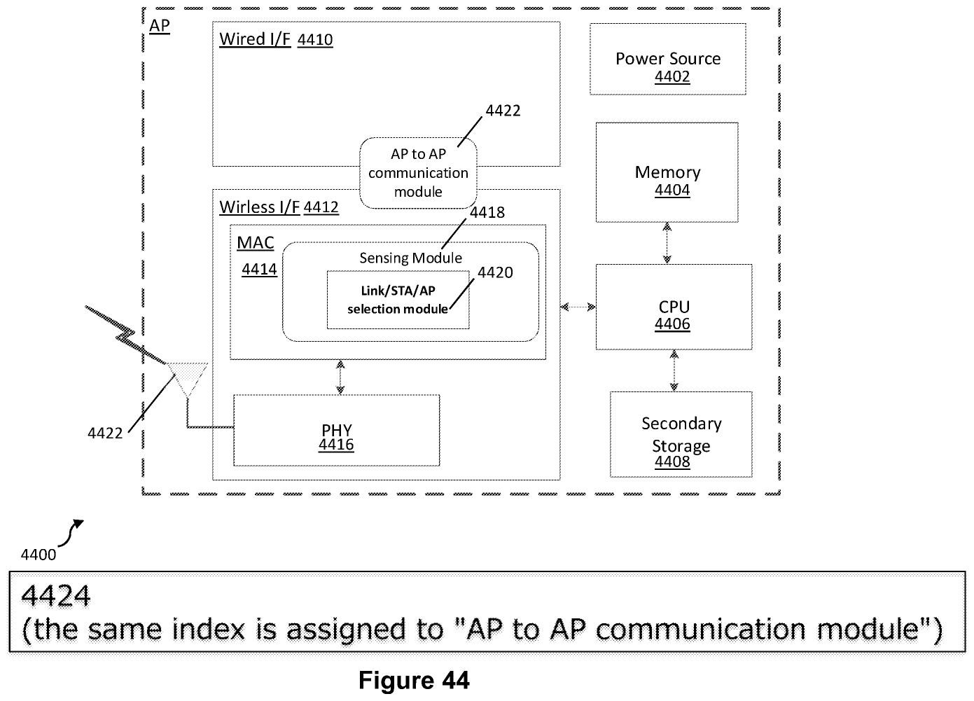

FIG. 44 shows another example configuration of a communication apparatus 4400. The communication apparatus 4400 is implemented as an AP for extended sensing by proxy in accordance with the present disclosure. The communication apparatus 4400 comprises a power source 4402, a memory 4404, a central processing unit (CPU) 4406 comprising at least one processor, a secondary storage 4408, a wired I/F 4410 and a wireless I/F 4412. The memory 4404 may be a non-transitory computer-readable storage medium having stored therein data representing instructions executable by the at least one processor of the CPU 4406 to communicate with the wireless I/F 4412 to perform multi-generation random access according to various embodiments in the present disclosure. The Wireless I/F 4412 comprises a MAC layer 4414 and a PHY layer 4416. The PHY layer 4416 connects with a radio transmitter (not shown), a radio receiver (not shown) and an antenna 4424 used for transmitting/receiving signals to/from other (base) communication apparatuses. Alternatively, the communication apparatus 4400 may transmit/receive signals to/from other communication apparatus via the Wired I/F 4410.

The MAC layer 4414 further comprises a Sensing Module 4418. The Sensing Module 4418 configured to generate and process frames (e.g., client discovery query/response frames, authorization validation request/response frames, report frame) to perform extended SBP procedure (e.g., as SBP responder, secondary proxy sensing initiator, or secondary SBP responder) according to various embodiments described above. The Sensing Module 4418 comprises a Link/STA/AP selection module 4420 which is configured to select one or more links, STAs and/or other APs to participate in the SBP procedure. The selection may be included in the frames, for example, as Target STAs/Links or Target APs information in a sensing request transmitted to another AP.

An AP to AP Communication module 4422 facilitates communication between wired I/F 4410 and Wireless I/F 4412. For example, multiple APs may be connected through wired backhaul in the Wired I/F 4410 while the APs communicates with other STAs via Wireless I/F 4412. When receiving a frame (e.g., SBP request frame) from a non-AP STA via Wireless I/F 4412, the AP to AP Communication Module 4422 may be configured to forward the frame (or generate another frame with the information) to other co-located AP or other AP within the same MLD, or interconnected AP through the wired backhaul link in the Wired I/F 4410. Similarly, when receiving a frame (e.g., SBP request frame) from another AP via Wired I/F 4410, the AP to AP Communication Module 4422 may be configured to forward the frame (or generate another frame with the information) to a STA which connects to the communication apparatus 4400 wireless through Wireless IF 4412.

As described above, the embodiments of the present disclosure provide an advanced communication system, communication methods and communication apparatuses for extended sensing by proxy procedure in MIMO WLAN networks. The embodiments illustrated in the present disclosure include:
1. A first communication apparatus comprising:
   a receiver, which, in operation, receives a first request frame from a second communication apparatus, the first request frame indicating a condition to select one or more links, each of the one or more links attached to one or more third communication apparatuses;
   circuitry, which, in operation, is configured to select a fourth communication apparatus and generate a second request to the fourth communication apparatus to perform a measurement on the one or more links; and
   a transmitter, which, in operation, transmits a first report frame to the second communication apparatus carrying one or more reports of the measurement corresponding to the one or more links.
2. The first communication apparatus of embodiment 1, wherein the transmitter transmits the first report frame upon receipt of a second report from the fourth communication apparatus carrying the one or more reports of the measurement corresponding to the one or more links.
3. The first communication apparatus of embodiment 2, wherein either one or both of the second request and the second report comprise a 1905 message.
4. The first communication apparatus of embodiment 2, wherein the first request frame carries an identifier or a media access control (MAC) address of the fourth communication apparatus and the second report being a report frame that carries an identifier or an MAC address of the second communication apparatus, wherein the transmitter transmits the first request frame to the fourth communication apparatus and the second report to the second communication apparatus.
5. The first communication apparatus of any one of embodiments 1-4, wherein the condition relates to at least one of a link related parameter, a device related parameter, a number of link to be selected, a condition on whether a responder-to-responder (R2R) link can be selected and a condition whether a link associating with the first or fourth communication apparatus can be selected.
6. The first communication apparatus of embodiment 5, wherein the link related parameter is at least one of a Received Signal Strength Indicator and a Received Channel Power Indicator received on a link, and the device related parameter is at least one of a device type, a device location, a device identifier and a device address.
7. The first communication apparatus of any one of embodiments 1-6, further comprising:
   circuitry, which, in operation, is configured to assign an identifier to the measurement on the one or more links and generate the second request, the second request carrying the identifier.
8. The first communication apparatus of any one of embodiments 1-7, wherein the first communication apparatus and the fourth communication apparatus are connected to or through a common physical device.
9. The first communication apparatus of any one of embodiments 1-8, wherein the first communication apparatus and the fourth communication apparatus are access points (APs), and the second communication apparatus and the third communication apparatus are non-access-point stations (non-AP STAs).
10. The first communication apparatus of embodiment 9, wherein both the first communication apparatus and the fourth communication apparatus are affiliated with a common AP multi-link device (MLD).
11. The first communication apparatus of embodiment 10, wherein the second communication apparatus is affiliated with a non-AP MLD; the first request frame is received on a first link between the AP MLD and the non-AP MLD; and the first report frame is exchanged on a second available link between the AP MLD and the non-AP MLD.
12. The first communication apparatus of any one of embodiments 1-11, wherein the first request frame is a Sensing By Proxy (SBP) Request frame and the first report frame is an SBP Report frame.
13. The first communication apparatus of embodiment 12, wherein the first communication apparatus is an SBP responder, and the second communication apparatus is an SBP initiator.
14. A second communication apparatus, comprising:
   circuitry, which, in operation, is configured to generate a first request frame indicating a condition to select one or more links and requesting for a measurement on the one or more links;
   a transmitter, which, in operation, transmits the first request frame to a first communication apparatus, each of the one or more links attached to one or more third communication apparatuses; and
   a receiver, which, in operation, receives a first report frame from the first communication apparatus carrying one or more reports of the measurement corresponding to the one or more links performed by a fourth communication apparatus.
15. The second communication apparatus of embodiment 14, wherein the condition relates to at least one of a link related parameter, a device related parameter, a number of link to be selected, a condition on whether a responder-to-responder (R2R) link can be selected and a condition whether a link associating with the first or second communication apparatus can be selected.
16. The second communication apparatus of embodiment 15, wherein the link related parameter is at least one of a Received Signal Strength Indicator and a Received Channel Power Indicator received on a link, and the device related parameter is at least one of a device type, a device location, a device identifier and a device address.
17. The second communication apparatus of any one of embodiments 14-16, wherein the first request frame comprises an identifier or a MAC address of a fourth communication apparatus.
18. The second communication apparatus of any one of embodiments 14-16, wherein the first request comprises an identifier or a MAC address of the first communication apparatus, and the measurement on the one or more links is performed by the first communication apparatus.
19. The second communication apparatus of any one of embodiments 14-18, wherein the first communication apparatus and the fourth communication apparatus are access points (APs), and the second communication apparatus and third communication apparatus are non-access-point stations (non-AP STAs).
20. The second communication apparatus of embodiments 17 or 18, wherein the first request frame is a Sensing By Proxy (SBP) Request frame and the first report frame is an SBP Report frame.
21. The second communication apparatus of embodiments 19, wherein either one or both of the first communication apparatus and the fourth communication apparatus are SBP responders and the second apparatus is an SBP initiator.
22. A communication method implemented by a first communication apparatus comprising:
   receiving a first request frame from a second communication apparatus, the first request frame indicating a condition to select one or more links, each of the one or more links attached to one or more third communication apparatuses; and
   selecting a fourth communication apparatus;
   generating a second request to the fourth communication apparatus to perform a measurement on the one or more links; and
   transmitting a first report frame to the second communication apparatus carrying one or more reports of the measurement corresponding to the one or more links.
23. A communication method implemented by a second communication apparatus comprising:
   generating a first request frame indicating a condition to select one or more links and requesting for a measurement on the one or more links;
   transmitting the first request frame to a first communication apparatus, each of the one or more links attached to one or more third communication apparatuses; and
   receiving a first report frame from the first communication apparatus carrying one or more reports of the measurement corresponding to the one or more links performed by a fourth communication apparatus.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system on a chip (SoC), a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, an FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A first communication apparatus comprising:
a receiver, which, in operation, receives a first request frame from a second communication apparatus, the first request frame indicating a condition to select one or more links, each of the one or more links attached to one or more third communication apparatuses;
circuitry, which, in operation, is configured to select a fourth communication apparatus and generate a second request to the fourth communication apparatus to perform a measurement on the one or more links; and
a transmitter, which, in operation, transmits a first report frame to the second communication apparatus carrying one or more reports of the measurement corresponding to the one or more links.

2. The first communication apparatus of claim 1, wherein the transmitter transmits the first report frame upon receipt of a second report from the fourth communication apparatus carrying the one or more reports of the measurement corresponding to the one or more links.

3. The first communication apparatus of claim 2, wherein either one or both of the second request and the second report comprise a 1905 message.

4. The first communication apparatus of claim 2, wherein the first request frame carries an identifier or a media access control (MAC) address of the fourth communication apparatus and the second report being a report frame that carries an identifier or an MAC address of the second communication apparatus, wherein the transmitter transmits the first request frame to the fourth communication apparatus and the second report to the second communication apparatus.

5. The first communication apparatus of claim 1, wherein the condition relates to at least one of a link related parameter, a device related parameter, a number of link to be selected, a condition on whether a responder-to-responder (R2R) link can be selected and a condition whether a link associating with the first or fourth communication apparatus can be selected.

6. The first communication apparatus of claim 1, further comprising:
circuitry, which, in operation, is configured to assign an identifier to the measurement on the one or more links and generate the second request, the second request carrying the identifier.

7. The first communication apparatus of claim 1, wherein the first communication apparatus and the fourth communication apparatus are connected to or through a common physical device.

8. The first communication apparatus of claim 1, wherein the first communication apparatus and the fourth communication apparatus are access points (APs), and the second communication apparatus and the third communication apparatus are non-access-point stations (non-AP STAs).

9. The first communication apparatus of claim 9, wherein both the first communication apparatus and the fourth communication apparatus are affiliated with a common AP multi-link device (MLD).

10. The first communication apparatus of claim 10, wherein the second communication apparatus is affiliated with a non-AP MLD; the first request frame is received on a first link between the AP MLD and the non-AP MLD; and the first report frame is exchanged on a second available link between the AP MLD and the non-AP MLD.

11. The first communication apparatus of claim 1, wherein the first request frame is a Sensing By Proxy (SBP) Request frame and the first report frame is an SBP Report frame.

12. The first communication apparatus of claim 11, wherein the first communication apparatus is an SBP responder, and the second communication apparatus is an SBP initiator.

13. A second communication apparatus, comprising:
circuitry, which, in operation, is configured to generate a first request frame indicating a condition to select one or more links and requesting for a measurement on the one or more links;
a transmitter, which, in operation, transmits the first request frame to a first communication apparatus, each of the one or more links attached to one or more third communication apparatuses; and
a receiver, which, in operation, receives a first report frame from the first communication apparatus carrying one or more reports of the measurement corresponding to the one or more links performed by a fourth communication apparatus.

14. The second communication apparatus of claim 13, wherein the condition relates to at least one of a link related parameter, a device related parameter, a number of link to be selected, a condition on whether a responder-to-responder (R2R) link can be selected and a condition whether a link associating with the first or second communication apparatus can be selected.

15. The second communication apparatus of claim 14, wherein the link related parameter is at least one of a Received Signal Strength Indicator and a Received Channel Power Indicator received on a link, and the device related parameter is at least one of a device type, a device location, a device identifier and a device address.

16. The second communication apparatus of claim 13, wherein the first request frame comprises an identifier or a MAC address of a fourth communication apparatus.

17. The second communication apparatus of claim 13, wherein the first request comprises an identifier or a MAC address of the first communication apparatus, and the measurement on the one or more links is performed by the first communication apparatus.

18. The second communication apparatus of claim 13, wherein the first communication apparatus and the fourth communication apparatus are access points (APs), and the second communication apparatus and third communication apparatus are non-access-point stations (non-AP STAs).

19. A communication method implemented by a first communication apparatus comprising:
receiving a first request frame from a second communication apparatus, the first request frame indicating a condition to select one or more links, each of the one or more links attached to one or more third communication apparatuses; and
selecting a fourth communication apparatus;
generating a second request to the fourth communication apparatus to perform a measurement on the one or more links; and
transmitting a first report frame to the second communication apparatus carrying one or more reports of the measurement corresponding to the one or more links.

20. A communication method implemented by a second communication apparatus comprising:
generating a first request frame indicating a condition to select one or more links and requesting for a measurement on the one or more links;
transmitting the first request frame to a first communication apparatus, each of the one or more links attached to one or more third communication apparatuses; and
receiving a first report frame from the first communication apparatus carrying one or more reports of the measurement corresponding to the one or more links performed by a fourth communication apparatus.
